(19) United States
(12) Patent Application Publication
(10) Pub. No.: US 2023/0415415 A1
(43) Pub. Date: Dec. 28, 2023

(54) PROCESSING FIELD MANIPULATION IN THREE-DIMENSIONAL PRINTING

(71) Applicant: Velo3D, Inc., Campbell, CA (US)

(72) Inventors: Erel Milshtein, Cupertino, CA (US); Benyamin Buller, Cupertino, CA (US)

(21) Appl. No.: 18/201,323

(22) Filed: May 24, 2023

Related U.S. Application Data
(63) Continuation of application No. 18/096,701, filed on Jan. 13, 2023, now abandoned.
Application No. 18/096,701 is a continuation of application No. 17/951,229, filed on Sep. 23, 2022, now abandoned.
Application No. 17/951,229 is a continuation of application No. 17/832,782, filed on Jun. 6, 2022, now abandoned.
Application No. 17/832,782 is a continuation of application No. 17/682,498, filed on Feb. 28, 2022, now abandoned.
Application No. 17/682,498 is a continuation of application No. 17/524,991, filed on Nov. 12, 2021, now abandoned.
Application No. 17/524,991 is a continuation of application No. 17/388,524, filed on Jul. 29, 2021, now abandoned.
Application No. 17/388,524 is a continuation of application No. 17/216,980, filed on Mar. 30, 2021, now abandoned.
Application No. 17/216,980 is a continuation of application No. 17/104,109, filed on Nov. 25, 2020, now abandoned.
Application No. 17/104,109 is a continuation of application No. PCT/US19/32727, filed on May 16, 2019.
(60) Provisional application No. 62/676,911, filed on May 25, 2018.

(51) Int. Cl. B29C 64/291; B29C 64/386

(52) U.S. Cl. CPC B29C 64/291; B29C 64/386; B33Y 30/00

(57) ABSTRACT

The present disclosure provides three-dimensional (3D) printing methods, apparatuses, systems and/or software to form one or more three-dimensional objects including: (i) an improved printing throughput, (ii) usage of an energy beam with selected directionality, (iii) usage of an aligned energy beam with respect to a target surface, and/or (iv) respective alignment of energy beams with respect to each other and/or with respect to a target surface.

### CROSS-REFERENCE

This application is a continuation of U.S. patent application Ser. No. 18/096,701 filed Jan. 13, 2023, which is a continuation of U.S. patent application Ser. No. 17/951,229 filed Sep. 23, 2022, which is continuation of U.S. patent application Ser. No. 17/832,782 filed Jun. 6, 2022, which is a continuation of U.S. patent application Ser. No. 17/682,498 filed Feb. 28, 2022, which is a continuation of U.S. patent application Ser. No. 17/524,991 filed Nov. 12, 2021, which is a continuation of U.S. patent application Ser. No. 17/388,524 filed Jul. 29, 2021, which is a continuation of U.S. patent application Ser. No. 17/216,980 filed Mar. 30, 2021, which is a continuation of U.S. patent application Ser. No. 17/104,109 filed Nov. 25, 2020, which is continuation of PCT/US19/032727 filed May 16, 2019, which claims priority to Provisional Patent Application Ser. No. 62/676,911, filed on May 25, 2018, tilted “PROCESSING FIELD MANIPULATION IN THREE-DIMENSIONAL PRINTING,” each of which is entirely incorporated herein by reference.

### BACKGROUND

Three-dimensional (3D) printing (e.g., additive manufacturing) is a process for making a three-dimensional object of any shape from a design. The design may be in the form of a data source such as an electronic data source or may be in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, elemental carbon, or polymeric material. In some 3D printing processes (e.g., additive manufacturing), a first layer of hardened material is formed, and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The modeling process of preparing geometric data for 3D computer graphics may be similar to plastic arts, such as sculpting or animating. 3D scanning is a process of analyzing and collecting digital data on the shape and appearance of a real object (e.g., real-life object). Based on these data, 3D models of the scanned object can be produced.

Many additive processes are currently available. They may differ in the manner layers are deposited and/or formed to create the materialized structure. They may vary in the material(s) that are used to generate the designed structure. Some methods melt and/or soften material to produce the layers. Examples of 3D printing methods include selective laser melting (SLM), selective laser sintering (SLS), direct metal laser sintering (DMLS), shape deposition manufacturing (SDM) or fused deposition modeling (FDM). Other methods cure liquid materials using different technologies such as stereo lithography (SLA). In the method of laminated object manufacturing (LOM), thin layers (made inter alia of paper, polymer, and/or metal) are cut to shape and joined together.

Each method of additive manufacturing requires an input of energy into one or more materials for transforming the material(s) to generate the designed structure of the requested 3D object. At times, a 3D printing system may use an energy beam projected on a material bed to transform a portion of pre-transformed material during formation of the 3D object. The rate at which a 3D printing system produces one or more 3D objects may be limited by the throughput capability of the 3D printing system. At times, the throughput of a 3D printing system may be increased by increasing a rate at which energy is delivered to the material(s). However, the energy delivered may not be arbitrarily high. For example, there may exist a threshold (e.g., maximal) energy (e.g., energy density) that can be delivered to a given location of a material while maintaining a controlled transformation of the material. For example, there may exist a threshold (e.g., maximal) energy that may be accommodated by one or more components (e.g., optical components) of a 3D printing system, before imparting damage to the component(s). Generation of large objects, and/or a number of smaller objects (e.g., in parallel), may require a large build area. At times, generation of large objects, and/or a number of smaller objects (e.g., in parallel), may require an unacceptably long time when the object formation is limited to one energy source.

### SUMMARY

At times, it may be desirable to increase a throughput at which a 3D printing system (e.g., a printer) generates one or more 3D objects by using a plurality of transforming elements (e.g., energy sources). In some instances, it may be desirable to coordinate which transforming element of a plurality of transforming elements is used to process a given portion of a generated 3D object. In some instances, it may be desirable to control a direction from which an energy beam impinges onto a surface (e.g., a target surface) for transforming a material to form a portion of a 3D object. In some embodiments, the present disclosure facilitates control of an angle at which an energy beam impinges onto a surface (e.g., a target surface). In some embodiments, the present disclosure facilitates control of an energy beam to impinge onto a surface, e.g., at an angle that is non-normal to the surface.

The operations of any of the methods, non-transitory computer readable media, and/or controller directions described herein can be in any order. At least two of the operation in any of the methods, non-transitory computer readable media, and/or controller(s) can be performed simultaneously.

In another aspect, a system for printing at least one three-dimensional object, comprises: a target surface that is configured to support the at least one three-dimensional object during the printing; an energy source that is configured to generate an energy beam that travels in an optical path, wherein the energy source is disposed adjacent to the target surface; one or more guidance systems operatively coupled with the energy source, which one or more guidance systems are configured to direct the energy beam across at least a portion of the target surface; and a directing optical element disposed adjacent to the optical path traversed by the energy beam, which directing optical element is configured for (e.g., translational and/or rotational) movement into and out of the optical path to (a) direct the energy beam to the one or more guidance systems at a first position, or (b) direct the energy beam to the one or more guidance systems at a second position.

In some embodiments, the energy beam is configured to irradiate a pre-transformed material at or adjacent to the target surface to form a transformed material as part of the at least one three-dimensional object. In some embodiments, the directing optical element is configured for movement at least during the printing. In some embodiments, the one or more guidance systems comprises a guidance system that is configured to travel from the first position to the second position. In some embodiments, the energy source is configured to attenuate the energy beam during travel of the guidance system. In some embodiments, to attenuate comprises to cease generation of the energy beam. In some embodiments, a first guidance system of the one or more guidance systems is positioned at the first position, and a second guidance system of the one or more guidance systems is positioned at the second position, wherein the second position is different from the first position. In some embodiments, the system further comprises a platform that is configured to (directly or indirectly) support the at least one three-dimensional object during the printing. In some embodiments, the energy source is configured to generate a plurality of energy beams. In some embodiments, the energy source is a first energy source, wherein the energy beam is a first energy beam, wherein the optical path is a first optical path, wherein the directing optical element is a first directing optical element, and wherein the system further comprises: a second directing optical element disposed adjacent to a second optical path traversed by a second energy beam, which second directing optical element is configured for (e.g., translational and/or rotational) movement into and out of the second optical path to (c) direct the second energy beam to the one or more guidance systems at a third position, or (d) direct the second energy beam to the one or more guidance systems at a fourth position. In some embodiments, the second optical path and the first optical path are the same. In some embodiments, the directing optical element comprises sapphire or amorphous silicon.

In another aspect, an apparatus for printing at least one three-dimensional object, comprises: at least one controller that is configured to operatively couple (e.g., and is operatively coupled) to an optical element, which at least one controller is configured to direct a (e.g., translational and/or rotational) movement of the optical element into and out of an optical path of an energy beam to (a) direct the energy beam to one or more guidance systems at a first position, or (b) direct the energy beam to the one or more guidance systems at a second position, which one or more guidance systems are configured to direct the energy beam to print the at least one three-dimensional object.

In some embodiments, the one or more guidance systems are configured to irradiate a pre-transformed material at or adjacent to a target surface to form a transformed material as part of the at least one three-dimensional object. In some embodiments, the at least one controller is configured to direct the movement of the optical element during the printing. In some embodiments, the at least one controller is configured to operatively couple (e.g., and is operatively coupled) with at least one guidance system of the one or more guidance systems, wherein the at least one controller is configured to move the at least one guidance system of the one or more guidance systems to travel from the first position to the second position. In some embodiments, the at least one controller is configured to operatively couple (e.g., and is operatively coupled) with an energy source configured to generate the energy beam, wherein the at least one controller is configured to direct the energy source to cease generation of the energy beam during travel from the first position to the second position. In some embodiments, a first guidance system of the one or more guidance systems is positioned at the first position, and a second guidance system of the one or more guidance systems is positioned at the second position. In some embodiments, the at least one three-dimensional object is directly or indirectly supported by a platform during the printing. In some embodiments, the at least one controller is configured to direct the movement of the optical element to direct a plurality of energy beams. In some embodiments, the energy beam is a first energy beam, wherein the optical path is a first optical path, wherein the optical element is a first optical element, and wherein the apparatus further comprises: the at least one controller configured to operatively couple (e.g., and is operatively coupled) with a second optical element disposed adjacent to a second optical path traversed by a second energy beam, which at least one controller is configured to direct a movement (e.g., translational and/or rotational) of the second optical element into and out of the second optical path to (c) direct the second energy beam to the one or more guidance systems at a third position, or (d) direct the second energy beam to the one or more guidance systems at a fourth position. In some embodiments, the second optical path and the first optical path are the same. In some embodiments, to direct the energy beam to the one or more guidance systems at the first position or at the second position is performed by a same controller. In some embodiments, the at least one controller comprises at least two different controllers that are configured to direct the movement of the optical element. In some embodiments, the at least one controller comprises an electrical circuit. In some embodiments, being operatively coupled to comprises being in signal communication with.

In another aspect, a method for printing at least one three-dimensional object, comprises: (i) generating an energy beam; and (ii) directing a (e.g., translational and/or rotational) movement of a directing optical element into an optical path of the energy beam to (a) direct the energy beam to a first guidance system of one or more guidance systems at a first position, or (b) direct the energy beam a second guidance system of the one or more guidance systems at a second position, wherein the one or more guidance systems direct the energy beam across at least a portion of a target surface to print the at least one three-dimensional object.

In some embodiments, translational movement comprises a horizontal and/or vertical movement. In some embodiments, the movement of the directing optical element is during the printing of the at least one three-dimensional object. In some embodiments, the first guidance system and the second guidance system are the same guidance system, wherein the method further comprises, after (a) and/or before (b), translating the same guidance system from the first position to the second position. In some embodiments, the method further comprises attenuating the energy beam during translation of the same guidance system from the first position to the second position. In some embodiments, the method further comprises ceasing generation of the energy beam during translation of the same guidance system from the first position to the second position. In some embodiments, the first guidance system and the second guidance system are different. In some embodiments, the energy beam forms a transformed material as part of the at least one three-dimensional object. In some embodiments, the method further comprises generating a plurality of energy beams. In some embodiments, the energy beam is a first energy beam, wherein the optical path is a first optical path, wherein the directing optical element is a first directing optical element, and wherein the method further comprises: directing a second movement (e.g., translational and/or rotational) of a second directing optical element into and out of a second optical path to (c) direct a second energy beam to the one or more guidance systems at a third position, or (d) direct the second energy beam to the one or more guidance systems at a fourth position. In some embodiments, the second optical path and the first optical path are the same.

In another aspect, a system for printing at least one three-dimensional object, comprises: a target surface that is configured to support the at least one three-dimensional object during the printing; an energy source that is configured to generate an energy beam, wherein the energy source is disposed adjacent to the target surface; and a guidance system operatively coupled with the energy source, which guidance system is configured to direct the energy beam across at least a portion of the target surface, which guidance system is configured to guide the energy beam to impinge on the target surface at an angle other than normal relative to the target surface.

In some embodiments, the guidance system is configured to have a final deflection point of the energy beam that is outside a perimeter (or a vertical projection of a perimeter) of the target surface. In some embodiments, the guidance system cannot direct the energy beam at an angle that is normal to the target surface. In some embodiments, the guidance system is disposed (e.g., laterally) such that the energy beam directed by the guidance system that forms an angle that is normal to a surface comprising the target surface impinges outside of the target surface. In some embodiments, the guidance system is configured to direct the energy beam to irradiate a pre-transformed material at or adjacent to the target surface to form a transformed material as part of the at least one three-dimensional object. In some embodiments, the system further comprises a platform that is configured to directly or indirectly support the at least one three-dimensional object during the printing. In some embodiments, the energy source is configured to generate a plurality of energy beams. In some embodiments, the angle other than normal comprises an angle from about 20° to about 5°, with respect to normal impingement on the target surface. In some embodiments, the energy beam is a first energy beam and the guidance system is a first guidance system, further comprises a second guidance system coupled with the energy source, the second guidance system configured to guide a second energy beam to impinge on the target surface at the angle other than normal relative to the target surface.

In another aspect, a method for printing at least one three-dimensional object, comprises: (i) generating an energy beam; and (ii) using a guidance system to direct the energy beam to impinge across at least a portion of a target surface at an angle other than normal to print the at least one three-dimensional object.

In some embodiments, the guidance system is disposed (e.g., laterally) such that directing the energy beam at an angle that is normal to a surface comprising the target surface causes the energy beam to impinge outside of the target surface. In some embodiments, the energy beam is irradiating a pre-transformed material to form a transformed material as part of the at least one three-dimensional object. In some embodiments, the guidance system is directing the energy beam from a final deflection point that is outside a perimeter (or a vertical projection of a perimeter) of the target surface. In some embodiments, the guidance system cannot direct the energy beam at an angle that is normal to the target surface. In some embodiments, the energy beam impinges to irradiate a pre-transformed material at or adjacent to the target surface to form a transformed material as part of the at least one three-dimensional object. In some embodiments, the method further comprises generating a plurality of energy beams. In some embodiments, the angle other than normal comprises an angle from about 20° to about 5°, with respect to normal impingement on the target surface.

In another aspect, a system for printing at least one three-dimensional object, comprises: a target surface configured to support the three-dimensional object during the printing; an energy source that is configured to generate an energy beam, wherein the energy source is disposed adjacent to the target surface; at least two guidance systems operatively coupled with the energy source, which the at least two guidance systems are configured to direct the energy beam (i) across at least a first portion of the target surface and (ii) across at least a second portion of the target surface, respectively, wherein a first guidance system of the at least two guidance systems is disposed above a second guidance system of the at least two guidance systems with respect to the target surface; and a directing optical element disposed adjacent to or within an optical path traversed by the energy beam, which directing optical element is configured to direct the energy beam (a) to the first guidance system of the at least two guidance systems, and/or (b) to the second guidance system of the at least two guidance systems.

In some embodiments, the energy beam is configured to irradiate a pre-transformed material at or adjacent to the target surface to form a transformed material as part of the at least one three-dimensional object. In some embodiments, above is with respect to a global vector, the global vector having a direction that is (i) toward a local gravitational center, (ii) opposite to a direction of layer-wise material deposition to print the at least one three-dimensional object, and/or (iii) normal to a platform that is configured to support the at least one three-dimensional object during the printing and directed opposite to a surface of the platform that supports the at least one three-dimensional object. In some embodiments, above is such that a bottom surface of the first guidance system is above a top surface of the second guidance system. In some embodiments, above is in a direction opposite to the global vector. In some embodiments, the directing optical element is configured to direct the energy beam during the printing of the at least one three-dimensional object. In some embodiments, the system further comprises a platform that is configured to directly or indirectly support the at least one three-dimensional object during the printing. In some embodiments, the energy source is configured to generate a plurality of energy beams.

In another aspect, a method for printing at least one three-dimensional object, comprises: (i) generating an energy beam; and (ii) directing the energy beam via a directing optical element to (a) a first guidance system of at least two guidance systems, and/or (b) a second guidance system of the at least two guidance systems, the at least two guidance systems for directing the energy beam to print the at least one three-dimensional object that is supported by a target surface, wherein the first guidance system of the at least two guidance systems is disposed above the second guidance system of the at least two guidance systems with respect to the target surface.

In some embodiments, directing the energy beam comprises irradiating a pre-transformed material at or adjacent to at least a first portion and a second portion of the target surface, respectively. In some embodiments, the directing the energy beam comprises irradiating a pre-transformed material to form a transformed material as part of the at least one three-dimensional object. In some embodiments, above is with respect to a global vector, the global vector having a direction that is (i) toward a local gravitational center, (ii) opposite a direction of layer-wise material deposition, and/or (iii) normal to a platform that is configured to support the at least one three-dimensional object during the printing. In some embodiments, above is such that a bottom surface of the first guidance system is above a top surface of the second guidance system. In some embodiments, the at least one three-dimensional object is supported directly or indirectly by a platform. In some embodiments, the method further comprises generating a plurality of energy beams.

In another aspect, an apparatus for printing a three-dimensional object comprises one or more controllers configured to operatively couple (e.g., and are operatively coupled) to an energy source and to one or more guidance systems, the one or more controllers are configured to direct: the energy source to irradiate an energy beam to the one or more guidance systems; the one or more guidance systems to select a location Aⱼ from a location set A₁, A₂, . . . Aₙ, wherein n and j are integers; and the one or more guidance systems to guide (e.g., direct) the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein the point P satisfies having an Sⱼ value of from about minus one (−1) to about zero point five (0.5, or half).

In some embodiments, the point P satisfies having a Sⱼ value of from about minus one (−1) to about zero (0). In some embodiments, the one or more controllers is configured to select, or directs a selection of, the location Aⱼ. In some embodiments, the one or more controllers is configured to select, or directs a selection of, a guidance system from the one or more guidance systems, which guidance system that is selected is at the location Aⱼ. In some embodiments, the one or more controllers translates the one or more guidance system to the location Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a first cross section of a first layering plane with the surface, and the point is in a second cross section of a second layering plane with the surface. In some embodiments, the one or more controllers are further configured to operatively couple (e.g., and are operatively coupled) to a sensor that is configured to detect (a) a position of the one or more guidance systems with respect to the location set A₁, A₂, . . . Aₙ, (b) at least one energy beam characteristic and/or (c) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, to detect the signal comprises a detection of a temperature of the energy beam footprint on the surface, or a vicinity thereof. In some embodiments, the vicinity is at most about seven (7) fundamental length scales of the energy beam footprint, centering at the energy beam footprint. In some embodiments, the sensor comprises an encoder, a switch, a CCD, a line scan CCD, a line scan CMOS, a video camera, or a spectrometer. In some embodiments, the one or more guidance systems are disposed within an optical enclosure that is configured to facilitate separation of the energy beam from an environment external to the optical enclosure. In some embodiments, the optical enclosure comprises one or more optical elements, the one or more optical elements arranged to direct and/or to transmit the energy beam, wherein the one or more optical elements comprise a lens, a mirror, a beam splitter, or an optical window. In some embodiments, the one or more optical elements comprise sapphire, beryllium, zinc selenide, calcium fluoride (CaF₂), or fused silica. In some embodiments, the one or more guidance systems are mounted or disposed on a railing, the railing comprising locations of the location set A₁, A₂, . . . Aₙ, the railing comprising at least one actuator configured to move the one or more guidance systems from a first location to a second location of the location set A₁, A₂, . . . Aₙ. In some embodiments, the one or more guidance systems are translated using remote control. In some embodiments, the one or more guidance systems are translated using local control. In some embodiments, a translation of at least one of the one or more guidance systems is wired. In some embodiments, a translation of at least one of the one or more guidance systems is wireless. In some embodiments, the surface comprises an exposed surface of an enclosure, wherein the enclosure comprises an inert or non-reactive atmosphere, which non-reactive is with the three-dimensional object or a pre-transformed material that is transformed to form the three-dimensional object (e.g., during and/or after printing). In some embodiments, the enclosure further comprises a processing chamber and a container, wherein the container comprises the pre-transformed material or the three-dimensional object and is removably coupled with the processing chamber. In some embodiments, the energy source is a first energy source, wherein the energy beam is a first energy beam, and wherein the one or more controllers is configured to operatively couple (e.g., and is operatively coupled) to a second energy source that is configured to irradiate a second energy beam, such that: (A) a first guidance system of the one or more guidance systems is disposed above a second guidance system of the one or more guidance systems, (B) the first energy source is disposed above the second energy source, and/or (C) the first energy beam is irradiated above the second energy beam, wherein above is with respect to the global vector (e.g., in a direction opposite to the global vector). In some embodiments, the one or more controllers are further configured to align the first energy beam and/or the second energy beam with respect to a requested position on a target surface to form the three-dimensional object. In some embodiments, the platform is configured to directly or indirectly support the three-dimensional object during the printing. In some embodiments, the one or more controllers are configured to select, or direct selection of, the location Aⱼ such that the point P satisfies having a Sⱼ value of from about minus one (−1) to about zero point five (0.5). In some embodiments, at least two of operations (i), (ii), and (iii) are controlled by the same controller. In some embodiments, at least two of operations (i), (ii), and (iii) are each controlled by a different controller. In some embodiments, the one or more controllers direct (i), (ii), and/or (iii) in real time during the printing.

In another aspect, an apparatus for printing a three-dimensional object, comprises at least one controller that is configured to operatively couple (e.g., and is operatively coupled) to an energy source and to at least one guidance system, the at least one controller is configured to: select, or direct selection of, a location Aⱼ of the at least one guidance system from a location set A₁, A₂, . . . Aₙ, wherein n and j are integers; direct the energy source to irradiate an energy beam to the at least one guidance system disposed at the location Aⱼ; and direct the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein the point P satisfies having an Sⱼ value of from about minus one (−1) to about zero point five (0.5).

In some embodiments, the at least one controller is further configured to operatively couple (e.g., and is operatively coupled) to a sensor that is configured to detect (A) a position of the at least one guidance system with respect to the location set A₁, A₂, . . . Aₙ, (B) at least one energy beam characteristic and/or (C) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, the sensor comprises an encoder, a switch, a CCD, a line scan CCD, a line scan CMOS, a video camera, or a spectrometer. In some embodiments, the at least one controller is configured to adjust at least one of (A) or (B), considering a detection of (A)-(C). In some embodiments, to adjust comprises a closed loop control scheme, which closed loop control comprises a feedback or a feed-forward control scheme. In some embodiments, the closed loop control is in real time, wherein real time comprises during the printing at least a portion of the three-dimensional object. In some embodiments, at least a first one of the at least one guidance system is configured for movement from a first location to a second location with of the location set A₁, A₂, . . . Aₙ. In some embodiments, the at least one guidance system further comprises a plurality of guidance systems disposed at locations within the location set A₁, A₂, . . . Aₙ, and/or wherein the energy source is a first energy source of a plurality of energy sources. In some embodiments, the at least one controller is configured to optimize (e.g., to select) a guidance system of the plurality of guidance systems to guide (e.g., direct) the energy beam considering the point P and/or a location of the energy source, wherein to optimize is with respect to minimizing the Sⱼ value. In some embodiments, the at least one controller is configured to optimize (e.g., to select) an energy source of the plurality of energy sources to irradiate the energy beam considering the point P and/or a location of a guidance system of the plurality of guidance systems, wherein to optimize is with respect to minimizing the Sⱼ value. In some embodiments, the at least one controller comprises an electrical circuit or a socket. In some embodiments, the at least one controller comprises programmable circuitry (e.g., a Field Programmable Gate Array). In some embodiments, the at least one controller is configured to direct the energy source to irradiate a plurality of energy beams. In some embodiments, the at least one controller is further configured to align at least one of the plurality of energy beams with respect to a requested position on a target surface to form the three-dimensional object. In some embodiments, the at least one controller is configured to select, or direct selection of, the location Aⱼ such that the point P satisfies having a Sⱼ value of from about minus one (−1) to about zero point five (0.5). In some embodiments, the at least one controller selects the location Aⱼ. In some embodiments, the at least one controller selects a guidance system from the at least one guidance system, which guidance system that is selected is at the location Aⱼ. In some embodiments, the at least one controller translates the at least one guidance system to the location Aⱼ.

In another aspect, a method for printing a three-dimensional object, comprises: selecting a location Aⱼ from a location set A₁, A₂, . . . Aₙ, wherein n and j are integers; generating an energy beam to impinge on at least one guidance system at the location Aⱼ; and using the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein the point P satisfies having an Sⱼ value of from about minus one (−1) to about zero point five (0.5).

In some embodiments, the point P satisfies having a Sⱼ value of from about minus one (−1) to about zero point two (0.2, or one fifth). In some embodiments, the point P satisfies having a Sⱼ value of from about minus one (−1) to about zero. In some embodiments, the point P satisfies having a Sⱼ value of at most about zero. In some embodiments, the at least one guidance system further comprises a plurality of guidance systems disposed at locations within the location set A₁, A₂, . . . Aₙ, and/or wherein the energy source is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the energy source. In some embodiments, the method further comprises aligning the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the method further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically or spectroscopically detecting. In some embodiments, the method further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point 5 (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, selecting the location Aⱼ is such that the point P satisfies having a Sⱼ value of from about minus one (−1) to about zero point five (0.5). In some embodiments, selecting is of a guidance system from the at least one guidance system, which guidance system that is selected is at the location Aⱼ. In some embodiments, the method further comprises translating the at least one guidance system to the location Aⱼ. In some embodiments, at least one of the at least one guidance system is stationary during printing. In some embodiments, the method further comprises translating a guidance system of the at least one guidance system. In some embodiments, translating the guidance system is during printing. In some embodiments, translating the guidance system is during printing as the energy beam ceases to impinge on the guidance system.

In another aspect, a computer program product for printing of a three-dimensional object, comprises a non-transitory computer-readable medium in which program instructions are stored, which instructions, when read by a computer, cause the computer to perform operations comprises: selecting a location Aⱼ from a location set A₁, A₂, . . . Aₙ, wherein n and j are integers; directing an energy beam to impinge on at least one guidance system at the location Aⱼ; and directing the energy beam from (a) the at least one guidance system disposed at the location Aⱼ to (b) a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein the point P satisfies having an Sⱼ value of from about minus one (−1) to about zero point five (0.5).

In some embodiments, selecting the location Aⱼ is such that the point P satisfies having a Sⱼ value of from about minus one (−1) to about zero point five (0.5). In some embodiments, the point P satisfies having a Sⱼ value of from about minus one (−1) to about zero point two (0.2). In some embodiments, the point P satisfies having a Sⱼ value of from about minus one (−1) to about zero. In some embodiments, the point P satisfies having a Sⱼ value of at most about zero. In some embodiments, the at least one guidance system further comprises a plurality of guidance systems disposed at locations within the location set A₁, A₂, . . . Aₙ, and/or wherein an energy source that is generating the energy beam is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the first energy source. In some embodiments, the computer program product further comprises aligning at least one of the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the computer program product further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically and/or spectroscopically detecting. In some embodiments, the computer program product further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam, from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, the location Aⱼ is selected such that the printing of the three-dimensional object is minimizing a deviation between a formed three-dimensional object and a (e.g., CAD) model of the three-dimensional object.

In another aspect, a system for printing a three-dimensional object comprises: a platform that is configured to support the three-dimensional object during printing; an energy source that is configured to generate an energy beam; and at least one guidance system operatively coupled with the energy source, which at least one guidance system is disposed at a location Aⱼ of a location set A₁, A₂, . . . Aₙ, wherein j and n are integers, wherein the at least one guidance system is configured to direct the energy beam from the location Aⱼ to a point P on a surface of the three-dimensional object during its printing, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein the point P satisfies having an Sⱼ value of from about minus one (−1) to about zero point five (0.5).

In some embodiments, the at least one guidance system comprise sapphire, silicon carbide (SiC), beryllium, zinc selenide, calcium fluoride (CaF₂), or fused silica. In some embodiments, the at least one guidance system is operatively coupled to one or more controllers that is configured to select, or directs selection of, the location Aⱼ. In some embodiments, the one or more controllers is configured to select, or directs selection of, a guidance system from the at least one guidance system, which guidance system that is selected is at the location Aⱼ. In some embodiments, the one or more controllers translate the at least one guidance system to the location Aⱼ. In some embodiments, the system further comprises a guide that is operatively coupled to at least one optical element, and is configured to facilitate translation of the at least one optical element. In some embodiments, the guide comprises a railing. In some embodiments, the guide is operatively coupled to an actuator. In some embodiments, the actuator is controlled by one or more controllers. In some embodiments, translation of the at least one optical element facilitates projection of the energy beam from at least two locations of the location set A₁, A₂, . . . Aₙ. In some embodiments, the at least one optical element comprises sapphire, silicon carbide (SiC), beryllium, zinc selenide, calcium fluoride (CaF₂), or fused silica. In some embodiments, the system further comprises a guide that is operatively coupled to a guidance system of the at least one guidance system, and is configured to facilitate translation of the guidance system. In some embodiments, the guide comprises a railing. In some embodiments, the guide is operatively coupled to an actuator. In some embodiments, the actuator is controlled by one or more controllers. In some embodiments, translation of the guidance system facilitates projection of the energy beam from at least two locations of the location set A₁, A₂, . . . Aₙ. In some embodiments, the system further comprises a guide that is operatively coupled to the energy source, and is configured to facilitate translation of the energy source. In some embodiments, the guide comprises a railing. In some embodiments, the guide is operatively coupled to an actuator. In some embodiments, the actuator is controlled by one or more controllers. In some embodiments, translation of the energy source facilitates projection of the energy beam from at least two locations of location set A₁, A₂, . . . Aₙ. In some embodiments, the at least one guidance system comprises two guidance systems, each of which is disposed at different vertical heights with respect to the platform. In some embodiments, the two guidance systems each facilitate projection from two different locations of the location set A₁, A₂, . . . Aₙ. In some embodiments, the energy source is a first energy source, wherein the system further comprises a second energy source that is disposed at a different vertical height with respect to the platform as compared to the first energy source. In some embodiments, at least one of the at least one guidance system is configured to remain stationary during the printing. In some embodiments, at least one of the at least one guidance system is configured to translate during the printing. In some embodiments, the platform is disposed in an enclosure. In some embodiments, the enclosure is configured to enclosure an internal atmosphere different from an ambient atmosphere that is external to the enclosure at least during the printing. In some embodiments, the internal atmosphere comprises an inert gas. In some embodiments, the internal atmosphere comprises a pressure above ambient pressure. In some embodiments, the at least one guidance system is operatively aligned with respect to a requested position on a target surface to form the three-dimensional object. In some embodiments, the system further comprises at least one controller that is configured to operatively couple (e.g., and is operatively coupled) to the at least one guidance system and is configured to align, or direct alignment of, the at least one guidance system with respect to a target surface to form the three-dimensional object. In some embodiments, the energy source comprises an electrical inlet, an electrical outlet, and/or electrical circuitry.

In another aspect, a system for printing a three-dimensional object comprises: a platform that is configured to support the three-dimensional object during printing; an energy source that is configured to generate an energy beam; and at least one guidance system operatively coupled with the energy source, which at least one guidance system is disposed at a location Aⱼ of a location set A₁, A₂, . . . Aₙ, wherein j and n are integers, wherein the at least one guidance system is configured to direct the energy beam from the location Aⱼ to a point P on a surface of the three-dimensional object during its printing, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ. M, and wherein the location Aⱼ is such that: Sⱼ=min {S₁, S₂, . . . Sₙ}.

In some embodiments, the at least one guidance system comprise sapphire, silicon carbide (SiC), beryllium, zinc selenide, calcium fluoride (CaF₂), or fused silica. In some embodiments, the at least one guidance system is operatively coupled to one or more controllers that is configured to select, or directs selection of, the location Aⱼ. In some embodiments, the one or more controllers is configured to select, or directs selection of, a guidance system from the at least one guidance system, which guidance system that is selected is at the location Aⱼ. In some embodiments, the one or more controllers translate the at least one guidance system to the location Aⱼ. In some embodiments, the system further comprises a guide that is operatively coupled to at least one optical element, and is configured to facilitate translation of the at least one optical element. In some embodiments, the guide comprises a railing. In some embodiments, the guide is operatively coupled to an actuator. In some embodiments, the actuator is controlled by one or more controllers. In some embodiments, translation of the at least one optical element facilitates projection of the energy beam from at least two locations of the location set A₁, A₂, . . . Aₙ. In some embodiments, the at least one optical element comprises sapphire, silicon carbide (SiC), beryllium, zinc selenide, calcium fluoride (CaF₂), or fused silica. In some embodiments, the system further comprises a guide that is operatively coupled to a guidance system of the at least one guidance system, and is configured to facilitate translation of the guidance system. In some embodiments, the guide comprises a railing. In some embodiments, the guide is operatively coupled to an actuator. In some embodiments, the actuator is controlled by one or more controllers. In some embodiments, translation of the guidance system facilitates projection of the energy beam from at least two locations of the location set A₁, A₂, . . . Aₙ. In some embodiments, the system further comprises a guide that is operatively coupled to the energy source, and is configured to facilitate translation of the energy source. In some embodiments, the guide comprises a railing. In some embodiments, the guide is operatively coupled to an actuator. In some embodiments, the actuator is controlled by one or more controllers. In some embodiments, translation of the energy source facilitates projection of the energy beam from at least two locations of location set A₁, A₂, . . . Aₙ. In some embodiments, the at least one guidance system comprises two guidance systems, each of which is disposed at different vertical heights with respect to the platform. In some embodiments, the two guidance systems each facilitate projection from two different locations of the location set A₁, A₂, . . . Aₙ. In some embodiments, the energy source is a first energy source, wherein the system further comprises a second energy source that is disposed at a different vertical height with respect to the platform as compared to the first energy source. In some embodiments, at least one of the at least one guidance system is configured to remain stationary during the printing. In some embodiments, at least one of the at least one guidance system is configured to translate during the printing. In some embodiments, the platform is disposed in an enclosure. In some embodiments, the enclosure is configured to enclosure an internal atmosphere different from an ambient atmosphere that is external to the enclosure at least during the printing. In some embodiments, the internal atmosphere comprises an inert gas. In some embodiments, the internal atmosphere comprises a pressure above ambient pressure. In some embodiments, the at least one guidance system is operatively aligned with respect to a requested position on a target surface to form the three-dimensional object. In some embodiments, the system further comprises at least one controller that is configured to operatively couple (e.g., and is operatively coupled) to the at least one guidance system and is configured to align, or direct alignment of, the at least one guidance system with respect to a target surface to form the three-dimensional object. In some embodiments, the energy source comprises an electrical inlet, an electrical outlet, and/or electrical circuitry.

In another aspect, an apparatus for printing a three-dimensional object comprises one or more controllers configured to operatively couple (e.g., and are operatively coupled) to an energy source and to one or more guidance systems, the one or more controllers are configured to direct: the energy source to irradiate an energy beam to the one or more guidance systems; the one or more guidance systems to select a location Aⱼ from a location set A₁, A₂, . . . Aₙ, wherein n and j are integers; and the one or more guidance systems to guide (e.g., direct) the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein the location Aⱼ is such that: Sⱼ=min {S₁, S₂, . . . Sₙ}.

In some embodiments, the point P satisfies having a Sⱼ value of from about minus one (−1) to about zero (0). In some embodiments, the one or more controllers is configured to select, or directs selection of, the location Aⱼ. In some embodiments, the one or more controllers is configured to select, or directs selection of, a guidance system from the one or more guidance systems, which guidance system that is selected is at the location Aⱼ. In some embodiments, the one or more controllers translates the one or more guidance system to the location Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a first cross section of a first layering plane with the surface, and the point is in a second cross section of a second layering plane with the surface. In some embodiments, the one or more controllers are further configured to operatively couple (e.g., and is operatively coupled) to a sensor that is configured to detect (a) a position of the one or more guidance systems with respect to the location set A₁, A₂, . . . Aa, (b) at least one energy beam characteristic and/or (c) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, to detect the signal comprises a detection of a temperature of the energy beam footprint on the surface, or a vicinity thereof. In some embodiments, the vicinity is at most about seven (7) fundamental length scales of the energy beam footprint, centering at the energy beam footprint. In some embodiments, the sensor comprises an encoder, a switch, a CCD, a line scan CCD, a line scan CMOS, a video camera, or a spectrometer. In some embodiments, the one or more guidance systems are disposed within an optical enclosure that is configured to facilitate separation of the energy beam from an environment external to the optical enclosure. In some embodiments, the optical enclosure comprises one or more optical elements, the one or more optical elements arranged to direct and/or to transmit the energy beam, wherein the one or more optical elements comprise a lens, a mirror, a beam splitter, or an optical window. In some embodiments, the one or more optical elements comprise sapphire, beryllium, zinc selenide, calcium fluoride (CaF₂), or fused silica. In some embodiments, the one or more guidance systems are mounted or disposed on a railing, the railing comprising locations of the location set A₁, A₂, . . . Aₙ, the railing comprising at least one actuator configured to move the one or more guidance systems from a first location to a second location of the location set A₁, A₂, . . . Aₙ. In some embodiments, the one or more guidance systems are translated using remote control. In some embodiments, the one or more guidance systems are translated using local control. In some embodiments, a translation of at least one of the one or more guidance systems is wired. In some embodiments, a translation of at least one of the one or more guidance systems is wireless. In some embodiments, the surface comprises an exposed surface of an enclosure, wherein the enclosure comprises an inert or non-reactive atmosphere, which non-reactive is with the three-dimensional object or a pre-transformed material that is transformed to form the three-dimensional object (e.g., during and/or after printing). In some embodiments, the enclosure further comprises a processing chamber and a container, wherein the container comprises the pre-transformed material or the three-dimensional object and is removably coupled with the processing chamber. In some embodiments, the energy source is a first energy source, wherein the energy beam is a first energy beam, and wherein the one or more controllers is configured to operatively couple (e.g., and is operatively coupled) to a second energy source that is configured to irradiate a second energy beam, such that: (A) a first guidance system of the one or more guidance systems is disposed above a second guidance system of the one or more guidance systems, (B) the first energy source is disposed above the second energy source, and/or (C) the first energy beam is irradiated above the second energy beam, wherein above is with respect to the global vector (e.g., in a direction opposite to the global vector). In some embodiments, the one or more controllers are further configured to align the first energy beam and/or the second energy beam with respect to a requested position on a target surface to form the three-dimensional object. In some embodiments, the platform is configured to directly or indirectly support the three-dimensional object during the printing. In some embodiments, the one or more controllers are configured to select, or direct selection of, the location Aⱼ such that the point P satisfies having a Sⱼ value of from about minus one (−1) to about zero point five (0.5). In some embodiments, at least two of operations (i), (ii), and (iii) are controlled by the same controller. In some embodiments, at least two of operations (i), (ii), and (iii) are each controlled by a different controller. In some embodiments, the one or more controllers direct (i), (ii), and/or (iii) in real time during the printing.

In another aspect, an apparatus for printing a three-dimensional object, comprises at least one controller that is configured to operatively couple (e.g., and is operatively coupled) to an energy source and to at least one guidance system, the at least one controller is configured to: select, or direct selection of, a location Aⱼ of the at least one guidance system from a location set A₁, A₂, . . . Aₙ, wherein n and j are integers; direct the energy source to irradiate an energy beam to the at least one guidance system disposed at the location Aⱼ; and direct the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein the location Aⱼ is such that: Sⱼ=min {S₁, S₂, . . . Sₙ}.

In some embodiments, the at least one controller is further configured to operatively couple (e.g., and is operatively coupled) to a sensor that is configured to detect (A) a position of the at least one guidance system with respect to the location set A₁, A₂, . . . Aₙ, (B) at least one energy beam characteristic and/or (C) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, the sensor comprises an encoder, a switch, a CCD, a line scan CCD, a line scan CMOS, a video camera, or a spectrometer. In some embodiments, the at least one controller is configured to adjust at least one of (A) or (B), considering a detection of (A)-(C). In some embodiments, to adjust comprises a closed loop control scheme, which closed loop control comprises a feedback or a feed-forward control scheme. In some embodiments, the closed loop control is in real time, wherein real time comprises during the printing at least a portion of the three-dimensional object. In some embodiments, at least a first one of the at least one guidance system is configured for movement from a first location to a second location with of the location set A₁, A₂, . . . Aₙ. In some embodiments, the at least one guidance system further comprises a plurality of guidance systems disposed at locations within the location set A₁, A₂, . . . Aₙ, and/or wherein the energy source is a first energy source of a plurality of energy sources. In some embodiments, the at least one controller is configured to optimize (e.g., to select) a guidance system of the plurality of guidance systems to guide (e.g., direct) the energy beam considering the point P and/or a location of the energy source, wherein to optimize is with respect to minimizing the Sⱼ value. In some embodiments, the at least one controller is configured to optimize (e.g., to select) an energy source of the plurality of energy sources to irradiate the energy beam considering the point P and/or a location of a guidance system of the plurality of guidance systems, wherein to optimize is with respect to minimizing the Sⱼ value. In some embodiments, the at least one controller comprises an electrical circuit or a socket. In some embodiments, the at least one controller comprises programmable circuitry (e.g., a Field Programmable Gate Array). In some embodiments, the at least one controller is configured to direct the energy source to irradiate a plurality of energy beams. In some embodiments, the at least one controller is further configured to align at least one of the plurality of energy beams with respect to a requested position on a target surface to form the three-dimensional object. In some embodiments, the at least one controller is configured to select, or direct selection of, the location Aⱼ such that the point P satisfies having a Sⱼ value of from about minus one (−1) to about zero point five (0.5). In some embodiments, the at least one controller selects the location Aⱼ. In some embodiments, the at least one controller selects a guidance system from the at least one guidance system, which guidance system that is selected is at the location Aⱼ. In some embodiments, the at least one controller translates the at least one guidance system to the location Aⱼ.

In another aspect, a method for printing a three-dimensional object, comprises: selecting a location Aⱼ from a location set A₁, A₂, . . . Aₙ, wherein n and j are integers; generating an energy beam to impinge on at least one guidance system at the location Aⱼ; and using the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein the location Aⱼ is such that: Sⱼ=min {S₁, S₂, . . . Sₙ}.

In some embodiments, the point P satisfies having a Sⱼ value of from about minus one (−1) to about zero point two (0.2, or one fifth). In some embodiments, the point P satisfies having a Sⱼ value of from about minus one (−1) to about zero. In some embodiments, the point P satisfies having a Sⱼ value of at most about zero. In some embodiments, the at least one guidance system further comprises a plurality of guidance systems disposed at locations within the location set A₁, A₂, . . . Aₙ, and/or wherein the energy source is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the energy source. In some embodiments, the method further comprises aligning the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the method further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically or spectroscopically detecting. In some embodiments, the method further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point 5 (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, selecting the location Aⱼ is such that the point P satisfies having an Sⱼ value of from about minus one (−1) to about zero point five (0.5). In some embodiments, selecting is of a guidance system from the at least one guidance system, which guidance system that is selected is at the location Aⱼ. In some embodiments, the method further comprises translating the at least one guidance system to the location Aⱼ. In some embodiments, at least one of the at least one guidance system is stationary during printing. In some embodiments, the method further comprises translating a guidance system of the at least one guidance system. In some embodiments, translating the guidance system is during printing. In some embodiments, translating the guidance system is during printing as the energy beam ceases to impinge on the guidance system.

In another aspect, a computer program product for printing of a three-dimensional object, comprises a non-transitory computer-readable medium in which program instructions are stored, which instructions, when read by a computer, cause the computer to perform operations comprises: selecting a location Aⱼ from a location set A₁, A₂, . . . Aₙ, wherein n and j are integers; directing an energy beam to impinge on at least one guidance system at the location Aⱼ; and directing the energy beam from (a) the at least one guidance system disposed at the location Aⱼ to (b) a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, wherein the location Aⱼ is such that: Sⱼ=min {S₁, S₂, . . . Sₙ}.

In some embodiments, selecting the location Aⱼ is such that the point P satisfies having an Sⱼ value of from about minus one (−1) to about zero point five (0.5). In some embodiments, the point P satisfies having an Sⱼ value of from about minus one (−1) to about zero point two (0.2). In some embodiments, the point P satisfies having an Sⱼ value of from about minus one (−1) to about zero. In some embodiments, the point P satisfies having an Sⱼ value of at most about zero. In some embodiments, the at least one guidance system further comprises a plurality of guidance systems disposed at locations within the location set A₁, A₂, . . . Aₙ, and/or wherein an energy source that is generating the energy beam is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the first energy source. In some embodiments, the computer program product further comprises aligning at least one of the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the computer program product further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically and/or spectroscopically detecting. In some embodiments, the computer program product further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam, from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, the location Aⱼ is selected such that the printing of the three-dimensional object is minimizing a deviation between a formed three-dimensional object and a (e.g., CAD) model of the three-dimensional object.

In another aspect, a system for printing a three-dimensional object comprises: a platform that is configured to support the three-dimensional object during printing; an energy source that is configured to generate an energy beam; and at least one guidance system operatively coupled with the energy source, which at least one guidance system is disposed at a location Aⱼ of a location set A₁, A₂, . . . Aₙ, wherein j and n are integers, wherein the at least one guidance system is configured to direct the energy beam from the location Aⱼ to a point P on a surface of the three-dimensional object during its printing, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein Sⱼ has a value of from about minus one (−1) to about one half (0.5).

In some embodiments, the at least one guidance system comprise sapphire, silicon carbide (SiC), beryllium, zinc selenide, calcium fluoride (CaF₂), or fused silica. In some embodiments, the at least one guidance system is operatively coupled to one or more controllers that is configured to select, or directs selection of, the location Aⱼ. In some embodiments, the one or more controllers is configured to select, or directs selection of, a guidance system from the at least one guidance system, which guidance system that is selected is at the location Aⱼ. In some embodiments, the one or more controllers translate the at least one guidance system to the location Aⱼ. In some embodiments, the system further comprises a guide that is operatively coupled to at least one optical element, and is configured to facilitate translation of the at least one optical element. In some embodiments, the guide comprises a railing. In some embodiments, the guide is operatively coupled to an actuator. In some embodiments, the actuator is controlled by one or more controllers. In some embodiments, translation of the at least one optical element facilitates projection of the energy beam from at least two locations of the location set A₁, A₂, . . . Aₙ. In some embodiments, the at least one optical element comprises sapphire, silicon carbide (SiC), beryllium, zinc selenide, calcium fluoride (CaF₂), or fused silica. In some embodiments, the system further comprises a guide that is operatively coupled to a guidance system of the at least one guidance system, and is configured to facilitate translation of the guidance system. In some embodiments, the guide comprises a railing. In some embodiments, the guide is operatively coupled to an actuator. In some embodiments, the actuator is controlled by one or more controllers. In some embodiments, translation of the guidance system facilitates projection of the energy beam from at least two locations of the location set A₁, A₂, . . . Aₙ. In some embodiments, the system further comprises a guide that is operatively coupled to the energy source, and is configured to facilitate translation of the energy source. In some embodiments, the guide comprises a railing. In some embodiments, the guide is operatively coupled to an actuator. In some embodiments, the actuator is controlled by one or more controllers. In some embodiments, translation of the energy source facilitates projection of the energy beam from at least two locations of location set A₁, A₂, . . . Aₙ. In some embodiments, the at least one guidance system comprises two guidance systems, each of which is disposed at different vertical heights with respect to the platform. In some embodiments, the two guidance systems each facilitate projection from two different locations of the location set A₁, A₂, . . . Aₙ. In some embodiments, the energy source is a first energy source, wherein the system further comprises a second energy source that is disposed at a different vertical height with respect to the platform as compared to the first energy source. In some embodiments, at least one of the at least one guidance system is configured to remain stationary during the printing. In some embodiments, at least one of the at least one guidance system is configured to translate during the printing. In some embodiments, the platform is disposed in an enclosure. In some embodiments, the enclosure is configured to enclosure an internal atmosphere different from an ambient atmosphere that is external to the enclosure at least during the printing. In some embodiments, the internal atmosphere comprises an inert gas. In some embodiments, the internal atmosphere comprises a pressure above ambient pressure. In some embodiments, the at least one guidance system is operatively aligned with respect to a requested position on a target surface to form the three-dimensional object. In some embodiments, the system further comprises at least one controller that is configured to operatively couple (e.g., and is operatively coupled) to the at least one guidance system and is configured to align, or direct alignment of, the at least one guidance system with respect to a target surface to form the three-dimensional object. In some embodiments, the energy source comprises an electrical inlet, an electrical outlet, and/or electrical circuitry.

In another aspect, an apparatus for printing a three-dimensional object comprises one or more controllers configured to operatively couple (e.g., and are operatively coupled) to an energy source and to one or more guidance systems, the one or more controllers are configured to direct: the energy source to irradiate an energy beam to the one or more guidance systems; the one or more guidance systems to select a location Aⱼ from a location set A₁, A₂, . . . Aₙ, wherein n and j are integers; and the one or more guidance systems to guide (e.g., direct) the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein Sⱼ has a value of from about minus one (−1) to about one half (0.5).

In some embodiments, the point P satisfies having an Sⱼ value of from about minus one (−1) to about zero (0). In some embodiments, the one or more controllers is configured to select, or direst selection of, the location Aⱼ. In some embodiments, the one or more controllers is configured to select, or direst selection of, a guidance system from the one or more guidance systems, which guidance system that is selected is at the location Aⱼ. In some embodiments, the one or more controllers translates the one or more guidance system to the location Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a first cross section of a first layering plane with the surface, and the point is in a second cross section of a second layering plane with the surface. In some embodiments, the one or more controllers are further configured to operatively couple (e.g., and is operatively coupled) to a sensor that is configured to detect (a) a position of the one or more guidance systems with respect to the location set A₁, A₂, . . . Aₙ, (b) at least one energy beam characteristic and/or (c) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, to detect the signal comprises a detection of a temperature of the energy beam footprint on the surface, or a vicinity thereof. In some embodiments, the vicinity is at most about seven (7) fundamental length scales of the energy beam footprint, centering at the energy beam footprint. In some embodiments, the sensor comprises an encoder, a switch, a CCD, a line scan CCD, a line scan CMOS, a video camera, or a spectrometer. In some embodiments, the one or more guidance systems are disposed within an optical enclosure that is configured to facilitate separation of the energy beam from an environment external to the optical enclosure. In some embodiments, the optical enclosure comprises one or more optical elements, the one or more optical elements arranged to direct and/or to transmit the energy beam, wherein the one or more optical elements comprise a lens, a mirror, a beam splitter, or an optical window. In some embodiments, the one or more optical elements comprise sapphire, beryllium, zinc selenide, calcium fluoride (CaF₂), or fused silica. In some embodiments, the one or more guidance systems are mounted or disposed on a railing, the railing comprising locations of the location set A₁, A₂, . . . Aₙ, the railing comprising at least one actuator configured to move the one or more guidance systems from a first location to a second location of the location set A₁, A₂ . . . , Aₙ. In some embodiments, the one or more guidance systems are translated using remote control. In some embodiments, the one or more guidance systems are translated using local control. In some embodiments, a translation of at least one of the one or more guidance systems is wired. In some embodiments, a translation of at least one of the one or more guidance systems is wireless. In some embodiments, the surface comprises an exposed surface of an enclosure, wherein the enclosure comprises an inert or non-reactive atmosphere, which non-reactive is with the three-dimensional object or a pre-transformed material that is transformed to form the three-dimensional object (e.g., during and/or after printing). In some embodiments, the enclosure further comprises a processing chamber and a container, wherein the container comprises the pre-transformed material or the three-dimensional object and is removably coupled with the processing chamber. In some embodiments, the energy source is a first energy source, wherein the energy beam is a first energy beam, and wherein the one or more controllers is configured to operatively couple (e.g., and is operatively coupled) to a second energy source that is configured to irradiate a second energy beam, such that: (A) a first guidance system of the one or more guidance systems is disposed above a second guidance system of the one or more guidance systems, (B) the first energy source is disposed above the second energy source, and/or (C) the first energy beam is irradiated above the second energy beam, wherein above is with respect to the global vector (e.g., in a direction opposite to the global vector). In some embodiments, the one or more controllers are further configured to align the first energy beam and/or the second energy beam with respect to a requested position on a target surface to form the three-dimensional object. In some embodiments, the platform is configured to directly or indirectly support the three-dimensional object during the printing. In some embodiments, the one or more controllers are configured to select, or direct selection of, the location Aⱼ such that the point P satisfies having an Sⱼ value of from about minus one (−1) to about zero point five (0.5). In some embodiments, at least two of operations (i), (ii), and (iii) are controlled by the same controller. In some embodiments, at least two of operations (i), (ii), and (iii) are each controlled by a different controller. In some embodiments, the one or more controllers direct (i), (ii), and/or (iii) in real time during the printing.

In another aspect, an apparatus for printing a three-dimensional object, comprises at least one controller that is configured to operatively couple (e.g., and is operatively coupled) to an energy source and to at least one guidance system, the at least one controller is configured to: select, or direct selection of, a location Aⱼ of the at least one guidance system from a location set A₁, A₂, . . . Aₙ, wherein n and j are integers; direct the energy source to irradiate an energy beam to the at least one guidance system disposed at the location Aⱼ; and direct the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, and wherein M is a unit vector of a projection of N on a plane normal to the global vector, wherein Sⱼ is a scalar product of Uⱼ·M, and wherein Sⱼ has a value of from about minus one (−1) to about one half (0.5).

In some embodiments, the at least one controller is further configured to operatively couple (e.g., and is operatively coupled) to a sensor that is configured to detect (A) a position of the at least one guidance system with respect to the location set A₁, A₂, . . . Aₙ, (B) at least one energy beam characteristic and/or (C) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, the sensor comprises an encoder, a switch, a CCD, a line scan CCD, a line scan CMOS, a video camera, or a spectrometer. In some embodiments, the at least one controller is configured to adjust at least one of (A) or (B), considering a detection of (A)-(C). In some embodiments, to adjust comprises a closed loop control scheme, which closed loop control comprises a feedback or a feed-forward control scheme. In some embodiments, the closed loop control is in real time, wherein real time comprises during the printing at least a portion of the three-dimensional object. In some embodiments, at least a first one of the at least one guidance system is configured for movement from a first location to a second location with of the location set A₁, A₂, . . . Aₙ. In some embodiments, the at least one guidance system further comprises a plurality of guidance systems disposed at locations within the location set A₁, A₂, . . . Aₙ, and/or wherein the energy source is a first energy source of a plurality of energy sources. In some embodiments, the at least one controller is configured to optimize (e.g., to select) a guidance system of the plurality of guidance systems to guide (e.g., direct) the energy beam considering the point P and/or a location of the energy source, wherein to optimize is with respect to minimizing the Sⱼ value. In some embodiments, the at least one controller is configured to optimize (e.g., to select) an energy source of the plurality of energy sources to irradiate the energy beam considering the point P and/or a location of a guidance system of the plurality of guidance systems, wherein to optimize is with respect to minimizing the Sⱼ value. In some embodiments, the at least one controller comprises an electrical circuit or a socket. In some embodiments, the at least one controller comprises programmable circuitry (e.g., a Field Programmable Gate Array). In some embodiments, the at least one controller is configured to direct the energy source to irradiate a plurality of energy beams. In some embodiments, the at least one controller is further configured to align at least one of the plurality of energy beams with respect to a requested position on a target surface to form the three-dimensional object. In some embodiments, the at least one controller is configured to select, or direct selection of, the location Aⱼ such that Sⱼ has a value of from about minus one (−1) to about zero point five (0.5). In some embodiments, the at least one controller selects the location Aⱼ. In some embodiments, the at least one controller selects a guidance system from the at least one guidance system, which guidance system that is selected is at the location Aⱼ. In some embodiments, the at least one controller translates the at least one guidance system to the location Aⱼ.

In another aspect, a method for printing a three-dimensional object, comprises: selecting a location Aⱼ from a location set A₁, A₂, . . . Aₙ, wherein n and j are integers; generating an energy beam to impinge on at least one guidance system at the location Aⱼ; and using the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Sⱼ has a value of from about minus one (−1) to about one half (0.5).

In some embodiments, selecting Aⱼ is such that Sⱼ has a value of from about minus one (−1) to about zero point two (0.2, or one fifth). In some embodiments, selecting Aⱼ is such that Sⱼ has a value of from about minus one (−1) to about zero. In some embodiments, selecting Aⱼ is such that Sⱼ has a value of at most about zero. In some embodiments, the at least one guidance system further comprises a plurality of guidance systems disposed at locations within the location set A₁, A₂, . . . Aₙ, and/or wherein the energy source is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the energy source. In some embodiments, the method further comprises aligning the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the method further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically or spectroscopically detecting. In some embodiments, the method further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point 5 (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, selecting the location Aⱼ is such that Sⱼ has a value of from about minus one (−1) to about zero point five (0.5). In some embodiments, selecting is of a guidance system from the at least one guidance system, which guidance system that is selected is at the location Aⱼ. In some embodiments, the method further comprises translating the at least one guidance system to the location Aⱼ. In some embodiments, at least one of the at least one guidance system is stationary during printing. In some embodiments, the method further comprises translating a guidance system of the at least one guidance system. In some embodiments, translating the guidance system is during printing. In some embodiments, translating the guidance system is during printing as the energy beam ceases to impinge on the guidance system.

In another aspect, a computer program product for printing of a three-dimensional object, comprises a non-transitory computer-readable medium in which program instructions are stored, which instructions, when read by a computer, cause the computer to perform operations comprises: selecting a location Aⱼ from a location set A₁, A₂, . . . Aₙ, wherein n and j are integers; directing an energy beam to impinge on at least one guidance system at the location Aⱼ; and directing the energy beam from (a) the at least one guidance system disposed at the location Aⱼ to (b) a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Sⱼ has a value of from about minus one (−1) to about one half (0.5).

In some embodiments, selecting the location Aⱼ is such that Sⱼ has a value of from about minus one (−1) to about zero point five (0.5). In some embodiments, selecting Aⱼ is such that Sⱼ has a value of from about minus one (−1) to about zero point two (0.2). In some embodiments, selecting Aⱼ is such that Sⱼ has a value of from about minus one (−1) to about zero. In some embodiments, selecting Aⱼ is such that Sⱼ has a value of at most about zero. In some embodiments, the at least one guidance system further comprises a plurality of guidance systems disposed at locations within the location set A₁, A₂, . . . Aₙ, and/or wherein an energy source that is generating the energy beam is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the first energy source. In some embodiments, the computer program product further comprises aligning at least one of the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the computer program product further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically and/or spectroscopically detecting. In some embodiments, the computer program product further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam, from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, the location Aⱼ is selected such that the printing of the three-dimensional object is minimizing a deviation between a formed three-dimensional object and a (e.g., CAD) model of the three-dimensional object.

In another aspect, a system for printing a three-dimensional object comprises: a platform that is configured to support the three-dimensional object during printing; an energy source that is configured to generate an energy beam; and at least one guidance system operatively coupled with the energy source, which at least one guidance system is disposed at a location Aⱼ of a location set A₁, A₂, . . . Aₙ, wherein j and n are integers, wherein the at least one guidance system is configured to direct the energy beam from the location Aⱼ to a point P on a surface of the three-dimensional object during its printing, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, wherein R is a constant having a value that ranges from zero to one, and wherein the location Aⱼ is such that: Sⱼ+R·Wⱼ=min {S₁+R·W₁, S₂+R·W₂, . . . Sₙ+R·Wₙ}.

In some embodiments, the at least one guidance system comprise sapphire, silicon carbide (SiC), beryllium, zinc selenide, calcium fluoride (CaF₂), or fused silica. In some embodiments, the at least one guidance system is operatively coupled to one or more controllers that is configured to select, or directs selection of, the location Aⱼ. In some embodiments, the one or more controllers is configured to select, or direst selection of, a guidance system from the at least one guidance system, which guidance system that is selected is at the location Aⱼ. In some embodiments, the one or more controllers translate the at least one guidance system to the location Aⱼ. In some embodiments, the system further comprises a guide that is operatively coupled to at least one optical element, and is configured to facilitate translation of the at least one optical element. In some embodiments, the guide comprises a railing. In some embodiments, the guide is operatively coupled to an actuator. In some embodiments, the actuator is controlled by one or more controllers. In some embodiments, translation of the at least one optical element facilitates projection of the energy beam from at least two locations of the location set A₁, A₂, . . . Aₙ. In some embodiments, the at least one optical element comprises sapphire, silicon carbide (SiC), beryllium, zinc selenide, calcium fluoride (CaF₂), or fused silica. In some embodiments, the system further comprises a guide that is operatively coupled to a guidance system of the at least one guidance system, and is configured to facilitate translation of the guidance system. In some embodiments, the guide comprises a railing. In some embodiments, the guide is operatively coupled to an actuator. In some embodiments, the actuator is controlled by one or more controllers. In some embodiments, translation of the guidance system facilitates projection of the energy beam from at least two locations of the location set A₁, A₂, . . . Aₙ. In some embodiments, the system further comprises a guide that is operatively coupled to the energy source, and is configured to facilitate translation of the energy source. In some embodiments, the guide comprises a railing. In some embodiments, the guide is operatively coupled to an actuator. In some embodiments, the actuator is controlled by one or more controllers. In some embodiments, translation of the energy source facilitates projection of the energy beam from at least two locations of location set A₁, A₂, . . . Aₙ. In some embodiments, the at least one guidance system comprises two guidance systems, each of which is disposed at different vertical heights with respect to the platform. In some embodiments, the two guidance systems each facilitate projection from two different locations of the location set A₁, A₂, . . . Aₙ. In some embodiments, the energy source is a first energy source, wherein the system further comprises a second energy source that is disposed at a different vertical height with respect to the platform as compared to the first energy source. In some embodiments, at least one of the at least one guidance system is configured to remain stationary during the printing. In some embodiments, at least one of the at least one guidance system is configured to translate during the printing. In some embodiments, the platform is disposed in an enclosure. In some embodiments, the enclosure is configured to enclosure an internal atmosphere different from an ambient atmosphere that is external to the enclosure at least during the printing. In some embodiments, the internal atmosphere comprises an inert gas. In some embodiments, the internal atmosphere comprises a pressure above ambient pressure. In some embodiments, the at least one guidance system is operatively aligned with respect to a requested position on a target surface to form the three-dimensional object. In some embodiments, the system further comprises at least one controller that is configured to operatively couple (e.g., and is operatively coupled) to the at least one guidance system and is configured to align, or direct alignment of, the at least one guidance system with respect to a target surface to form the three-dimensional object. In some embodiments, the energy source comprises an electrical inlet, an electrical outlet, and/or electrical circuitry.

In another aspect, an apparatus for printing a three-dimensional object comprises one or more controllers configured to operatively couple (e.g., and are operatively coupled) to an energy source and to one or more guidance systems, the one or more controllers are configured to direct: the energy source to irradiate an energy beam to the one or more guidance systems; The one or more guidance systems to select a location Aⱼ from a location set A₁, A₂, . . . Aₙ, wherein n and j are integers; and the one or more guidance systems to guide (e.g., direct) the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, wherein R is a constant having a value that ranges from zero to one, and wherein the location Aⱼ is such that: Sⱼ+R·Wⱼ=min {S₁+R·W₁, S₂+R·W₂, . . . Sₙ+R·Wₙ}.

In some embodiments, the point P satisfies having a Sⱼ value of from about minus one (−1) to about zero (0). In some embodiments, the one or more controllers is configured to select, or direst selection of, the location Aⱼ. In some embodiments, the one or more controllers is configured to select, or direst selection of, a guidance system from the one or more guidance systems, which guidance system that is selected is at the location Aⱼ. In some embodiments, the one or more controllers translates the one or more guidance system to the location Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a first cross section of a first layering plane with the surface, and the point is in a second cross section of a second layering plane with the surface. In some embodiments, the one or more controllers are further configured to operatively couple (e.g., and is operatively coupled) to a sensor that is configured to detect (a) a position of the one or more guidance systems with respect to the location set A₁, A₂, . . . Aₙ, (b) at least one energy beam characteristic and/or (c) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, to detect the signal comprises a detection of a temperature of the energy beam footprint on the surface, or a vicinity thereof. In some embodiments, the vicinity is at most about seven (7) fundamental length scales of the energy beam footprint, centering at the energy beam footprint. In some embodiments, the sensor comprises an encoder, a switch, a CCD, a line scan CCD, a line scan CMOS, a video camera, or a spectrometer. In some embodiments, the one or more guidance systems are disposed within an optical enclosure that is configured to facilitate separation of the energy beam from an environment external to the optical enclosure. In some embodiments, the optical enclosure comprises one or more optical elements, the one or more optical elements arranged to direct and/or to transmit the energy beam, wherein the one or more optical elements comprise a lens, a mirror, a beam splitter, or an optical window. In some embodiments, the one or more optical elements comprise sapphire, beryllium, zinc selenide, calcium fluoride (CaF₂), or fused silica. In some embodiments, the one or more guidance systems are mounted or disposed on a railing, the railing comprising locations of the location set A₁, A₂, . . . Aₙ, the railing comprising at least one actuator configured to move the one or more guidance systems from a first location to a second location of the location set A₁, A₂ . . . , Aₙ. In some embodiments, the one or more guidance systems are translated using remote control. In some embodiments, the one or more guidance systems are translated using local control. In some embodiments, a translation of at least one of the one or more guidance systems is wired. In some embodiments, a translation of at least one of the one or more guidance systems is wireless. In some embodiments, the surface comprises an exposed surface of an enclosure, wherein the enclosure comprises an inert or non-reactive atmosphere, which non-reactive is with the three-dimensional object or a pre-transformed material that is transformed to form the three-dimensional object (e.g., during and/or after printing). In some embodiments, the enclosure further comprises a processing chamber and a container, wherein the container comprises the pre-transformed material or the three-dimensional object and is removably coupled with the processing chamber. In some embodiments, the energy source is a first energy source, wherein the energy beam is a first energy beam, and wherein the one or more controllers is configured to operatively couple (e.g., and is operatively coupled) to a second energy source that is configured to irradiate a second energy beam, such that: (A) a first guidance system of the one or more guidance systems is disposed above a second guidance system of the one or more guidance systems, (B) the first energy source is disposed above the second energy source, and/or (C) the first energy beam is irradiated above the second energy beam, wherein above is with respect to the global vector (e.g., in a direction opposite to the global vector). In some embodiments, the one or more controllers are further configured to align the first energy beam and/or the second energy beam with respect to a requested position on a target surface to form the three-dimensional object. In some embodiments, the platform is configured to directly or indirectly support the three-dimensional object during the printing. In some embodiments, the one or more controllers are configured to select, or direct selection of, the location Aⱼ such that the point P satisfies having an Sⱼ value of from about minus one (−1) to about zero point five (0.5). In some embodiments, at least two of operations (i), (ii), and (iii) are controlled by the same controller. In some embodiments, at least two of operations (i), (ii), and (iii) are each controlled by a different controller. In some embodiments, the one or more controllers direct (i), (ii), and/or (iii) in real time during the printing.

In another aspect, an apparatus for printing a three-dimensional object, comprises at least one controller that is configured to operatively couple (e.g., and is operatively coupled) to an energy source and to at least one guidance system, the at least one controller is configured to: select, or direct selection of, a location Aⱼ of the at least one guidance system from a location set A₁, A₂, . . . Aₙ, wherein n and j are integers; direct the energy source to irradiate an energy beam to the at least one guidance system disposed at the location Aⱼ; and direct the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, wherein R is a constant having a value that ranges from zero to one, and wherein the location Aⱼ is such that: Sⱼ+R·Wⱼ=min {S₁+R·W₁, S₂+R·W₂, . . . Sₙ+R·Wₙ}.

In some embodiments, the at least one controller is further configured to operatively couple (e.g., and is operatively coupled) to a sensor that is configured to detect (A) a position of the at least one guidance system with respect to the location set A₁, A₂, . . . Aₙ, (B) at least one energy beam characteristic and/or (C) a signal emitted from an energy beam footprint on the surface. In some embodiments, the at least one energy beam characteristic comprises (1) a position of the energy beam footprint with respect to the point P, (II) a fundamental length scale of the energy beam footprint, or (Ill) a focal position of the energy beam footprint. In some embodiments, the sensor comprises an encoder, a switch, a CCD, a line scan CCD, a line scan CMOS, a video camera, or a spectrometer. In some embodiments, the at least one controller is configured to adjust at least one of (A) or (B), considering a detection of (A)-(C). In some embodiments, to adjust comprises a closed loop control scheme, which closed loop control comprises a feedback or a feed-forward control scheme. In some embodiments, the closed loop control is in real time, wherein real time comprises during the printing at least a portion of the three-dimensional object. In some embodiments, at least a first one of the at least one guidance system is configured for movement from a first location to a second location with of the location set A₁, A₂, . . . Aₙ. In some embodiments, the at least one guidance system further comprises a plurality of guidance systems disposed at locations within the location set A₁, A₂, . . . Aₙ, and/or wherein the energy source is a first energy source of a plurality of energy sources. In some embodiments, the at least one controller is configured to optimize (e.g., to select) a guidance system of the plurality of guidance systems to guide (e.g., direct) the energy beam considering the point P and/or a location of the energy source, wherein to optimize is with respect to minimizing the Sⱼ value. In some embodiments, the at least one controller is configured to optimize (e.g., to select) an energy source of the plurality of energy sources to irradiate the energy beam considering the point P and/or a location of a guidance system of the plurality of guidance systems, wherein to optimize is with respect to minimizing the Sⱼ value. In some embodiments, the at least one controller comprises an electrical circuit or a socket. In some embodiments, the at least one controller comprises programmable circuitry (e.g., a Field Programmable Gate Array). In some embodiments, the at least one controller is configured to direct the energy source to irradiate a plurality of energy beams. In some embodiments, the at least one controller is further configured to align at least one of the plurality of energy beams with respect to a requested position on a target surface to form the three-dimensional object. In some embodiments, the at least one controller is configured to select, or direct selection of, the location Aⱼ such that the point P satisfies having an Sⱼ value of from about minus one (−1) to about zero point five (0.5). In some embodiments, the at least one controller selects the location Aⱼ. In some embodiments, the at least one controller selects a guidance system from the at least one guidance system, which guidance system that is selected is at the location Aⱼ. In some embodiments, the at least one controller translates the at least one guidance system to the location Aⱼ.

In another aspect, a method for printing a three-dimensional object, comprises: selecting a location Aⱼ from a location set A₁, A₂, . . . Aₙ, wherein n and j are integers; generating an energy beam to impinge on at least one guidance system at the location Aⱼ; and using the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, wherein R is a constant having a value that ranges from zero to one, and wherein the location Aⱼ is such that: Sⱼ+R·Wⱼ=min {S₁+R·W₁, S₂+R·W₂, . . . Sₙ+R·Wₙ}.

In some embodiments, the point P satisfies having a Sⱼ value of from about minus one (−1) to about zero point two (0.2, or one fifth). In some embodiments, the point P satisfies having an Sⱼ value of from about minus one (−1) to about zero. In some embodiments, the point P satisfies having an Sⱼ value of at most about zero. In some embodiments, the at least one guidance system further comprises a plurality of guidance systems disposed at locations within the location set A₁, A₂, . . . Aₙ, and/or wherein the energy source is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the energy source. In some embodiments, the method further comprises aligning the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the method further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically or spectroscopically detecting. In some embodiments, the method further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point 5 (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, selecting the location Aⱼ is such that the point P satisfies having an Sⱼ value of from about minus one (−1) to about zero point five (0.5). In some embodiments, selecting is of a guidance system from the at least one guidance system, which guidance system that is selected is at the location Aⱼ. In some embodiments, the method further comprises translating the at least one guidance system to the location Aⱼ. In some embodiments, at least one of the at least one guidance system is stationary during printing. In some embodiments, the method further comprises translating a guidance system of the at least one guidance system. In some embodiments, translating the guidance system is during printing. In some embodiments, translating the guidance system is during printing as the energy beam ceases to impinge on the guidance system.

In another aspect, a computer program product for printing of a three-dimensional object, comprises a non-transitory computer-readable medium in which program instructions are stored, which instructions, when read by a computer, cause the computer to perform operations comprises: selecting a location Aⱼ from a location set A₁, A₂, . . . Aₙ, wherein n and j are integers; directing an energy beam to impinge on at least one guidance system at the location Aⱼ; and directing the energy beam from (a) the at least one guidance system disposed at the location Aⱼ to (b) a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ. M, and wherein Wⱼ is the scalar product of Vⱼ and Uⱼ, wherein R is a constant having a value that ranges from zero to one, and wherein the location Aⱼ is such that: Sⱼ+R·Wⱼ=min{S₁+R·W₁·S₂+R·W₂, . . . Sₙ+R·Wₙ}.

In some embodiments, selecting the location Aⱼ is such that the point P satisfies having an Sⱼ value of from about minus one (−1) to about zero point five (0.5). In some embodiments, the point P satisfies having an Sⱼ value of from about minus one (−1) to about zero point two (0.2). In some embodiments, the point P satisfies having an Sⱼ value of from about minus one (−1) to about zero. In some embodiments, the point P satisfies having an Sⱼ value of at most about zero. In some embodiments, the at least one guidance system further comprises a plurality of guidance systems disposed at locations within the location set A₁, A₂, . . . Aₙ, and/or wherein an energy source that is generating the energy beam is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the first energy source. In some embodiments, the computer program product further comprises aligning at least one of the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the computer program product further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically and/or spectroscopically detecting. In some embodiments, the computer program product further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam, from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, the location Aⱼ is selected such that the printing of the three-dimensional object is minimizing a deviation between a formed three-dimensional object and a (e.g., CAD) model of the three-dimensional object.

In another aspect, a system for printing a three-dimensional object comprises: a platform that is configured to support the three-dimensional object during printing; an energy source that is configured to generate an energy beam; and at least one guidance system operatively coupled with the energy source, which at least one guidance system is disposed at a location Aⱼ of a location set A₁, A₂, . . . Aₙ, wherein j and n are integers, wherein the at least one guidance system is configured to direct the energy beam from the location Aⱼ to a point P on a surface of the three-dimensional object during its printing, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, and wherein the location Aⱼ is such that: Sⱼ·Wⱼ=min{S₁·W₁·S₂·W₂, . . . Sₙ·Wₙ}.

In some embodiments, the at least one guidance system comprise sapphire, silicon carbide (SiC), beryllium, zinc selenide, calcium fluoride (CaF₂), or fused silica. In some embodiments, the at least one guidance system is operatively coupled to one or more controllers that is configured to select, or directs selection of, the location Aⱼ. In some embodiments, the one or more controllers is configured to select, or direst selection of, a guidance system from the at least one guidance system, which guidance system that is selected is at the location Aⱼ. In some embodiments, the one or more controllers translate the at least one guidance system to the location Aⱼ. In some embodiments, the system further comprises a guide that is operatively coupled to at least one optical element, and is configured to facilitate translation of the at least one optical element. In some embodiments, the guide comprises a railing. In some embodiments, the guide is operatively coupled to an actuator. In some embodiments, the actuator is controlled by one or more controllers. In some embodiments, translation of the at least one optical element facilitates projection of the energy beam from at least two locations of the location set A₁, A₂, . . . Aₙ. In some embodiments, the at least one optical element comprises sapphire, silicon carbide (SiC), beryllium, zinc selenide, calcium fluoride (CaF₂), or fused silica. In some embodiments, the system further comprises a guide that is operatively coupled to a guidance system of the at least one guidance system, and is configured to facilitate translation of the guidance system. In some embodiments, the guide comprises a railing. In some embodiments, the guide is operatively coupled to an actuator. In some embodiments, the actuator is controlled by one or more controllers. In some embodiments, translation of the guidance system facilitates projection of the energy beam from at least two locations of the location set A₁, A₂, . . . Aₙ. In some embodiments, the system further comprises a guide that is operatively coupled to the energy source, and is configured to facilitate translation of the energy source. In some embodiments, the guide comprises a railing. In some embodiments, the guide is operatively coupled to an actuator. In some embodiments, the actuator is controlled by one or more controllers. In some embodiments, translation of the energy source facilitates projection of the energy beam from at least two locations of location set A₁, A₂, . . . Aₙ. In some embodiments, the at least one guidance system comprises two guidance systems, each of which is disposed at different vertical heights with respect to the platform. In some embodiments, the two guidance systems each facilitate projection from two different locations of the location set A₁, A₂, . . . Aₙ. In some embodiments, the energy source is a first energy source, wherein the system further comprises a second energy source that is disposed at a different vertical height with respect to the platform as compared to the first energy source. In some embodiments, at least one of the at least one guidance system is configured to remain stationary during the printing. In some embodiments, at least one of the at least one guidance system is configured to translate during the printing. In some embodiments, the platform is disposed in an enclosure. In some embodiments, the enclosure is configured to enclosure an internal atmosphere different from an ambient atmosphere that is external to the enclosure at least during the printing. In some embodiments, the internal atmosphere comprises an inert gas. In some embodiments, the internal atmosphere comprises a pressure above ambient pressure. In some embodiments, the at least one guidance system is operatively aligned with respect to a requested position on a target surface to form the three-dimensional object. In some embodiments, the system further comprises at least one controller that is configured to operatively couple (e.g., and is operatively coupled) to the at least one guidance system and is configured to align, or direct alignment of, the at least one guidance system with respect to a target surface to form the three-dimensional object. In some embodiments, the energy source comprises an electrical inlet, an electrical outlet, and/or electrical circuitry.

In another aspect, an apparatus for printing a three-dimensional object comprises one or more controllers configured to operatively couple (e.g., and are operatively coupled) to an energy source and to one or more guidance systems, the one or more controllers are configured to direct: the energy source to irradiate an energy beam to the one or more guidance systems; the one or more guidance systems to select a location Aⱼ from a location set A₁, A₂, . . . Aₙ, wherein n and j are integers; and the one or more guidance systems to guide (e.g., direct) the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, and wherein the location Aⱼ is such that: Sⱼ·Wⱼ=min{S₁·W₁, S₂·W₂, . . . Sₙ·Wₙ}.

In some embodiments, the point P satisfies having an Sⱼ value of from about minus one (−1) to about zero (0). In some embodiments, the one or more controllers is configured to select, or direst selection of, the location Aⱼ. In some embodiments, the one or more controllers is configured to select, or direst selection of, a guidance system from the one or more guidance systems, which guidance system that is selected is at the location Aⱼ. In some embodiments, the one or more controllers translates the one or more guidance system to the location Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a first cross section of a first layering plane with the surface, and the point is in a second cross section of a second layering plane with the surface. In some embodiments, the one or more controllers are further configured to operatively couple (e.g., and is operatively coupled) to a sensor that is configured to detect (a) a position of the one or more guidance systems with respect to the location set A₁, A₂, . . . Aₙ, (b) at least one energy beam characteristic and/or (c) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, to detect the signal comprises a detection of a temperature of the energy beam footprint on the surface, or a vicinity thereof. In some embodiments, the vicinity is at most about seven (7) fundamental length scales of the energy beam footprint, centering at the energy beam footprint. In some embodiments, the sensor comprises an encoder, a switch, a CCD, a line scan CCD, a line scan CMOS, a video camera, or a spectrometer. In some embodiments, the one or more guidance systems are disposed within an optical enclosure that is configured to facilitate separation of the energy beam from an environment external to the optical enclosure. In some embodiments, the optical enclosure comprises one or more optical elements, the one or more optical elements arranged to direct and/or to transmit the energy beam, wherein the one or more optical elements comprise a lens, a mirror, a beam splitter, or an optical window. In some embodiments, the one or more optical elements comprise sapphire, beryllium, zinc selenide, calcium fluoride (CaF₂), or fused silica. In some embodiments, the one or more guidance systems are mounted or disposed on a railing, the railing comprising locations of the location set A₁, A₂, . . . Aₙ, the railing comprising at least one actuator configured to move the one or more guidance systems from a first location to a second location of the location set A₁, A₂ . . . , Aₙ. In some embodiments, the one or more guidance systems are translated using remote control. In some embodiments, the one or more guidance systems are translated using local control. In some embodiments, a translation of at least one of the one or more guidance systems is wired. In some embodiments, a translation of at least one of the one or more guidance systems is wireless. In some embodiments, the surface comprises an exposed surface of an enclosure, wherein the enclosure comprises an inert or non-reactive atmosphere, which non-reactive is with the three-dimensional object or a pre-transformed material that is transformed to form the three-dimensional object (e.g., during and/or after printing). In some embodiments, the enclosure further comprises a processing chamber and a container, wherein the container comprises the pre-transformed material or the three-dimensional object and is removably coupled with the processing chamber. In some embodiments, the energy source is a first energy source, wherein the energy beam is a first energy beam, and wherein the one or more controllers is configured to operatively couple (e.g., and is operatively coupled) to a second energy source that is configured to irradiate a second energy beam, such that: (A) a first guidance system of the one or more guidance systems is disposed above a second guidance system of the one or more guidance systems, (B) the first energy source is disposed above the second energy source, and/or (C) the first energy beam is irradiated above the second energy beam, wherein above is with respect to the global vector (e.g., in a direction opposite to the global vector). In some embodiments, the one or more controllers are further configured to align the first energy beam and/or the second energy beam with respect to a requested position on a target surface to form the three-dimensional object. In some embodiments, the platform is configured to directly or indirectly support the three-dimensional object during the printing. In some embodiments, the one or more controllers are configured to select, or direct selection of, the location Aⱼ such that the point P satisfies having an Sⱼ value of from about minus one (−1) to about zero point five (0.5). In some embodiments, at least two of operations (i), (ii), and (iii) are controlled by the same controller. In some embodiments, at least two of operations (i), (ii), and (iii) are each controlled by a different controller. In some embodiments, the one or more controllers direct (i), (ii), and/or (iii) in real time during the printing.

In another aspect, an apparatus for printing a three-dimensional object, comprises at least one controller that is configured to operatively couple (e.g., and is operatively coupled) to an energy source and to at least one guidance system, the at least one controller is configured to: select, or direct selection of, a location Aⱼ of the at least one guidance system from a location set A₁, A₂, . . . Aₙ, wherein n and j are integers; direct the energy source to irradiate an energy beam to the at least one guidance system disposed at the location Aⱼ; and direct the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, and wherein the location Aⱼ is such that: Sⱼ·Wⱼ=min{S₁·W₁·S₂·W₂, . . . Sₙ·Wₙ}.

In some embodiments, the at least one controller is further configured to operatively couple (e.g., and is operatively coupled) to a sensor that is configured to detect (A) a position of the at least one guidance system with respect to the location set A₁, A₂, . . . Aₙ, (B) at least one energy beam characteristic and/or (C) a signal emitted from an energy beam footprint on the surface. In some embodiments, the at least one energy beam characteristic comprises (I) a position of the energy beam footprint with respect to the point P, (II) a fundamental length scale of the energy beam footprint, or (Ill) a focal position of the energy beam footprint. In some embodiments, the sensor comprises an encoder, a switch, a CCD, a line scan CCD, a line scan CMOS, a video camera, or a spectrometer. In some embodiments, the at least one controller is configured to adjust at least one of (A) or (B), considering a detection of (A)-(C). In some embodiments, to adjust comprises a closed loop control scheme, which closed loop control comprises a feedback or a feed-forward control scheme. In some embodiments, the closed loop control is in real time, wherein real time comprises during the printing at least a portion of the three-dimensional object. In some embodiments, at least a first one of the at least one guidance system is configured for movement from a first location to a second location with of the location set A₁, A₂, . . . Aₙ. In some embodiments, the at least one guidance system further comprises a plurality of guidance systems disposed at locations within the location set A₁, A₂, . . . Aₙ, and/or wherein the energy source is a first energy source of a plurality of energy sources. In some embodiments, the at least one controller is configured to optimize (e.g., to select) a guidance system of the plurality of guidance systems to guide (e.g., direct) the energy beam considering the point P and/or a location of the energy source, wherein to optimize is with respect to minimizing the Sⱼ value. In some embodiments, the at least one controller is configured to optimize (e.g., to select) an energy source of the plurality of energy sources to irradiate the energy beam considering the point P and/or a location of a guidance system of the plurality of guidance systems, wherein to optimize is with respect to minimizing the Sⱼ value. In some embodiments, the at least one controller comprises an electrical circuit or a socket. In some embodiments, the at least one controller comprises programmable circuitry (e.g., a Field Programmable Gate Array). In some embodiments, the at least one controller is configured to direct the energy source to irradiate a plurality of energy beams. In some embodiments, the at least one controller is further configured to align at least one of the plurality of energy beams with respect to a requested position on a target surface to form the three-dimensional object. In some embodiments, the at least one controller is configured to select, or direct selection of, the location Aⱼ such that the point P satisfies having an Sⱼ value of from about minus one (−1) to about zero point five (0.5). In some embodiments, the at least one controller selects the location Aⱼ. In some embodiments, the at least one controller selects a guidance system from the at least one guidance system, which guidance system that is selected is at the location Aⱼ. In some embodiments, the at least one controller translates the at least one guidance system to the location Aⱼ.

In another aspect, a method for printing a three-dimensional object, comprises: selecting a location Aⱼ from a location set A₁, A₂, . . . Aₙ, wherein n and j are integers; generating an energy beam to impinge on at least one guidance system at the location Aⱼ; and using the at least one guidance system to direct the energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, and wherein the location Aⱼ is such that: Sⱼ·Wⱼ=min{S₁·W₁·S₂·W₂, . . . Sₙ·Wₙ}.

In some embodiments, the point P satisfies having an Sⱼ value of from about minus one (−1) to about zero point two (0.2, or one fifth). In some embodiments, the point P satisfies having an Sⱼ value of from about minus one (−1) to about zero. In some embodiments, the point P satisfies having an Sⱼ value of at most about zero. In some embodiments, the at least one guidance system further comprises a plurality of guidance systems disposed at locations within the location set A₁, A₂, . . . Aₙ, and/or wherein the energy source is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the energy source. In some embodiments, the method further comprises aligning the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the method further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically or spectroscopically detecting. In some embodiments, the method further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point 5 (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, selecting the location Aⱼ is such that the point P satisfies having an Sⱼ value of from about minus one (−1) to about zero point five (0.5). In some embodiments, selecting is of a guidance system from the at least one guidance system, which guidance system that is selected is at the location Aⱼ. In some embodiments, the method further comprises translating the at least one guidance system to the location Aⱼ. In some embodiments, at least one of the at least one guidance system is stationary during printing. In some embodiments, the method further comprises translating a guidance system of the at least one guidance system. In some embodiments, translating the guidance system is during printing. In some embodiments, translating the guidance system is during printing as the energy beam ceases to impinge on the guidance system.

In another aspect, a computer program product for printing of a three-dimensional object, comprises a non-transitory computer-readable medium in which program instructions are stored, which instructions, when read by a computer, cause the computer to perform operations comprises: selecting a location Aⱼ from a location set A₁, A₂, . . . Aₙ, wherein n and j are integers; directing an energy beam to impinge on at least one guidance system at the location Aⱼ; and directing the energy beam from (a) the at least one guidance system disposed at the location Aⱼ to (b) a point P on a surface of the three-dimensional object, wherein Vⱼ is a unit vector of a vector from the location Aⱼ to the point P, wherein Uⱼ is a unit vector of a projection of Vⱼ on a plane normal to a global vector, wherein the global vector is (a) directed to the local gravitational center, (b) directed opposite to a direction of layer-wise deposition to print the three-dimensional object, and/or (c) normal to a platform configured to support the three-dimensional object during its printing and directed opposite to a surface of the platform that supports the three-dimensional object, wherein a unit vector N normal to an average of the surface of the three-dimensional object at the point P forms an angle alpha with the global vector, wherein the angle alpha is at most about 45 degrees, wherein the unit vector N is directed away from the three-dimensional object, wherein M is a unit vector of a projection of N on a plane normal to the global vector, wherein Sⱼ is a scalar product of Uⱼ·M, and wherein Wⱼ is the scalar product of Vⱼ and Uⱼ, and wherein the location Aⱼ is such that: Sⱼ·Wⱼ=min{S₁·W₁·S₂·W₂, . . . Sₙ·Wₙ}.

In some embodiments, selecting the location Aⱼ is such that the point P satisfies having an Sⱼ value of from about minus one (−1) to about zero point five (0.5). In some embodiments, the point P satisfies having an Sⱼ value of from about minus one (−1) to about zero point two (0.2). In some embodiments, the point P satisfies having an Sⱼ value of from about minus one (−1) to about zero. In some embodiments, the point P satisfies having an Sⱼ value of at most about zero. In some embodiments, the at least one guidance system further comprises a plurality of guidance systems disposed at locations within the location set A₁, A₂, . . . Aₙ, and/or wherein an energy source that is generating the energy beam is a first energy source of a plurality of energy sources, wherein selecting the location Aⱼ comprises changing from a first guidance system to a second guidance system of the plurality of guidance systems to guide (e.g., direct) the energy beam, considering the point P and/or a location of the first energy source. In some embodiments, the computer program product further comprises aligning at least one of the plurality of guidance systems and/or the plurality of energy sources with respect to a requested position on a target surface to form the three-dimensional object. In some embodiments, changing comprises optimizing with respect to minimizing the Sⱼ value. In some embodiments, the optimizing is considering a printing instruction and/or a computer aided design (CAD) model. In some embodiments, the optimizing is before the printing and/or in real time (e.g., during printing at least a portion of the three-dimensional object). In some embodiments, the computer program product further comprises detecting (a) a position of the at least one guidance system with respect to the location set A₁, A₂, . . . Aₙ, (b) at least one energy beam characteristic or (c) a signal emitted from an energy beam footprint on the surface. In some embodiments, the detecting comprises optically and/or spectroscopically detecting. In some embodiments, the computer program product further comprises calibrating an alignment of the at least one guidance system or of an energy source that is generating the energy beam, the alignment with respect to the surface, the calibrating comprising evaluating a deviation between a requested position of the energy beam footprint and a detected position of the energy beam footprint as directed by the at least one guidance system. In some embodiments, the calibrating is before, during, and/or following the printing of the three-dimensional object. In some embodiments, selecting the location Aⱼ comprises moving the at least one guidance system or an energy source that is generating the energy beam, from a first position of the location set A₁, A₂, . . . Aₙ to the location Aⱼ. In some embodiments, the at least one guidance system further comprises a plurality of guidance systems disposed at locations within the location set A₁, A₂, . . . Aₙ, and wherein the selecting the location Aⱼ comprises using a guidance system of the plurality of guidance systems that is located at Aⱼ. In some embodiments, the average of the surface of the three-dimensional object is a (e.g., mathematically) planarized surface of the three-dimensional object that is averaged in an area of a circle having a radius of at least zero point five (0.5) millimeters centered at the point P, which circle is disposed on the surface. In some embodiments, the average of the surface of the three-dimensional object is a surface defined by a selected line portion and a point, wherein the selected line portion is a cross section of a first layering plane with the surface, and the point is in a cross section of a second layering plane with the surface. In some embodiments, the unit vector N is directed such that a scalar product of N and the global vector has a value of at least about zero (0). In some embodiments, the location Aⱼ is selected such that the printing of the three-dimensional object is minimizing a deviation between a formed three-dimensional object and a (e.g., CAD) model of the three-dimensional object.

Another aspect of the present disclosure provides a system for effectuating the methods disclosed herein.

Another aspect of the present disclosure provides an apparatus for effectuating the methods disclosed herein.

Another aspect of the present disclosure provides an apparatus comprising a controller that directs effectuating one or more steps in the method disclosed herein, wherein the controller is configured to operatively couple (e.g., and is operatively coupled) to the apparatuses, systems, and/or mechanisms that it controls to effectuate the method.

Another aspect of the present disclosure provides a computer system comprising one or more computer processors and a non-transitory computer-readable medium coupled thereto.

The non-transitory computer-readable medium comprises machine-executable code that, upon execution by the one or more computer processors, implements any of the methods above or elsewhere herein.

Another aspect of the present disclosure provides an apparatus for printing one or more 3D objects comprises a controller that is programmed to direct a mechanism used in a 3D printing methodology to implement (e.g., effectuate) any of the method disclosed herein, wherein the controller is configured to operatively couple (e.g., and is operatively coupled) to the mechanism.

Another aspect of the present disclosure provides a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is configured to operatively couple (e.g., and is operatively coupled) to the mechanism.

Another aspect of the present disclosure provides a non-transitory computer-readable medium comprising machine-executable code that, upon execution by one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “Fig.,” Figs.,” “FIG.” or “FIGs.” herein), of which:

FIG. 1 shows a schematic side view of a three-dimensional (3D) printing system and its components;

FIG. 2A schematically illustrates a perspective view of a portion of a 3D printer, and FIG. 2B schematically illustrates a perspective view of a portion of the 3D printer;

FIG. 3 schematically illustrates various processing fields of a 3D printing system;

FIG. 4A schematically illustrates an overhead view of a spatial arrangement of components of a 3D printing system, and FIG. 4B schematically illustrates a vector plot of various components of a 3D printing system

FIG. 5 schematically illustrates a cross section in portion of a 3D object;

FIG. 6 schematically illustrates a cross section in portion of a 3D object;

FIG. 7 schematically illustrates an arrangement of components of an optical system;

FIG. 8 schematically illustrates an arrangement of components of an optical system;

FIG. 9 schematically illustrates an arrangement of components of an optical system;

FIG. 10 schematically illustrates an arrangement of components of an optical system;

FIG. 11 schematically illustrates a detection system and its components;

FIG. 12 schematically illustrates a computer control system that is programmed or otherwise configured to facilitate the formation of one or more 3D objects;

FIG. 13 schematically illustrates a computer control system that is programmed or otherwise configured to facilitate the formation of one or more 3D objects;

FIG. 14A shows a perspective view of a 3D object; and FIG. 14B schematically illustrates a cross section in various layering planes;

FIGS. 15A-15F schematically depict perspective views depicting various operations used in calibration;

FIG. 16 shows calibration elements of a 3D printing system;

FIG. 17 illustrates various components used in calibration of a 3D printing system;

FIGS. 18A-18D schematically illustrates spatial intensity profiles of various energy beams; and

FIGS. 19A-19B schematically illustrates spatial intensity profiles of various energy beams.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

The present disclosure provides apparatuses, systems and methods for controlling aspects of printing 3D objects. In some embodiments, the apparatuses, systems and methods include a plurality of transforming elements used to generate 3D objects. In some embodiments, a plurality of transforming elements comprises at least two energy sources and/or at least two guidance systems (e.g., for guiding an energy beam on a target surface). A throughput with which a 3D printing system generates 3D objects may be increased with a plurality of transforming elements. An increased throughput may be with respect to a 3D printing system having only one transforming element (e.g., one that is devoid of a plurality of transforming elements).

Terms such as “a,” “an,” and “the” are not intended to refer to only a singular entity, but include the general class of which a specific example may be used for illustration. The terminology herein is used to describe specific embodiments of the invention, but their usage does not delimit the invention.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “adjacent” or “adjacent to,” as used herein, includes ‘next to’, ‘adjoining’, ‘in contact with,’ and ‘in proximity to.’ In some instances, adjacent to may be ‘above’ or ‘below.’

The term “operatively coupled” or “operatively connected” refers to a first mechanism that is coupled (or connected) to a second mechanism to allow the intended operation of the second and/or first mechanism, including a first mechanism that is in signal communication with a second mechanism. The term “configured to” refers to an object or apparatus that is (e.g., structurally) configured to bring about an intended result.

Fundamental length scale (abbreviated herein as “FLS”) can refer to any suitable scale (e.g., dimension) of an object. For example, a FLS of an object may comprise a length, a width, a height, a diameter, a spherical equivalent diameter, or a diameter of a bounding sphere.

The phrase “a three-dimensional object” as used herein may refer to “one or more three-dimensional objects,” as applicable.

“Real time” as understood herein may be during at least part of the printing of a 3D object. Real time may be during a print operation. Real time may be during a print cycle. Real time may comprise during formation of: a 3D object, a layer of hardened material as part of the 3D object, a hatch line, a single-digit number of melt pools, or a melt pool.

The phrase “is/are structured,” or “is/are configured,” when modifying an article, refers to a structure of the article that is able to bring about the enumerated result.

The phrase “a target surface” may refer to (1) a surface of a build plane (e.g., an exposed surface of a material bed), (2) an exposed surface of a platform, (3) an exposed surface of a 3D object (or a portion thereof), (4) any exposed surface adjacent to an exposed surface of the material bed, platform, or 3D object, and/or (5) any targeted surface. Targeted may be by at least one energy beam.

The phrase “a processing field” as used herein may refer to an (e.g., maximum) areal coverage of the energy beam at a surface. For example, it may be the extent achievable by an energy beam directed through one or more controllable (e.g., mechanical and/or optical) angles by an energy beam guidance system (e.g., a galvanometer scanner). At times, the processing field refers to a plane (e.g., comprising a target surface on which the energy beam can be incident). The processing field may have any (e.g., two dimensional) geometrical shape. For example, the processing field refers to a spherical (e.g., circular) surface, or a polygonal (e.g., rectangular) surface. A circumference of the processing field may comprise a curvature, or a straight line. A circumference of the processing field may comprise an arch. The arc may be circular or non-circular. The processing filed may be of a convex or concave shape.

Three-dimensional printing (also “3D printing”) generally refers to a process for generating a 3D object. The apparatuses, methods, controllers, and/or software described herein pertaining to generating (e.g., forming, or printing) a 3D object, pertain also to generating one or more 3D objects. For example, 3D printing may refer to sequential addition of material layers or joining of material layers (or parts of material layers) to form a 3D structure, in a controlled manner. The controlled manner may comprise manual or automated control. In the 3D printing process, the deposited material can be transformed (e.g., fused, sintered, melted, bound, or otherwise connected) to subsequently harden and form at least a part of the 3D object. Fusing (e.g., sintering or melting) binding, or otherwise connecting the material is collectively referred to herein as transforming a pre-transformed material (e.g., powder material) into a transformed material. Fusing the material may include melting or sintering the material. Binding can comprise chemical bonding. Chemical bonding can comprise covalent bonding. Examples of 3D printing may include additive printing (e.g., layer by layer printing, or additive manufacturing). 3D printing may include layered manufacturing. 3D printing may include rapid prototyping. 3D printing may include solid freeform fabrication. The 3D printing may further comprise subtractive printing.

3D printing methodologies can comprise extrusion, wire, granular, laminated, light polymerization, or powder bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Powder bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM). 3D printing methodologies can comprise Direct Material Deposition (DMD). The Direct Material Deposition may comprise, Laser Metal Deposition (LMD, also known as, Laser deposition welding). 3D printing methodologies can comprise powder feed, or wire deposition. 3D printing methodologies may comprise a binder that binds pre-transformed material (e.g., binding a powder). The binder may remain in the 3D object, or may be (e.g., substantially) absent from the 3D printing (e.g., due to heating, extracting, evaporating, and/or burning).

3D printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

“Pre-transformed material,” as understood herein, is a material before it has been first transformed (e.g., once transformed) by an energy beam during the 3D printing process. The pre-transformed material may be a material that was, or was not, transformed prior to its use in the 3D printing process. The pre-transformed material may be a material that was partially transformed prior to its use in the 3D printing process. The pre-transformed material may be a starting material for the 3D printing process. The pre-transformed material may be liquid, solid, or semi-solid (e.g., gel). The pre-transformed material may be a particulate material. The particulate material may be a powder material. The powder material may comprise solid particles of material. The particulate material may comprise vesicles (e.g., containing liquid or semi-solid material). The particulate material may comprise solid or semi-solid material particles.

The FLS of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, 100 m or 1000 m. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some instances, it is desired to control the manner in which at least a portion of a layer of hardened material is formed. The layer of hardened material may comprise a plurality of melt pools. In some instances, it may be desired to control one or more characteristics of the melt pools that form the layer of hardened material. The characteristics may comprise the depth of a melt pool, microstructure, or the repertoire of microstructures of the melt pool. The microstructure of the melt pool may comprise the crystalline structure, or crystalline structure repertoire that makes up the melt pool.

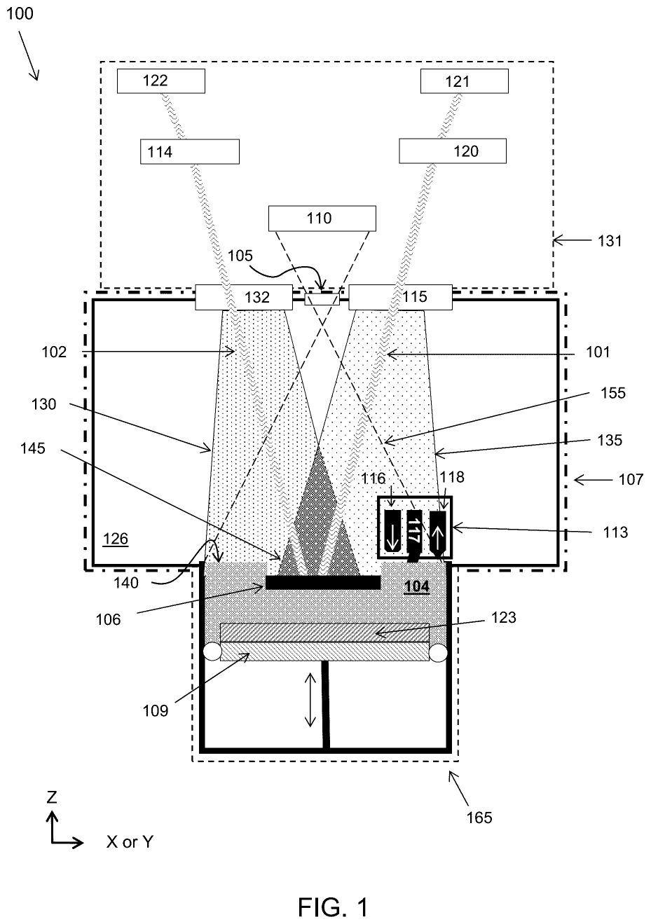

In some embodiments, transforming comprises heating at least a portion of a target surface (e.g., exposed surface of a material bed), and/or a previously formed area of hardened material using at least one energy source. The energy source may generate an energy beam. The energy source may be a radiative energy source. The energy source may be a dispersive energy source (e.g., a fiber laser). The energy source may generate a substantially uniform (e.g., homogenous) energy stream. The energy source may comprise a cross section (e.g., or a footprint) having a (e.g., substantially) homogenous fluence. The energy beam may have a spot size (e.g., footprint or cross-section) on a target surface. The energy generated for transforming a portion of material (e.g., pre-transformed or transformed), by the energy source will be referred herein as the “energy beam.” The energy beam may heat a portion of a 3D object (e.g., an exposed surface of the 3D object). The energy beam may heat a portion of the target surface (e.g., an exposed surface of the material bed, and/or a deeper portion of the material bed that is not exposed). The target surface may comprise a pre-transformed material, a partially transformed material and/or a transformed material. The target surface may comprise a portion of the build platform, for example, the base (e.g., FIG. 1, 123). The target surface may comprise a (surface) portion of a 3D object. The heating by the energy beam may be substantially uniform across its footprint on the target surface. In some embodiments, the energy beam takes the form of an energy stream emitted toward the target surface in a step and repeat sequence (e.g., tiling sequence). The energy beam may advance continuously, in a pulsing sequence, or in a step-and repeat sequence. The energy source may comprise an array of energy sources, e.g., a light emitting diode (LED) array.

In some embodiments, the methods, systems, apparatuses, and/or software disclosed herein may comprise controlling at least one characteristics of the layer of hardened material (or a portion thereof) that is part of the 3D object. The methods, systems, apparatuses, and/or software disclosed herein may comprise controlling the degree of 3D object deformation. The control may be an in-situ and/or real-time control. The control may be control during formation of the at least a portion of the 3D object. The control may comprise a closed loop or an open loop control scheme. The portion may be a surface, layer, multiplicity of layers, portion of a layer, and/or portion of a multiplicity of layers. The layer of hardened material of the 3D object may comprise a plurality of melt pools. The layers' characteristics may comprise planarity, curvature, or radius of curvature of the layer (or a portion thereof). The characteristics may comprise the thickness of the layer (or a portion thereof). The characteristics may comprise the smoothness (e.g., planarity) of the layer (or a portion thereof).

In some embodiments, a 3D printing cycle refers to printing one or more 3D objects in a 3D printer, e.g., using one printing instruction batch. A 3D printing cycle may include printing one or more 3D objects above a platform and/or in a material bed. A 3D printing cycle may include printing all layers of one or more 3D objects in a 3D printer. On the completion of a 3D printing cycle, the one or more objects may be removed from the 3D printer (e.g., by sealing and/or removing the build module from the printer) in a removal operation (e.g., simultaneously). During a printing cycle, the one or more objects may be printed in the same material bed, above the same platform, with the same printing system, at the same time span, using the same printing instructions, or any combination thereof. A print cycle may comprise printing the one or more objects layer-wise (e.g., layer-by-layer). A layer may comprise a layer height. A layer height may correspond to a height of (e.g., distance between) an exposed surface of a (e.g., newly) formed layer with respect to a (e.g., top) surface of a prior-formed layer. In some embodiments, the layer height is (e.g., substantially) the same for each layer of a print cycle (e.g., within a material bed). In some embodiments, at least two layers of a print cycle within a material bed have different layer heights. A printing cycle may comprise a collection (e.g., sum) of print increments (e.g., deposition of a layer and transformation of a portion thereof to form at least part of the 3D object). A build cycle may comprise one or more build laps (e.g., the process of forming a printed incremental layer). The 3D printing cycle may correspond with (i) depositing a (planar) layer of pre-transformed material (e.g., as part of a material bed) above a platform, and (ii) transforming at least a portion of the pre-transformed material (e.g., by at least one energy beam) to form one or more 3D objects above the platform (e.g., in the material bed). The 3D printing cycle may correspond with (I) depositing a pre-transformed material toward a platform, and (II) transforming at least a portion of the pre-transformed material (e.g., by at least one energy beam) at or adjacent to the platform to form one or more 3D objects above the platform. An additional sequential layer (or part thereof) can be added to the previous layer of a 3D object by transforming (e.g., fusing and/or melting) a fraction of pre-transformed material that is introduced (e.g., as a pre-transformed material stream) to the prior-formed layer. The depositing in (i) and the transforming in (ii) may comprise a print increment. At times, the platform supports a plurality of material beds. One or more 3D objects may be formed in a single material bed during a printing cycle (e.g., one or more print jobs). The transformation may connect transformed material of a given layer (e.g., printing cycle) to a previously formed 3D object portion (e.g., of a previous printing cycle). The transforming operation may comprise utilizing an energy beam to transform the pre-transformed (or the transformed) material. In some instances, the energy beam is utilized to transform at least a portion of the material bed (e.g., utilizing any of the methods described herein).

In some embodiments, usage of a plurality transforming elements (e.g., energy beams) increases (i) the (e.g., total) processing field available for printing (e.g., in a X-Y plane) and/or (ii) the rate of completion for a given print cycle (as compared to using a single energy beam). A plurality of energy beams (e.g., at least two energy beams) may be useful in providing a relatively larger processing area in which one or more 3D objects may be generated. A relatively larger processing area may be useful in generating a larger 3D object, or a plurality of (e.g., laterally) adjacent 3D objects. The larger 3D object may be larger in at least one dimension (e.g., in a X-Y plane), compared to a 3D object formed using a single energy beam. The platform and/or material bed may be larger in at least one dimension (e.g., in a X-Y plane), compared to a platform and/or a material bed used for 3D printing with a single energy beam. A relatively larger processing field may be larger in relation to a 3D printing system that comprises (e.g., only) a single energy beam, which processing area is limited to the areal extent (e.g., the processing field) of the single energy beam (e.g., as guided by a guidance system), which is not arbitrarily sized.

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr).

In some embodiments, the 3D printing increases in efficiency when a plurality of energy beams is used for the 3D printing. For example, the time for 3D printing may be shortened when at least two of the plurality of energy beams operate simultaneously at least in part (e.g., in parallel). For example, the time for 3D printing may be shortened by at least 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam).

At times, an energy beam from a first and/or second energy source is incident on, and/or is directed to, a target surface (e.g., the exposed surface of the material bed). The energy beam may be directed to and/or impinge on the pre-transformed material. The energy beam can be directed to the pre-transformed or transformed material for a specified period. The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy source and/or energy beam can be moveable such that it can translate relative to the surface (e.g., the target surface).

In some embodiments, the energy source is movable such that it can translate across (e.g., laterally) the top surface of the material bed, e.g., during the printing. The energy beam(s) and/or energy source(s) can be moved via at least one scanner. In some embodiments, at least two energy beams are moved with the same scanner. In some embodiments, at least two energy beams are moved with different scanners (e.g., are each moved with a different scanner). The scanner may comprise a galvanometer scanner, a polygon, a mechanical-stage (e.g., X-Y-stage), a piezoelectric device, gimbal, or any combination of thereof. The galvanometer may comprise a mirror. The scanner may comprise a modulator. The scanner may comprise a polygonal mirror. The scanner can be the same scanner for two or more energy sources and/or beams. At least two (e.g., each) energy sources and/or beams may have a separate scanner. At least two scanners may be operably coupled with a single energy source and/or energy beam. The energy sources and/or energy beams can be translated independently of each other. In some cases, at least two energy sources and/or energy beams can be translated at different rates, and/or along different paths. For example, the movement of a first energy beam may be faster (e.g., at a greater rate) as compared to the movement of a second energy beam. The systems and/or apparatuses disclosed herein may comprise one or more shutters (e.g., safety shutters). The energy beam(s), energy source(s), and/or the platform can be moved by the scanner (e.g., optical scanner to move the energy beam, or mechanical stage type scanner to move the platform or energy source). The galvanometer scanner may comprise a two-axis galvanometer scanner. The scanner may comprise a modulator. The energy source(s) can project energy using a DLP modulator, a one-dimensional scanner, a two-dimensional scanner, or any combination thereof. The energy source(s) can be stationary or translatable. The energy source(s) can translate vertically, horizontally, or in an angle (e.g., planar or compound angle).

At times, the energy source(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the current supplied to the energy source (e.g., direct modulation). The modulation may affect (e.g., alter) the energy beam (e.g., external modulation such as external light modulator). The modulator can comprise an acousto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam.

The scanner can be included in an optical system that is configured to direct energy from the energy source to a predetermined position on the (target) surface (e.g., exposed surface of the material bed). The scanner may comprise one or more optical elements (e.g., mirrors). At least one controller can be programmed to control a trajectory of the energy source(s) with the aid of the optical system. The controller can regulate a supply of energy from the energy source to the pre-transformed material (e.g., at the target surface) to form a transformed material. The optical system may be enclosed in an optical enclosure. An optical enclosure and/or system may be any, e.g., of the ones disclosed in Patent Application serial number PCT/US17/64474, titled “OPTICS, DETECTORS, AND THREE-DIMENSIONAL PRINTING” that was filed Dec. 4, 2017, or in Patent Application serial number PCT/US18/12250, titled “OPTICS IN THREE-DIMENSIONAL PRINTING” that was filed Jan. 3, 2018, each of which is incorporated herein by reference in its entirety.

In some embodiments, a plurality of energy beams is directed at the target surface for printing a 3D object. In some embodiments, the system can comprise 1, 2, 3, 4, 5, 6, 7, 8, 9, 10, 30, 100, 300, 1000 or more energy beams and/or sources. The system can comprise an array of energy sources (e.g., laser diode array). At least one optical element may direct the irradiating energy from an energy source to a scanner (e.g., a X-Y scanner, a galvanometer scanner) to direct the energy beams. The scanner may be any scanner disclosed herein. The irradiating energy may be directed (e.g., by the at least one optical element) to one or more scanners. The scanner may direct irradiating energy on a position at the target surface. Alternatively, or additionally the target surface, material bed, 3D object (or part thereof), or any combination thereof may be temperature controlled, e.g., heated by a heating mechanism and/or cooled by a cooling mechanism. The heating mechanism may comprise dispersed energy beams. An energy beam may travel through one or more filters, apertures, and/or optical windows on its way to the target surface (e.g., as depicted in FIGS. 1, 101 and/or 102).

In some embodiments, the energy beam includes a radiation comprising an electromagnetic or charged particle beam. The energy beam may include radiation comprising electromagnetic, electron, positron, proton, plasma, or ionic radiation. An electromagnetic beam may comprise microwave, infrared, ultraviolet, or visible radiation. A charged particle beam may comprise a cation or an anion. The electromagnetic beam may comprise a laser beam. The energy beam may derive from a laser source. The energy source may be a laser source. The laser may comprise a fiber laser, a solid-state laser, or a diode laser. The laser source may comprise a Nd: YAG, Neodymium (e.g., neodymium-glass), or an Ytterbium laser. The laser may comprise a carbon dioxide laser (CO₂ laser). The energy source may comprise a diode array laser. The laser may be a laser used for micro laser sintering. The energy beam may be any energy beam, e.g., as disclosed in Patent Application serial number PCT/US17/64474, or in Patent Application serial number PCT/US18/12250, each of which is incorporated herein by reference in its entirety.

The energy beam (e.g., transforming energy beam) may comprise a Gaussian energy beam. The energy beam may have any cross-sectional shape comprising an ellipse (e.g., circle), or a polygon. The energy beam may have a cross section (e.g., at an intersection of the energy beam on a target surface) with a FLS of at least about 20 μm, 50 μm, 75 μm, 100 μm, 150 μm, 200 μm, or 250 μm, 0.3 millimeters (mm), 0.4 mm, 0.5 mm, 0.8 mm, 1 mm, 1.5 mm, 2 mm, 2.5 mm, 3 mm, 3.5 mm, 4 mm, 4.5 mm, or 5 mm. The cross section of the energy beam may be any value of the afore-mentioned values (e.g., from about 50 μm, to about 250 μm, from about 50 μm, to about 150 μm, from about 150 μm, to about 250 μm, from about 0.2 mm to about 5 mm, from about 0.2 mm to about 2.5 mm, or from about 2.5 mm to about 5 mm). The FLS may be measured at full width half maximum intensity of the energy beam. The FLS may be measured at 1/e² intensity of the energy beam. In some embodiments, the energy beam is a focused energy beam at the target surface. In some embodiments, the energy beam is a defocused energy beam at the target surface. The energy profile of the energy beam may be (e.g., substantially) uniform (e.g., in the energy beam's cross-sectional area that impinges on the target surface). The energy profile of the energy beam may be (e.g., substantially) uniform during an exposure time (e.g., also referred to herein as a dwell time). The exposure time (e.g., at the target surface) of the energy beam may be at least about 0.1 milliseconds (msec), 0.5 msec, 1 msec, 10 msec, 50 msec, 100 msec, 200 msec, 500 msec, 1000 msec, 2500 msec, or 5000 msec. The exposure time may be between any of the above-mentioned exposure times (e.g., from about 0.1 msec to about 5000 msec, from about 0.1 msec to about 1000 msec, or from about 1000 msec to about 5000 msec). In some embodiments, the energy beam is configured to be continuous or non-continuous (e.g., pulsing). In some embodiments, at least one energy source can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The at least one energy source can provide an energy beam having an energy density of a value between the afore-mentioned values (e.g., from about 50 J/cm² to about 5000 J/cm², from about 50 J/cm² to about 2500 J/cm², or from about 2500 J/cm² to about 5000 J/cm²). In some embodiments, the power density (e.g., power per unit area) of the energy beam is at least about 100 Watts per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², 8000 W/mm², 9000 W/mm², 10000 W/mm², 20000 W/mm², 30000 W/mm², 50000 W/mm², 60000 W/mm², 70000 W/mm², 80000 W/mm², 90000 W/mm², or 100000 W/mm². The power density of the energy beam may be any value between the aforementioned values (e.g., from about 100 W/mm² to about 100000 W/mm², about 100 W/mm² to about 1000 W/mm², or about 1000 W/mm² to about 10000 W/mm², from about 10000 W/mm² to about 100000 W/mm², from about 10000 W/mm² to about 50000 W/mm², or from about 50000 W/mm² to about 100000 W/mm²). The energy beam may emit energy stream towards the target surface in a step and repeat sequence.

At times, an energy source provides power at a peak wavelength. For example, an energy source can provide electromagnetic energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. An energy beam can provide energy at a peak wavelength between any value of the afore-mentioned peak wavelength values (e.g., from about 100 nm to about 2000 nm, from about 100 nm to about 1000 nm, or from about 1000 nm to about 2000 nm). The energy source (e.g., laser) may have a power of at least about 0.5 Watt (W), 1 W, 5 W, 10 W, 50 W, 100 W, 250 W, 500 W, 1000 W, 2000 W, 3000 W, or 4000 W. The energy source may have a power between any value of the afore-mentioned laser power values (e.g., from about 0.5 W to about 4000 W, from about 0.5 W to about 1000 W, or from about 1000 W to about 4000 W).

At times, an energy beam is translated across a surface (e.g., target surface) at a given rate (e.g., a scanning speed), e.g., in a trajectory. The scanning speed of the energy beam may be at least about 50 millimeters per second (mm/sec), 100 mm/sec, 500 mm/sec, 1000 mm/sec, 2000 mm/sec, 3000 mm/sec, 4000 mm/sec, or 50000 mm/sec. The scanning speed of the energy beam may be any value between the aforementioned values (e.g., from about 50 mm/sec to about 50000 mm/sec, from about 50 mm/sec to about 3000 mm/sec, or from about 3000 mm/sec to about 50000 mm/sec). The energy beam may be continuous or non-continuous (e.g., pulsing). The energy profile of the energy beam may be (e.g., substantially) uniform during the exposure time (e.g., also referred to herein as dwell time). The exposure time (e.g., at the target surface) of the energy beam may be at least about 0.1 milliseconds (msec), 0.5 msec, 1 msec, 10 msec, 50 msec, 100 msec, 500 msec, 1000 msec, 2500 msec, or 5000 msec. The exposure time may be any value between the above-mentioned exposure times (e.g., from about 0.1 msec to about 5000 msec, from about 0.1 to about 1000 msec, or from about 1000 msec to about 5000 msec). The exposure time (e.g., irradiation time) may be the dwell time. The dwell time may be at least 1 minute, or 1 hour.

At times, at least two energy sources (e.g., producing at least two energy beams) may have at least one characteristic value in common with each other. At times, the at least two energy sources may have at least one characteristic value that is different from each other.

Characteristics of the energy beam may comprise wavelength, power density, amplitude, trajectory, FLS of footprint on the target surface, intensity, energy, energy density, fluence, Andrew Number, hatch spacing, scan speed, scanning scheme, or charge. The scanning scheme may comprise continuous, pulsed or tiled scanning scheme. The charge can be electrical and/or magnetic charge. Andrew number is proportional to the power of the irradiating energy over the multiplication product of its velocity (e.g., scan speed) by a hatch spacing. The Andrew number is at times referred to as the area filling power of the irradiating energy.

In some embodiments, one or more (e.g., a plurality of) guidance systems direct a plurality of energy beams, respectively, to the target surface (e.g., to different positions of the target surface). The guidance system of the energy beam may comprise an optical element and/or optical mechanism. The guidance system of the energy beam may comprise a scanner. A given scanner may direct a plurality of energy beams from the same energy source. A given guidance system may direct a plurality of energy beams from more than one (e.g., at least two) energy sources. A given guidance system may direct one energy beam from an energy source. The plurality of energy beams may have the same or of different characteristics (e.g., energy density, and cross section) and/or scanning scheme in the 3D printing process. A guidance system may be controlled manually and/or by at least one controller. For example, at least two guidance systems may be directed by the same controller. For example, at least one guidance system may be directed by its own (e.g., unique) controller. The plurality of controllers may be configured to operatively couple (e.g., and may be operatively coupled) to each other, to the guidance system(s) (e.g., scanner(s)), and/or to the energy source(s). At least two of the plurality of energy beams may irradiate the surface simultaneously or sequentially. At least two of the plurality of energy beams may be generated by the same energy source. At least two of the plurality of energy beams may be generated by at least two energy sources (e.g., a respective energy source for each energy beam). At least two of the plurality of energy beams may be directed towards the same position at the target surface, or to different positions at the target surface. The one or more guidance systems may be positioned at an angle (e.g., tilted) with respect to the target surface. In some embodiments, at least two of the energy source(s) and/or beam(s) can be translated at different rates (e.g., velocities). In some cases, at least two energy source(s) and/or beam(s) can comprise at least one different characteristic. The characteristics may comprise wavelength, power, amplitude, trajectory, footprint, intensity, energy, or charge. The charge can be electrical and/or magnetic charge. One or more sensors may be disposed adjacent to the target surface. The at least one of the one or more sensors may be disposed in an indirect view of the target surface. The at least one of the one or more sensors may be disposed in a direct view of the target surface (e.g., a camera viewing the target surface). The one or more sensors may be configured to have a field of view of at least a portion of the target surface (e.g., an exposed surface of the material bed).

FIG. 1 shows an example of a 3D printing system 100 (also referred to herein as “3D printer”) and apparatuses, including a (e.g., first) energy source 121 that emits a (e.g., first) energy beam 101 and a (e.g., second) energy source 122 that emits a (e.g., second overlapping) energy beam 102. In the example of FIG. 1 the energy from energy source 121 travels through an (e.g., first) optical system 120 (e.g., comprising a scanner) and an optical window 115 to be incident upon a target surface 140 within an enclosure 126 (e.g., comprising an atmosphere). The target surface may comprise at least one layer of pre-transformed material (e.g., powder material) that is disposed adjacent to a platform (e.g., 109). Adjacent can be above. The guidance system of the energy beam may comprise an optical system. FIG. 1 shows the energy from the energy source 122 travels through an optical system 114 (e.g., comprising a scanner) and an optical window 132 to be incident upon the target surface 140.

The energy from the (e.g., plurality of) energy sources may be directed through the same optical system and/or the same optical window. At times, energy from the same energy source is directed to form a plurality of energy beams by one or more optical systems. In the example of FIG. 1, the energy beam 102 trajectory defines a processing volume 130 (shown as a vertical cross section), the energy beam 101 trajectory defines a processing volume 135 (shown as a vertical cross section), and the processing volumes 130 and 135 have an overlapping region 145. A processing volume may have a corresponding processing field defined by the intersection of the processing volume with the target surface. The target surface may comprise a (e.g., portion of) hardened material (e.g., FIG. 1, 106) formed via transformation of material within a material bed (e.g., FIG. 1, 104). In the example of FIG. 1, a layer forming device 113 includes a (e.g., powder) dispenser 116, a leveler 117, and material removal mechanism 118.

The material bed may be supported by a (e.g., movable) platform, which platform may comprise a base (e.g., FIG. 1, 123). The base may be detachable (e.g., after the printing). A hardened material may be anchored to the base (e.g., via supports and/or directly), or un-attached to the base (e.g., floating anchorlessly in the material bed, e.g., suspended in the material bed). At times, a (e.g., optical) detection system is disposed to detect one or more characteristics of the printing process. In the example of FIG. 1, a detection system 110 is disposed adjacent to (e.g., above) the enclosure, having a field of view 155 via an opening (e.g., comprising a (transparent) window) 105.

In some embodiments, an optical system through which an energy beam travels can be disposed within the enclosure, outside of the enclosure, or within at least one wall of the enclosure. For example, an optical window of an optical system may be disposed within at least one wall of the enclosure (e.g., as in FIGS. 1, 132 and 115). In some embodiments, at least a portion of the optical system is disposed within its own (optical) enclosure (e.g., FIG. 1, 131). The optical enclosure may optionally be (e.g., operatively and/or physically) coupled with the processing chamber. The optical mechanism and any of its components (e.g., including an optical enclosure and/or optical window) may be any optical mechanism and respective components disclosed, e.g., in patent application number PCT/US17/60035, titled “GAS FLOW IN THREE-DIMENSIONAL PRINTING” that was filed on Nov. 3, 2017, or in Patent Application serial number PCT/US18/12250, each of which is incorporated herein by reference in its entirety.

In some embodiments, the target surface is detected by a detection system. The detection system may comprise at least one sensor. The detection system (e.g., FIG. 1, 110) may comprise a light source operable to illuminate a portion of the 3D printing system enclosure (e.g., the target surface). The light source may be configured to illuminate onto a target surface. The illumination may be such that objects in the field of view of the detector are illuminated with (e.g., substantial) uniformity. For example, sufficient uniformity may be uniformity such that at most a threshold level (e.g., 25 levels) of variation in grayscale intensity exists (for objects), across the build plane. The illumination may comprise illuminating a map of varied light intensity (e.g., a picture made of varied light intensities). Examples of illumination apparatuses include a lamp (e.g., a flash lamp), a LED, a halogen light, an incandescent light, a laser, or a fluorescent light. The detection system may comprise a camera system, CCD, CMOS, detector array, a photodiode, or line-scan CCD (or CMOS). The control system, detection system and/or illumination may be any, e.g., the ones disclosed in Patent Application serial number U.S. Ser. No. 15/435,090, titled “ACCURATE THREE-DIMENSIONAL PRINTING” that was filed Feb. 16, 2017, patent application serial number PCT/US17/18191, titled “ACCURATE THREE-DIMENSIONAL PRINTING” that was filed on Feb. 16, 2017; and/or patent application serial number EP17156707, titled “ACCURATE THREE-DIMENSIONAL PRINTING” that was filed on Feb. 17, 2017; each of which is incorporated herein by reference in its entirety.

In some embodiments, the processing volume is defined by a portion of the enclosure that can be occupied by the energy beam, e.g., during printing. The energy beam(s) may travel through a region of the processing chamber referred to as a processing volume region (also referred the herein as a “processing volume”). In some embodiments, each scanner (e.g., of a plurality of scanners) has a corresponding processing volume within which it is configured to direct an energy beam across at least a portion of the target surface, e.g., during printing. At least one of the plurality of scanners may direct one or more energy beams through a processing volume. At least one of the plurality of scanners can be configured to move the energy beam (e.g., by deflection) in accordance with a (e.g., predetermined) path along the at least the portion of the target surface. Movement of the energy beam(s) during a printing operation can cause the energy beam(s) to potentially occupy a volume (e.g., processing volume) extending from the area or point of entry of the energy beam into the processing chamber to the area of the target surface (e.g., an exposed surface of the material bed, or a platform).

In some embodiments, the build module and the processing chamber are separate and/or separable. The build module and processing chamber may (e.g., controllably) engage and disengage. The separate build module and processing chamber may comprise separate atmospheres. Any of these atmospheres may be different than the ambient atmosphere outside of the build module and/or processing chamber. For example, any of these atmospheres may be inert (e.g., comprise argon, or nitrogen). Any of these atmospheres may comprise a species that is reactive with the transformed and/or pre-transformed material during the printing, in an amount below a (e.g., reactive) threshold. The species may comprise water or oxygen. The build module and processing chamber may engage to form a gas tight seal (e.g., hermetic seal). The separate build module and processing chamber may (e.g., controllably) merge. For example, the atmospheres of the build module and processing chamber may merge. In the example of FIG. 1, the 3D printing system comprises a processing chamber which comprises the irradiating energy and the target surface (e.g., comprising the atmosphere in the interior volume of the processing chamber, e.g., 126). The enclosure may comprise one or more build modules (e.g., enclosed in the dashed area 165). At times, at least one build module may be disposed in the enclosure that comprises the processing chamber (having an interior volume 126 comprising an atmosphere). At times, at least one build module may engage with the processing chamber (e.g., FIG. 1) (e.g., 107). At times, a plurality of build modules may be coupled to the enclosure. The build module may reversibly engage with (e.g., couple to) the processing chamber. The engagement of the build module may be before or after the 3D printing. The engagement of the build module with the processing chamber may be controlled (e.g., by a controller, such as a microcontroller). The controller may be any controller, e.g., as disclosed in: patent application serial number PCT/US17/18191; patent application serial number U.S. Ser. No. 15/435,065, titled “ACCURATE THREE-DIMENSIONAL PRINTING” that was filed on Feb. 16, 2017; and/or patent application serial number EP17156707; each of which is incorporated herein by reference in its entirety. The controller may direct the engagement and/or dis-engagement of the build module. The control may comprise automatic and/or manual control. The engagement of the build module with the processing chamber may be reversible. In some embodiments, the engagement of the build module with the processing chamber may be non-reversible (e.g., stable). The FLS (e.g., width, depth, and/or height) of the processing chamber can be at least about 50 millimeters (mm), 60 mm, 70 mm, 80 mm, 90 mm, 100 mm, 200 mm, 250 mm, 280 mm, 400 mm, 500 mm, 800 mm, 900 mm, 1 meter (m), 2 m, or 5 m. The FLS of the processing chamber can be at most about 50 millimeters (mm), 60 mm, 70 mm, 80 mm, 90 mm, 100 mm, 200 mm, 250 mm, 400 mm, 500 mm, 800 mm, 900 mm, 1 meter (m), 2 m, or 5 m. The FLS of the processing chamber can be between any of the afore-mentioned values (e.g., 50 mm to about 5 m, from about 250 mm to about 500 mm, or from about 500 mm to about 5 m). The build module and/or processing chamber may comprise any (e.g., be formed of a) material comprising an organic (e.g., polymer or resin) or inorganic material (e.g., a salt, mineral, acid, base, or silicon-based compound). The build module and/or processing chamber may comprise any material disclosed herein (e.g., elemental metal, metal alloy, an allotrope of elemental carbon, ceramic, or glass).

The height of a processing volume can span a distance between the interior surface of an optical window and the (e.g., target) surface of the processing chamber (e.g., comprising the processing field). The processing volume can have a height of at least about 10 cm, 50 cm, 100 cm, 500 cm, 1000 cm, or 5000 cm. The processing volume can have a height of any value of the afore-mentioned values (e.g., from about 10 cm to about 5000 cm, about 10 cm to about 500 cm, or about 500 cm to about 5000 cm). In some cases, the processing field comprises at least a portion of the exposed surface of a material bed. The shape of the processing volume region may be varied (e.g., by controllably adjusting the target surface's and/or optical window's height). The variation can be before, during, and/or after the printing. The variation can be in situ and/or in real time. The variation may be controlled (e.g., manually and/or automatically, e.g., by at least one controller). In some embodiments, the shape of the processing volume region may comprise at least a portion of a cone, a conical frustum (cut-off cone), a pyramid (e.g., square pyramid), a frustum (cut-off pyramid), a cylinder, a tetrahedron, a cube, or a prism (e.g., triangular prism, hexagonal prism, or pentagonal prism). In some embodiments, the processing volume region has a symmetric shape (e.g., substantially symmetric about a central axis). In some embodiments, the processing volume region has an asymmetric shape. The processing volume may have a shape depending on the motion range of the energy beam(s), that may depend on the shape of the platform, optical window, and/or energy beam guidance system (e.g., scanner).

In some embodiments, an intersection of a processing volume with a target surface defines a processing field. The processing field of a given energy beam may cover an area of the target surface (e.g., as measured at a build plane). A build plane may be an exposed surface of a material bed. The area of a given processing field in relation to the target surface can be (i) larger than (e.g., and include), (ii) equal to (e.g., is), or (iii) smaller than (e.g., a portion of), the target surface. The area (e.g., of a target surface) may be irradiated by an energy beam (e.g., one energy beam). In some embodiments, the processing field has a symmetric shape. Substantially symmetric may be about a central point, about an inversion point, or about a symmetry line (e.g., about a mirror line or a rotational axis). In some embodiments, the processing field has an asymmetric shape. The processing field of a given guidance system may overlap (e.g., at least in part) with a processing field of another (e.g., at least one) guidance system. Overlapping processing fields may be for energy beam(s) that are generated at a given (e.g., the same) energy source. For example, the processing field of a first guidance system may overlap (e.g., at least in part) with a processing field of a second guidance system. The processing field of a given energy beam may overlap (e.g., at least in part) with a processing field of another (e.g., at least one) energy beam. For example, the processing field of a first energy beam may overlap (e.g., at least in part) with a processing field of a second energy beam. An overlap may be an overlapping area (e.g., of a target surface). The overlap area may be irradiated by both (e.g., all) of the energy beams. As measured at a target surface, an overlapping region may comprise, a portion, a totality of a target surface, or exceed the target surface. An overlapping region of the processing volumes at a target surface may be at most about 120%, 100%, 80%, 60%, 40%, 20%, 10%, 5% or 1% of the target surface area. An overlapping region of the processing volumes at the target surface may be any value between the afore-mentioned area percentage values (e.g., from about 1% to about 120%, from about 1% to about 100%, from about 40% to about 100%, or from about 1% to about 40%) of the area of the target surface. At times, the overlapping region may have a greater extent than the target surface (e.g., extend beyond the target surface). The irradiation by at least two of the plurality of energy beams may occur sequentially or simultaneously. The irradiations by the at least two of the plurality of energy beams may occur separately. The irradiations by the at least two of the plurality of energy beams may occur in concert. For example, separate irradiations may comprise a first irradiation by a first energy beam at a first time, and a second irradiation by a second energy beam at a second time (e.g., where the second time follows the first time).

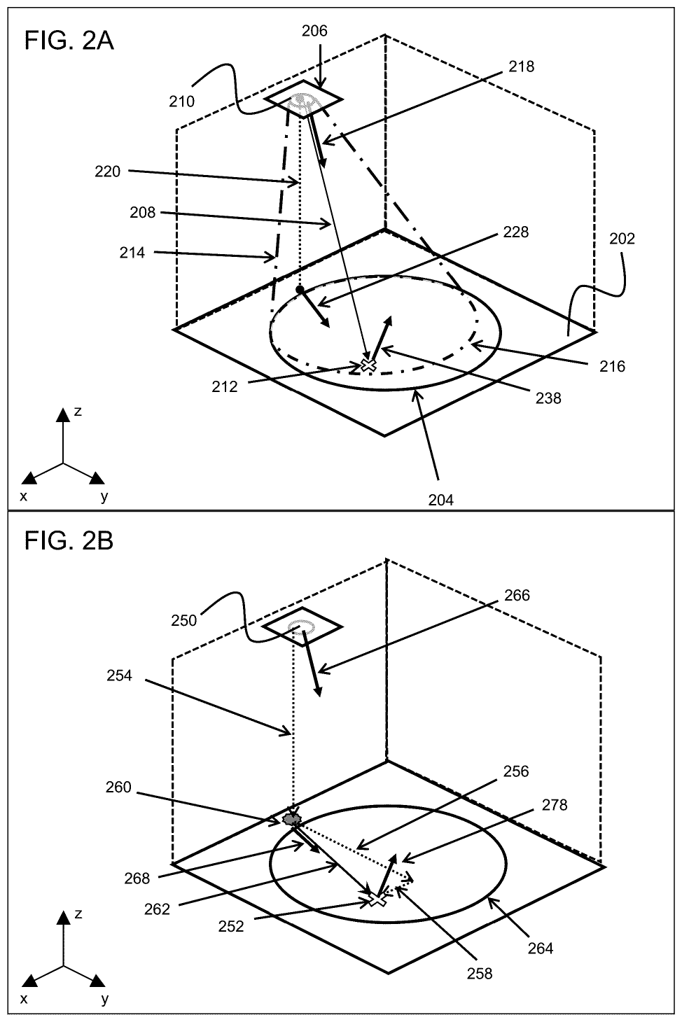

FIG. 2A depicts in perspective view an example of a processing volume 214 that is formed by a guidance system (e.g., a scanner) within an enclosure. In the example of FIG. 2A, an initiation region (e.g., point) 210 of a processing volume is adjacent to an optical element 206. The optical element may be an optical window (e.g., a portion of an optical arrangement and/or a guidance system). FIG. 2A depicts an example of an energy beam propagation vector 208 that is directed through the optical element and onto a target surface 204 of a build plane 202, at an irradiation point (e.g., position) 212. At times, a (e.g., first) unit vector is associated with the energy beam propagation vector. The first unit vector may comprise a three-dimensional vector (e.g., FIG. 2A, 218). At times, a (e.g., second) unit vector comprises a (e.g., two-dimensional) projection of an energy beam propagation (e.g., unit) vector. For example, a (e.g., second) unit vector may be a projection of the energy beam propagation vector onto a (e.g., target) surface (e.g., FIG. 2A, 228). At times, an irradiation point has an associated growth direction vector (e.g., as described herein). A growth direction vector may comprise a (e.g., unit) vector projected onto a (e.g., target) surface (e.g., FIG. 2A, 238). The growth direction is directed in a direction towards which an addition to the 3D object is to be supplemented. The processing volume may have a height that is defined by a distance between the initiation region and the target surface (FIG. 2A, 220). In the example of FIG. 2A an intersection of the processing volume with the target surface is shown by a processing field 216. At times, a path traveled by an energy beam from an initiation point (e.g., of a processing volume) to an irradiation point (e.g., within a corresponding processing field) is defined by an energy beam propagation vector.

In some embodiments, an energy beam propagation vector comprises an origin at the initiation point (e.g. an origin location Aₙ, with n being an integer), and an end point at the irradiation point (e.g., at the target surface, P). An energy beam propagation vector (e.g., origin and/or end point) may be represented by one or more values (e.g., of a coordinate system). For example, an energy beam propagation vector may be represented by x, y, and z values for a Cartesian coordinate system. At times, a position of an initiation point (e.g., of a processing volume) may be characterized with respect to a target surface. For example, a position of an initiation point may be characterized with respect to a perimeter of a target surface. The position of the initiation point may be according to its coordinates in a (e.g., Cartesian) coordinate system. For example, the position of the initiation point with respect to the target surface may be with respect to (e.g., x and y) coordinates of the initiation point at a plane in common with the target surface (e.g., an x-y plane). The plane in common may comprise the target surface, a layering plane, or (e.g., a portion of) a 3D object. The (e.g., x-y coordinate) position of an initiation point may be (i) outside of, (ii) overlapping with, or (iii) inside of a perimeter of the target surface.

FIG. 2B depicts in perspective view an example of x, y, and z axis components of an energy beam propagation vector that originates from a guidance system. In the example of FIG. 2B, the components of an energy beam propagation vector that originates at an initiation point 250 and ends at an end point (e.g., irradiation point) 252 are given by an x-axis component 258, a y-axis component 256, and a z-axis component 254. The irradiation point may be on a portion of a 3D object (e.g., a surface) that comprises a growth direction vector (e.g., FIG. 2B, 278). The initiation point of the energy beam propagation vector may be represented by a subset of the initiation point coordinates (e.g., a subset of x-y-z coordinates). For example, the initiation point may be represented by the x and y components of the initiation point coordinates. A representation of a position (e.g., initiation point and/or end point) using a subset (e.g., two) of the coordinates of the position may be referred to herein as a “projection” of the position. In the example of FIG. 2B, a projection of the initiation point 250 onto the x-y plane is depicted by marker 260, which lies outside of the perimeter of a target surface 264 (e.g., an exposed surface of a material bed). A projection of a three-dimensional (e.g., energy beam propagation) vector may be a two-dimensional vector. For example, a projection of an energy beam propagation vector in Cartesian coordinates may be given for an x-y, x-z, and/or y-z plane. In the example of FIG. 2B, a projection of an energy beam propagation vector is depicted by vector 262 (e.g., the hypotenuse of the x component 258 and the y component 256).

At times, at least two (e.g., a plurality of) guidance systems are arranged within a 3D printing system. The at least two guidance systems may have at least two (e.g., a plurality) respective processing fields. In some embodiments, a total processing area of the at least two guidance systems may be a combination of the respective processing fields. The total processing area may encompass (e.g., at least) a target surface of the 3D printing system (e.g., exposed surface of a material bed). The target surface may be organized (e.g., divided) into at least two (e.g., a plurality of) regions. The at least two guidance systems (e.g., each) may be arranged for processing (e.g., material transformation) within at least one of the target surface regions. At least two guidance systems may be arranged for processing within a same target surface region. At least two guidance systems may be arranged for processing within different target surface regions.

At times, a first processing field (e.g., of a first guidance system) at least partially overlaps a second processing field (e.g., of a second guidance system). At times, at least one processing field is juxtaposed with at least a second processing field (e.g., abuts in a non-overlapping manner). At times, at least one processing field does not abut or overlap another processing field. An overlap may comprise a (e.g., shared) region comprising a (e.g., shared) portion of the first processing field and a (e.g., shared) portion of the second processing field. The non-overlapping region may comprise a portion of a first processing field that is (e.g., mutually) distinct from a portion of a second processing field. As understood herein, total (e.g., complete) overlapping comprises at least one processing field that is entirely shared with (e.g., by) another (e.g., at least one) processing field. A total overlapping may be mutual, for example, a first guidance system having the same (e.g., shared) processing field as a second guidance system. A total overlapping may be non-mutual, for example, a first processing field that is entirely within a second processing field, which second processing field comprises an area distinct from the first processing field. Overlapping may comprise a first processing field that is (e.g., entirely or completely) shared with (e.g., a portion of) a second processing field. For example, a partial overlapping such that a portion of the second processing field is distinct from the first processing field (e.g., the first processing field is entirely encompassed by the second processing field). Characteristics of overlapping regions for a given processing field can vary between respective overlapping processing field regions. For example, a first processing field may be partially overlapping with a second processing field, and totally overlapping with a third processing field. Other combinations of (e.g., partial, total, and none) overlapping are possible for a plurality of energy beams.

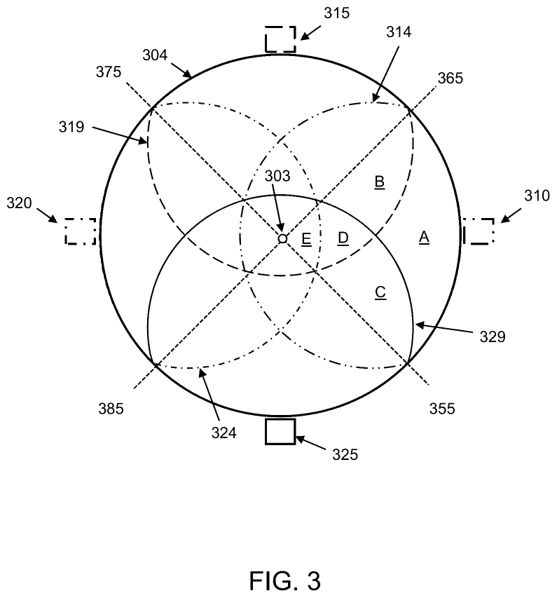

FIG. 3 depicts an example of a division of a target surface of a 3D printing system into a plurality of processing regions. In the example of FIG. 3, four processing regions are depicted with respect to the lines 355, 365, 375, and 385, inclusive: a (e.g., first) region in a between lines 355 and 365, inclusive; a (e.g., second) region in a sector between lines 365 and 375; a (e.g., third) region in a sector between lines 375 and 385, inclusive; and a (e.g., fourth) region in a sector between lines 385 and 355. The processing regions may be such a (e.g., first) processing region is juxtaposed with (e.g., does not overlap) a (e.g., second) processing region. The processing regions may be such a (e.g., first) processing region is at least partially overlapping with a (e.g., second) processing region. FIG. 3 depicts an example of an arrangement of a plurality of guidance systems with respect to a target surface 304 (e.g., FIG. 3; 310, 315, 320, and 325). In the example of FIG. 3, each of the plurality of guidance systems has a respective processing field (shown in like line type): for guidance system 310, a processing field 314; for guidance system 315, a processing field 319; for guidance system 320, a processing field 324; and for guidance system 325, a processing field and 329.

In some embodiments a symmetry between at least two processing regions and/or at least two processing fields confers a design advantage. The design advantage may comprise simplification of hardware (e.g., re-used components), software (e.g., re-used modules and/or code), or a combination thereof. The design advantage may allow utilization of a platform rotation (e.g., during the printing). In some embodiments, at least two processing regions (e.g., of a target surface) are symmetric (e.g., by inversion, reflection, rotation, and/or translation). For example, at least two processing regions may be symmetrical segments of a circle (e.g., FIG. 3; sector between 355 and 365 (inclusive), and sector between 365 and 375, inclusive). The at least two processing regions may comprise a grid symmetry (e.g., the target surface divided into a grid, e.g., forming an array). In some embodiments, at least two processing regions (e.g., of a target surface) are asymmetric. In some embodiments, at least two processing fields (e.g., of a plurality of processing fields) are symmetric with respect to each other (e.g., by inversion, reflection, rotation, and/or translation). In some embodiments, at least two processing fields (e.g., of a plurality of processing fields) are not symmetry related with respect to each other. In some embodiments, an arrangement of guidance systems comprises a symmetry. In the example of FIG. 3, the position of the plurality of guidance systems 310, 315, 320, and 325 are related to each other in inversion symmetry about a point 303 (e.g., as well as in rotation, reflection, and translation symmetry).

FIG. 3 depicts an example of a variety of overlapping processing fields on a target surface. In the example of FIG. 3, the processing field 314 includes segments A, B, C, and D. The segment A comprises an example of a portion of the processing field 314 that is non-overlapping with any other processing field. The segments B and C comprise examples of portions of the processing field 314 that area overlapping with (e.g., a portion of) one other processing field (e.g., FIG. 3; 319 and 329, respectively). The segment D comprises an example of a portion of the processing field 314 that is overlapping with (e.g., a portion of) two other processing fields (e.g., FIG. 3; 319 and 329). The segment E comprises an example of a portion of the processing field 314 that is overlapping with (e.g., a portion of) three other processing fields (e.g., FIG. 3; 319, 324 and 329). In some embodiments, a given processing field may overlap with at least about 1, 2, 3, 4, 5, 10, 15, or 20 other processing fields at least in part (e.g., at least a fraction of the processing field overlap). A processing field may overlap with any number of the afore-mentioned numbers of processing fields (e.g., from about 1 to about 20, about 1 to about 10, or about 10 to about 20 processing fields).

At times, a process window within which an energy beam is directed (e.g., a processing volume) may be limited by one or more components of the 3D printing system. For example, an optical arrangement may constrain an energy beam to impinge onto a surface at an angle of about 90°. For example, an optical arrangement comprising an f-theta lens may constrain an energy beam to impinge onto a surface at an angle of about 90° (e.g., impinge normal to the surface). In some embodiments, the system and/or apparatus comprises an f-theta lens. In some embodiments, the system and/or apparatus is devoid of an f-theta lens. In some embodiments, at least one energy beam is constrained to impinge onto a surface (e.g., the target surface) within an angular range. An angular range may be, for example, within at most about 30°, about 25°, about 20°, about 15°, about 10° or about 5°, with respect to a normal impingement of the at least one energy beam onto the surface. The angular range may be any value within a range of the afore-mentioned values (e.g., from at most about 30° to about 5°, about 30° to about 20°, or about 20° to about 5° with respect to normal impingement of the at least one energy beam onto the surface). In some embodiments, an energy beam can be directed at an acute angle within a value of from about parallel to about perpendicular relative to the target surface.

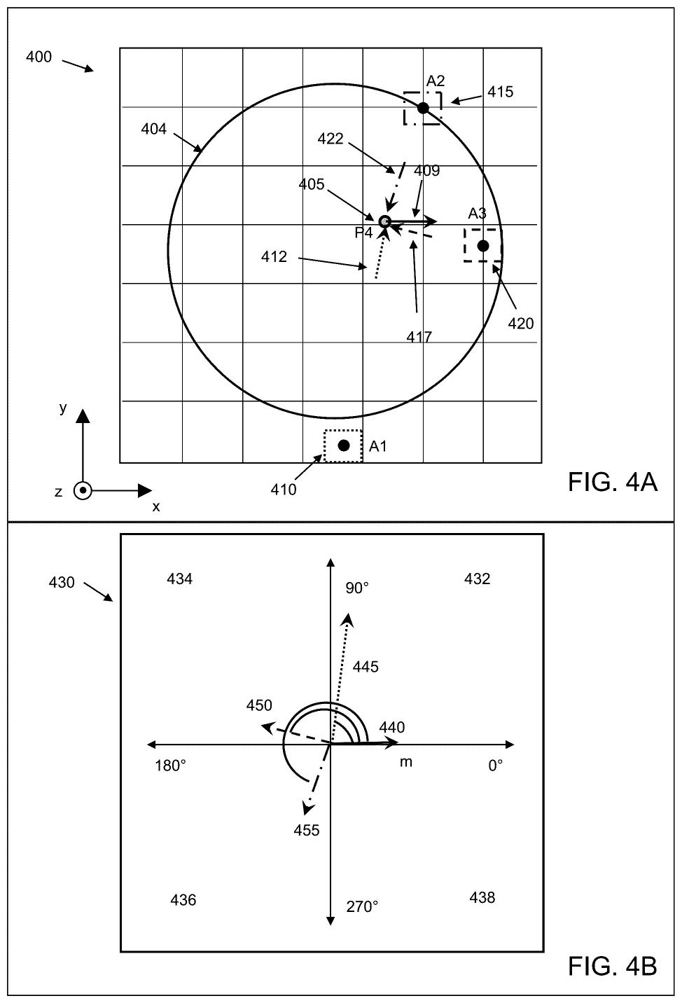

In some embodiments, an energy beam impingement angle onto a target surface is constrained by a location of a (e.g., initiation point of a) processing volume (e.g., associated with a guidance system). The initiation point of the processing volume (e.g., FIG. 2A, 210 in the optical window 206 and/or from a guidance system) may be disposed above: the target surface (e.g., using guidance system FIG. 4A, 420), the perimeter of the target surface (e.g., using guidance system FIG. 4A, 415), or outside of the target surface (e.g., using guidance system FIG. 4A, 410). The initiation point of the processing volume (e.g., in the optical window, e.g., FIG. 2A, 206) may be laterally overlapping: the target surface (e.g., using guidance system FIG. 4A, 420), the perimeter of the target surface (e.g., using guidance system FIG. 4A, 415), or outside of the target surface (e.g., using guidance system FIG. 4A, 410). For example, an initiation point of the processing volume may be positioned above and laterally outside of a (e.g., perimeter of a) target surface (e.g., FIG. 2B, 250). For example, the projection of the initiation point on a plane of the target surface may be outside a perimeter of the target surface (e.g., FIG. 2B, 260). An initiation point of a processing volume that is positioned outside of a target surface may preclude an energy beam impingement at a normal to the target surface, e.g., as guided by the respective guidance system of the processing volume. At times, at least one guidance system (e.g., all) of a plurality of guidance systems comprises a processing volume having an initiation point positioned (i) outside of a target surface, (ii) overlapping with a target surface, or (iii) inside of a target surface. At times, at least two guidance systems (e.g., all) of a plurality of guidance systems comprise processing volumes having initiation points positioned (i) outside of a target surface, (ii) overlapping with a target surface, or (iii) inside of a target surface.

Some embodiments comprise control of a direction from which an (e.g., at least one) energy beam impinges onto a target surface and/or at least a portion of a 3D object. The direction from which an energy beam impinges onto the target surface may consider a position of a processing volume initiation point (e.g., FIG. 2A, 250) with respect to the target surface (e.g., FIG. 2A, 264). For example, the position of the initiation point with respect to (e.g., around) a perimeter of the target surface. The direction from which an energy beam impinges may take into consideration the location of a given initiation point, with respect to a point of irradiation on a (e.g., target) surface (e.g., in three-dimensional coordinates in a Cartesian coordinate space). The direction from which an energy beam impinges may take into consideration (e.g., a subset of) the coordinates of the initiation point (e.g., x and y coordinates in a Cartesian coordinate space).

FIG. 4A depicts an example of an arrangement 400 of a plurality of guidance systems with respect to a (e.g., target) surface. In the example of FIG. 4A, an irradiation point 405 (e.g., ‘P’) is located on (e.g., adjacent to) a target surface 404. In some embodiments, a plurality of (e.g., at least two) guidance systems are arranged about a target surface, having a corresponding plurality of initiation points (e.g., associated with each guidance system). The initiation points may provide varied directionality and/or energy beam path length for directing an energy beam onto an irradiation point (e.g., with respect to one another). For example, the initiation points may provide varied (e.g., different) impingement angles onto an irradiation point. In the example of FIG. 4A, an initiation point for a guidance system 410 is located (e.g., laterally) outside of a target surface (e.g., FIG. 4A, ‘A1’), an initiation point for a guidance system 415 is located overlapping a target surface (e.g., FIG. 4A, ‘A2’), and an initiation point for a guidance system 420 is located (e.g., laterally) within a target surface (e.g., FIG. 4A, ‘A3’). In the example shown in FIG. 4A, vectors are depicted that represent a directionality of energy beam impingement onto a target surface from the guidance systems 410, 415, and 420 (e.g., FIG. 4A, depicted as arrows 412, 417, and 422, respectively). The (e.g., portion of the) forming 3D object may have an associated direction of formation (e.g., growth direction) at an irradiation point. In some embodiments, a growth direction at an irradiation point is represented by (e.g., unit) vector (e.g., FIG. 4A, arrow 409). In some embodiments, energy beam vectors (e.g., 412, 417, and 422) may be normalized (e.g., as unit vectors). In some embodiments, energy beam vectors may have a magnitude that is proportional to a distance of a guidance system to an irradiation point (e.g., a greater magnitude for a larger distance).

In some embodiments, a control system is configured to select usage of a guidance system, which selection process comprises considering a growth direction of a 3D object (e.g., at an irradiation point). For example, a selection of a guidance system for projecting an energy beam may comprise a consideration of a relationship between (e.g., respective) energy beam propagation vectors of the at least two guidance systems and a growth direction vector (e.g., of a 3D object at an irradiation point). In some embodiments, the energy beam propagation vector and/or the growth direction vector may be represented by a (e.g., 2D) projection onto a plane that is normal to a global vector. In some embodiments, the energy beam and/or growth direction vectors may be normalized (e.g., as unit vectors in a given direction). A control system may be configured to select a (e.g., optimal) guidance system of at least two guidance systems having an energy beam propagation vector in an (e.g., at least partially) opposing direction to a direction of a growth vector (e.g., at an irradiation point). At least partially opposing comprises a direction having at least one opposing direction component. An opposing direction may comprise an angle between two vectors (e.g., FIG. 4A, 440 and 450) that is from 90° to 270° (e.g., where “directly opposing” is 180°).

FIG. 4B illustrates a vector plot 430 showing relationships of a plurality of energy beam propagation vectors and a growth direction vector. In the example of FIG. 4B, a growth direction vector 440 forms a reference vector (e.g., at an angle of 0°) with respect to a direction of a coordinate system (e.g., Cartesian coordinates system, e.g., x axis). The example vector plot 430 comprises quadrants for delineating vector angles with respect to the growth direction vector (e.g., quadrants 432, 434, 436, and 438). In the example of FIG. 4B, three energy beam propagation vectors are shown (e.g., 445, 450, and 455, projected from three respective guidance systems, now shown). In the example of FIG. 4B, vector 445 is within quadrant 432 (e.g., from 0° to 90° with respect to the growth direction vector); vector 450 is within quadrant 434 (e.g., from 90° to 180° with respect to the growth direction vector); and vector 455 is within quadrant 436 (e.g., from 180° to 27° ° with respect to the growth direction vector). A direction of a given energy beam propagation vector with respect to a growth direction vector may consider (e.g., be based on) a position of a guidance system (e.g., that directs the given energy beam) with respect to an irradiation point. In some embodiments, a control system may direct selection of (e.g., or may select) a guidance system such that an energy beam vector is at least partially opposing a growth direction vector (e.g., FIG. 4B, vectors 450 or 455). At least partially opposes may indicate having at least one direction component in direct opposition. A magnitude of a given energy beam propagation vector may consider (e.g., be based upon) a distance from a guidance system to an irradiation point (e.g., where a larger vector magnitude corresponds with a larger distance). In the example of FIG. 4B, the magnitude of the vector 445 is larger than that of the vector 450. In the example of FIG. 4B, the larger magnitude indicates that the projection position (e.g., initiation point) of the first energy beam onto the target surface (e.g., and the position of an optical element of the first guidance system that projects and/or directs the (e.g., first) energy beam (e.g., corresponding to vector 445) to a point at the target surface) is further from the irradiation point (e.g., origin of the growth direction vector 440) than a projection position of the second energy beam onto the target surface that directs the second energy beam (e.g., and the position of an optical element of a second guidance system that projects and/or directs the (e.g., second) energy beam (e.g. corresponding to vector 450)).

In some embodiments, a control system (e.g., at least one controller) is configured to select (or direct selection of) a guidance system of at least two guidance systems to (optimally) direct an energy beam onto an irradiation point. A selection of a guidance system may consider (e.g., comprise an evaluation) of a relation between an angle of incidence of an energy beam onto a (e.g., target) surface, and/or (e.g., relative to) a direction of intended 3D object growth. For example, a control system may select a guidance system such that an angle at which an energy beam impinges onto a target surface is within a range of angles (e.g., within at most about 30° with respect to normal impingement). In some embodiments, the range of angels with which an energy beam is controlled to impinge on the target surface includes the angle of normal impingement. The range of angles may exclude the angle of energy beam impingement normal to the target surface. For example, a control system may select a guidance system of at least two guidance systems such that an angle of impingement by an energy beam is maximized (e.g., with respect to normal impingement). For example, a control system may select a guidance system of at least two guidance systems such that an angle of impingement by an energy beam is minimized (e.g., with respect to normal impingement). A selection of a guidance system may consider (e.g., comprises an evaluation of) a distance of the (e.g., initiation point of the) guidance system from an irradiation point. A control system may select a guidance system of at least two guidance systems that has an initiation point that is nearer (e.g., closest) to an irradiation point (e.g., with respect to the initiation points of the remaining guidance systems).

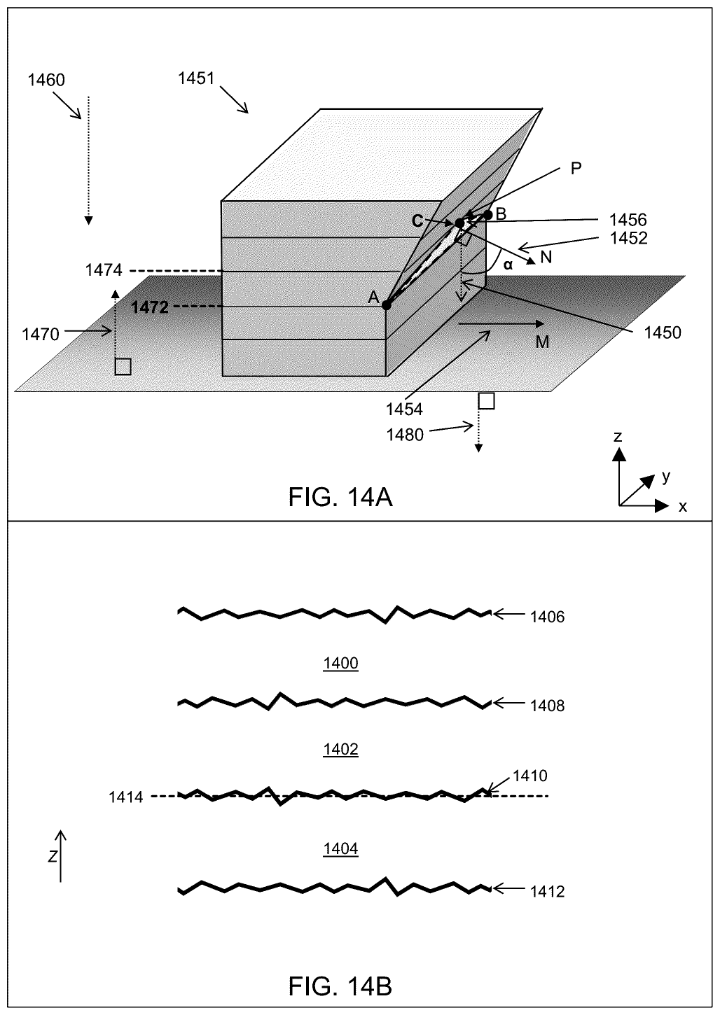

In some embodiments, for a plurality ‘n’ guidance systems there exists a corresponding set of guidance system locations A₁, A₂, . . . Aₙ, where a location Aⱼ is a location of a given guidance system ‘j’ of the plurality ‘n’ guidance system with respect to a target surface (where ‘j’ is a positive integer from 1 to ‘n’). In some embodiments, for a set of guidance system locations A₁, A₂, . . . Aₙ, there exists a corresponding set of energy beam propagation vectors V₁, V₂, . . . Vₙ, where an energy beam propagation vector Vⱼ is a vector from a given location ‘Aⱼ’ to an irradiation point (e.g., on a target surface). The point can be designated as ‘P.’ In some embodiments, a set of energy beam propagation vectors V₁, V₂, . . . Vₙ has a corresponding set of unit vectors U₁, U₂, . . . Uₙ that are projections of the energy beam propagation vectors onto a plane that is normal to a global vector. In some embodiments a unit vector ‘N’ (e.g., FIG. 14A, 1452) is a (e.g., growth direction) vector that originates at an irradiation point P of a (e.g., portion of a) 3D object (e.g., FIG. 14A, 1451). In some embodiments, the unit vector N is normal to an average of the surface at point P (e.g., point P of FIG. 14A). Averaging of the surface may comprise selecting (i) a line portion AB at the exposed surface portion to be averaged, and (ii) a point C in the surface portion to be averaged that is not part of line AB, to define a surface (ABC, e.g., of FIG. 14A) to be averaged. The point P may be within the surface ABC or as part of a perimeter of surface ABC. The forming 3D object may be formed layer-wise (e.g., layer by layer). The layers forming the 3D object may have an (e.g., average) layering plane (e.g., FIG. 14A, 1474; or FIG. 14B, 1410). The line portion AB and/or point C may each correspond to an intersection of the layering plane with the exposed surface portion to be averaged. The point C may be part of one layering plane intersection with the exposed surface portion, and line AB may be part of a different layering plane intersection with the exposed surface portion. The different layering plane may precede or supersede the layering plane to which line AB corresponds. An averaging operation on that surface (ABC) may be a mathematical averaging operation (e.g., smoothing or planarizing operation), e.g., any averaging methodology described herein. For example, the averaging of the surface may comprise selecting a line portion (e.g., FIG. 14A, line AB) from an intersection of a layering plane of a layer n (e.g., FIG. 14A, 1472) with the exposed surface that is to be averaged, and a point (C) from an intersection of a layering plane of any subsequent layer (e.g., ‘n+1’) (e.g., FIG. 14A, 1474) that intersects the surface to be averaged, to define a surface (ABC) to be averaged (e.g., FIG. 14A, 1456), and performing a (e.g., mathematical) averaging operation on that surface (ABC). The unit vector N may form an angle alpha with a global vector (e.g., FIG. 14A, 1450). The angle alpha can be at most about 450, 350, 30°, 25°, 20°, 15°, 10°, or 5° (degrees), with respect to the global vector. The angle alpha can any angle between the afore-mentioned angles (and zero) (e.g., from about 45° to about 0°, from about 35° to about 0°, from about 25° to about 0°, or from about 15° to about 0°), with respect to the global vector. The unit vector N may be directed away from (e.g., out of) the three-dimensional object (e.g., 1452). The global vector may be (a) directed to the local gravitational center (e.g., FIG. 14A, 1460) (e.g., Earth's center, e.g., acceleration vector), (b) directed opposite to the direction of layer-wise deposition to print the three-dimensional object (e.g., FIG. 14A, 1470 depicting the direction of layer-wise deposition), and/or (c) normal to a platform configured to support the three-dimensional object during its printing and directed opposite to a surface of the platform that supports the three-dimensional object (e.g., FIG. 14A, 1480). In some embodiments, a unit vector ‘M’ (e.g., FIG. 14A, 1454) is a projection of a vector ‘N’ (that is normal to the surface of the 3D object at an irradiation point P.

In some cases, a layer comprises a layering plane corresponding to an average layering plane. FIG. 14B shows an example schematic vertical cross section of a portion of a 3D object having layers of hardened material 1400, 1402, and 1404 sequentially formed during the 3D printing process. Boundaries (e.g., FIG. 14B, 1406, 1408, 1410 and 1412) between the layers may be visible (e.g., by human eye or using microscopy). The microscopy method may comprise optical microscopy, scanning electron microscopy, or transmission electron microscopy. The boundaries between the layers may be evident by a microstructure of the 3D object. The boundaries between the layers may be (e.g., substantially) planar. The boundaries between the layers may have some irregularity (e.g., roughness) due to the transformation (e.g., melting and or sintering) process (e.g., and formation of any microstructure such as melt pools). An average layering plane (e.g., FIG. 14B, 1414) may correspond to a (e.g., imaginary) plane that is estimated or calculated average. A calculated average may correspond to an arithmetic mean of (e.g., of number of point locations on a boundary between layers). A calculated average may be calculated using, for example, a linear regression analysis. In some cases, the average layering plane consider deviations from a nominal planar shape.

In some embodiments a set of (e.g., inner) products S₁, S₂, . . . Sₙ is determined between energy beam propagation vectors (e.g., of U₁, U₂, . . . Uₙ) and a growth direction vector (e.g., ‘M’). The product may be a scalar product. A (e.g., scalar) value Sⱼ may range from −1 (e.g., when an angle between two vectors is 180°) to 1 (e.g., when an angle between two vectors is 0°). In some embodiments, a control system is configured to select a guidance system of the ‘n’^{th} guidance systems for directing an energy beam to irradiation at an irradiation point considering a result of the (e.g., set of) inner products. For example, a control system may select a guidance system such that an inner product Sⱼ has a value that is at most about 0.5 (e.g., such that an angle between an energy beam propagation vector and a growth direction vector is from about 60° to about 330°). A control system may select a guidance system such that an inner product Sⱼ has a value that is at most about 0. A control system may select a guidance system of the ‘n’^{th} guidance system such that a value of Sⱼ is minimized. For example, a control system may select of the guidance system positioned at Aⱼ such that Sⱼ=min {S₁, S₂, . . . Sₙ}. In some embodiments, a plurality of guidance systems are arranged to provide a selected directionality of energy beam propagation onto an irradiation point (e.g., at the target surface). For example, a plurality of guidance systems may be arranged such that, for any point within a target surface, at least one guidance system is arranged to have a location Aⱼ such that Sⱼ has a value that is at most about 0.5, 0.3, 0.2, 0.1, 0, −0.1, −0.2, −0.5, −0.7, −0.8 or −1. The at least one guidance system may be arranged to have a location Aⱼ such that Sⱼ has a value between any of the afore-mentioned values (e.g., from about 0.5 to about −1, from about 0.5 to about 0, from about 0 to about −1). In some embodiments, an irradiation point (e.g., FIG. 4A, 405) may be located on a (e.g., target) surface such that, for a guidance system Aⱼ, Sⱼ has a value that is at most about 0.5, 0.3, 0.2, 0.1, 0, −0.1, −0.2, −0.5, −0.7, −0.8 or −1. The irradiation point may be located such that Sⱼ has a value between any of the afore-mentioned values (e.g., from about 0.5 to about −1, from about 0.5 to about 0, from about 0 to about −1). In some embodiments, a set of inner products Wⱼ, W₂, . . . Wₙ is determined between the set of energy beam propagation vectors V₁, V₂, . . . Vₙ and the corresponding set of unit vectors U₁, U₂, . . . Uₙ. The inner product may be a scalar product. In some embodiments, a control system is configured to select a guidance system location (e.g., Aⱼ) such that Sⱼ+R·Wⱼ=min {S₁+R·W₁, S₂+R·W₂, . . . Sₙ+R·Wₙ} (e.g., where R is a constant having a value that ranges from zero to one). In some embodiments, a control system is configured to select a guidance system location (e.g., Aⱼ) such that Sⱼ·Wⱼ=min {S₁·W₁, S₂·W₂, . . . Sₙ·Wₙ}. At times, a growth direction of a (e.g., portion of a) 3D object is related to a (e.g., layer-wise) manner in which the 3D object is formed. Formation of a 3D object may comprise a process of disposing a planar layer of pre-transformed material (e.g., by lowering a platform, dispensing a pre-transformed (e.g., particulate) material, and planarizing the dispensed material), and transforming a portion of the material bed (e.g., by energy beam irradiation) to (e.g., subsequently or directly) form a hardened material, the process may be repeated until a requested 3D object is printed layer by layer (e.g., additively, layerwise). A printed 3D object may comprise a plurality of layers that are indicative of a layerwise forming (e.g., printing) of the 3D object. In some embodiments, the 3D object comprises a hanging structure (e.g., wire, ledge, or shelf). The hanging structure may be a (e.g., vertically) thin structure. The hanging structure may be a plane-like structure. A 3D plane may have a relatively small width as opposed to a relatively large surface area. For example, the 3D plane may have a small height relative to a large horizontal plane. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have a shape of a curving scarf. In some cases, the 3D object comprises a skin. The skin can correspond to a portion of the 3D object that comprises an exterior surface of the 3D object. The skin may be referred to herein as an “outer portion,” or “exterior portion” of the 3D object. In some embodiments, the skin is a “bottom” skin, which can correspond to a skin on a bottom of an overhang with respect to a platform surface during a printing operation. Bottom may be in the direction of the global vector, e.g., as disclosed herein. In some cases, the bottom skin of an overhang has a different surface quality than other portions of the 3D object. The surface quality can include a surface roughness, appearance, reflectivity, specularity, and/or shininess. In some cases, the bottom skin of an overhang has (e.g., substantially) the same surface quality than other portions of the 3D object.

In some embodiments, the 3D object is generated with respect to a (e.g., virtual) model of a requested 3D object. The 3D object model may comprise a simulated model. The model may be a computer-generated model. The 3D object model may comprise a (e.g., 3D object) surface. In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm with respect to a model of the requested 3D object. With respect to a model of the requested 3D object, the generated 3D object may be generated with the accuracy of any accuracy value between the afore-mentioned values (e.g., from about 5 μm to about 100 μm, from about 15 μm to about 35 μm, from about 100 μm to about 1500 μm, from about 5 μm to about 1500 μm, or from about 400 μm to about 600 μm). The 3D object (e.g., solidified material) that is generated for the customer can have an average deviation value from the intended dimensions of at most about 0.5 microns (μm), 1 μm, 3 μm, 10 μm, 30 μm, 100 μm, 300 μm or less. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dᵥ+L/K_{dv}, wherein Dᵥ is a deviation value, L is the length of the 3D object in a specific direction, and K_{dv} is a constant. Dᵥ can have a value of at most about 300 μm, 200 μm, 100 μm, 50 μm, 40 μm, 30 μm, 20 μm, 10 μm, 5 μm, 1 μm, or 0.5 μm. Dᵥ can have any value between the afore-mentioned values (e.g., from about 0.5 μm to about 300 μm, from about 10 μm to about 50 μm, from about 15 μm to about 85 μm, from about 5 μm to about 45 μm, or from about 15 μm to about 35 μm). K_{dv} can have a value of at most about 3000, 2500, 2000, 1500, 1000, or 500. Kay can have any value between the afore-mentioned values (e.g., from about 3000 to about 500, from about 1000 to about 2500, from about 500 to about 2000, from about 1000 to about 3000, or from about 1000 to about 2500).

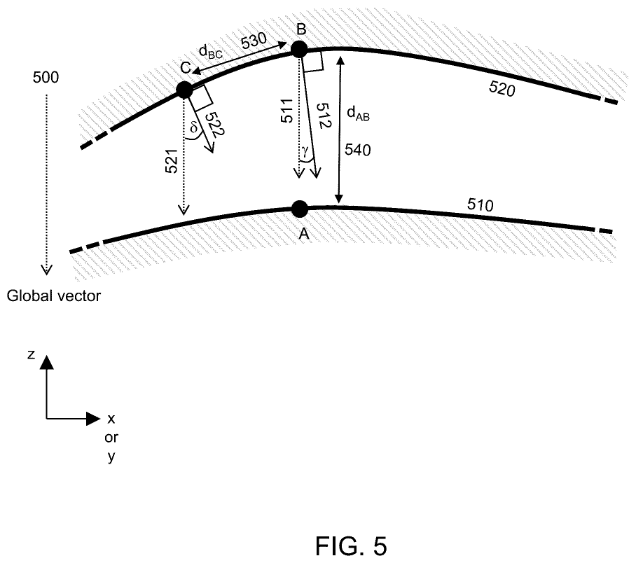

FIG. 5 shows an example of a first (e.g., top) surface 510 and a second (e.g., bottom) surface 520 of a 3D object. At least a portion of the first and second surface may be separated by a gap. At least a portion of the first surface may be separated from at least a portion of the second surface (e.g., to constitute a gap). The gap may be filled with pre-transformed or transformed (e.g., and subsequently hardened) material, e.g., during the formation of the 3D object. The second surface may be a bottom skin layer. FIG. 5 shows an example of a vertical gap distance 540 that separates the first surface 510 from the second surface 520. Point A (e.g., in FIG. 5) may reside on the top surface of the first portion. Point B may reside on the bottom surface of the second portion. The second portion may be a cavity ceiling or hanging structure as part of the 3D object. Point B (e.g., in FIG. 5) may reside above point A. The gap may be the (e.g., shortest) distance (e.g., vertical distance) between points A and B. FIG. 5 shows an example of the gap 540 that constitutes the shortest distance d_{AB} between points A and B. There may be a first normal to the bottom surface of the second portion at point B. FIG. 5 shows an example of a first normal 512 to the surface 520 at point B. The angle between the first normal 512 and a direction of global vector 500 may be any angle γ. A global vector may be (a) directed to a gravitational center, (b) directed opposite to the direction of a layer-wise deposition to print a three-dimensional object, and/or (c) normal to a platform configured to support the three-dimensional object during its printing, and directed opposite to a surface of the platform that supports the three-dimensional object. Point C may reside on the bottom surface of the second portion. There may be a second normal to the bottom surface of the second portion at point C. FIG. 5 shows an example of the second normal 522 to the surface 520 at point C. The angle between the second normal 522 and the global vector 500 may be any angle δ. Vectors 511, and 521 are parallel to the global vector 500. The angles γ and δ may be the same or different. The angle between the first normal 512 and/or the second normal 522 to the global vector 500 may be any angle alpha disclosed herein. For example, alpha may be at most about 450, 40°, 30°, 20°, 10°, 5°, 3°, 2°, 1°, or 0.5°. The angle alpha may be any value of the afore-mentioned values (e.g., at most about 45° to about 0.5°, from about 45° to about 20°, or from about 20° to about 0.5°). The auxiliary support structure and auxiliary support feature spacing distance (e.g., the shortest distance between points B and C) can be any, e.g., as disclosed in Patent Application Serial No. PCT/US15/36802 filed on Jun. 19, 2015, titled “APPARATUSES, SYSTEMS AND METHODS FOR THREE-DIMENSIONAL PRINTING,” which is entirely incorporated herein by reference in its entirety. For example, the shortest distance BC (e.g., d_{BC}) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm, 35 mm, 40 mm, 50 mm, 100 mm, 200 mm, 300 mm, 400 mm, or 500 mm. FIG. 5 shows an example of the shortest distance BC (e.g., 530, d_{BC}). The bottom skin layer may be the first surface and/or the second surface. The bottom skin layer may be the first formed layer of the 3D object. The bottom skin layer may be a first formed hanging layer in the 3D object (e.g., that is separated by a gap from a previously formed layer of the 3D object). The vertical distance of the gap may be at least about 30 μm, 35 μm, 40 μm, 50 μm, 60 μm, 70 μm, 80 μm, 90 μm, 100 μm, 150 μm, 200 μm, 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm or 20 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about 0.05 mm to about 20 mm, from about 0.05 mm to about 0.5 mm, from about 0.2 mm to about 3 mm, from about 0.1 mm to about 10 mm, or from about 3 mm to about 20 mm).

In some embodiments, a boundary (e.g., skin and/or surface) of a 3D object is considered during the formation of the 3D object. For example, a growth direction of a (e.g., portion of a) 3D object at a given irradiation point may consider a boundary of the 3D object. The consideration of the boundary may comprise consideration of a boundary region that is local to the irradiation point. Local to the irradiation point may comprise a region that is within about a layer height (e.g., a thickness of a material layer) from the irradiation point (e.g., any layer height as described herein).

In some embodiments, a boundary of a (e.g., forming) 3D object varies from layer-to-layer. In some embodiments, a boundary of a 3D object may be an outer portion (e.g., a skin) of the 3D object. A layer-to-layer variation of a boundary of a 3D object may comprise a growth direction of the 3D object (e.g., from a layer number ‘n’ to a layer number ‘n+1’). A growth direction of a 3D object at a given layer may comprise an orientation of a boundary of the 3D object at the layer number ‘n’ and/or the layer number ‘n+1’ (e.g., that is successive to the layer number ‘n’). Successive may be immediately successive. For example, a growth direction of a 3D object at a given layer may be represented as a vector at a given (e.g., irradiation) position on the 3D object. For example, a growth vector may be represented as a vector that is normal (e.g., in a direction outward of the 3D object) to a boundary of the 3D object at the given irradiation position. For a given layer, a 3D object may be represented as a section (e.g., a fraction) of the requested 3D object. A given fraction of a 3D object may comprise a plurality of irradiation positions. In some embodiments, a growth vector is associated with at least two (e.g., all) irradiation positions for a given fraction of a 3D object. In some embodiments, a growth vector is associated with at least two (e.g., all) irradiation positions corresponding to a boundary (e.g., a skin) of a given fraction of a 3D object.

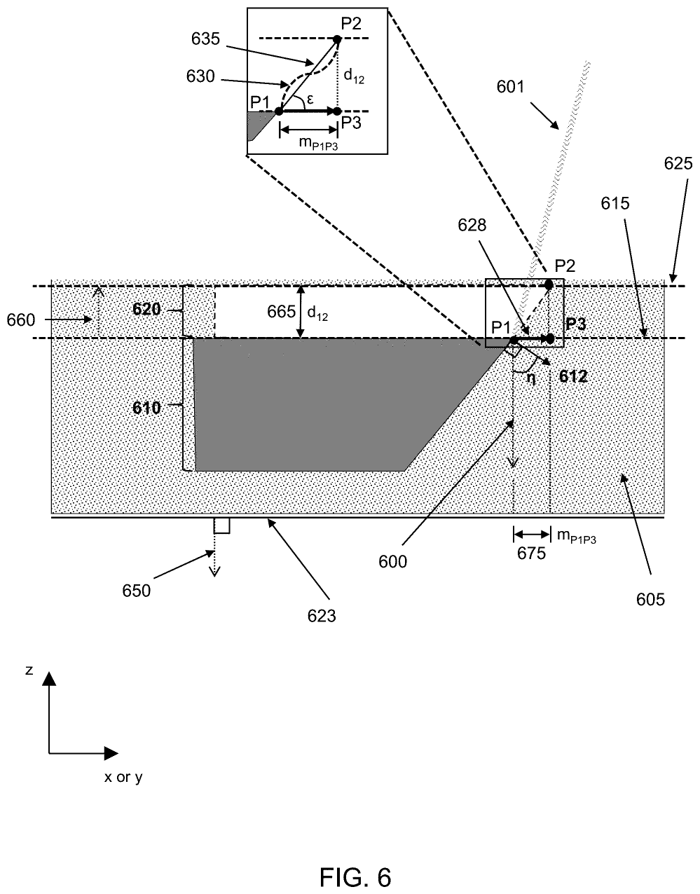

In the example of FIG. 6, a portion of a (e.g., forming) 3D object within a (e.g., pre-transformed) material bed 605 is depicted. In the example of FIG. 6, a first formed (e.g., comprising at least a layer ‘n,’ and/or hardened) portion of a 3D object is shown by a region 610, and a second (e.g., layer ‘n+1,’ and/or to-be-formed) portion of the 3D object is shown by a region 620. A thickness (e.g., a height) of a layer may be given by a (e.g., shortest) distance between a top surface of a first layer and a top surface of a successive second layer (e.g., distance d₁₂, 665). Top may be with respect to a global vector. For example, for two positions in a 3D printing system, a (e.g., first) position (e.g., FIG. 6, P2) that has a lower global vector value than a (e.g., second) position (e.g., FIG. 6, P1) is above the (e.g., second) position. A thickness of a first (e.g., ‘n’) layer may be the same as a thickness of a second (e.g., ‘n+1’) layer. A thickness of a first (e.g., ‘n’) layer may be different than a thickness of a second (e.g., ‘n+1’) layer. The 3D objection may be supported (e.g., indirectly or directly) by a platform (e.g., FIG. 6, 623). FIG. 6 depicts an example of an irradiation point P1 at a boundary of the 3D object (e.g., that is irradiated by an energy beam 601). FIG. 6 depicts a point P2 that is above (e.g., higher than) the point P1 by the layer height 665, and that is at a boundary of the 3D object. In the example of FIG. 6, a global vector 600, a vector 650 that is normal to the platform, a vector 660 that is in a direction of a layer-wise formation (e.g., material addition) Are depicted. The global vector can be the gravitational acceleration vector, e.g., in the direction of the local gravitational field. The vector 660 may have a magnitude that is equal to a height of a given layer (e.g., ‘n+1’). FIG. 6 depicts a plane 615 that passes through the irradiation point P1 and is normal to the global vector 600; and a plane 625 that passes through the point P2 and is normal to the global vector 600. The plane may be parallel to the layering plane of the layers that make up the 3D object. In the example of FIG. 6, the point P2 is projected (e.g., along the direction of the global vector) onto the plane 615 at a point P3.

In some embodiments, a growth vector of a 3D object at given point (e.g., P1) considers a geometry of the 3D object in a region of the given point. In the example of FIG. 6, a growth vector 612 is normal to the surface of the 3D object at the irradiation point P1, in a direction outward from the 3D object. An angle between a growth vector (e.g., 612) that is normal to a surface of the 3D object (e.g., at point P1) and the global vector (e.g., 600) may be defined (e.g., angle η). In some embodiments, a growth vector that is normal to a surface of a 3D object may have a direction such that an inner (e.g., dot, or scalar) product of the growth vector and the global vector (e.g., 600) is positive (e.g., has a value at least equal to zero). In some embodiments, a geometry of a 3D object may comprise relationship between a (e.g., first) boundary (e.g., surface) of the 3D object that was formed (e.g., at P1) in a prior step (e.g., print increment), and a (e.g., second) boundary of the (e.g., portion of the) 3D object (e.g., at P2) that is formed in a current step (e.g., print increment). In the example of FIG. 6, a growth vector 628 for the irradiation point P1 depicts an origination point at the surface of the 3D object (e.g., at P1), and an end point at the point P3 (e.g., projection of the boundary surface P2 of the 3D part from the layer 620, onto the plane 615). A magnitude of the example growth vector 628 is given by a distance m_{P1P2} (e.g., 675) from the irradiation point P1 and the projected point P3. At times, a characteristic of a (e.g., surface fraction of a) 3D object from a first layer to a second layer comprises an angle characterizing the surface of the 3D object (e.g., with respect to the global vector) at (e.g., at least two points) of the first layer and the second layer. For example, an angle ε may be defined as the arctangent of the ratio of the distance between layers (e.g., d₁₂) and the magnitude of the growth vector in a plane normal to the global vector (e.g., m_{P1P2}); e.g., ε=tan⁻¹(d₁₂/m_{P1P2}). The example FIG. 6 shows an angle ε formed by a (e.g., first) line between points P1 and P2, and a (e.g., second) line between the points P1 and P3. The angle ε at an irradiation point may correspond to a growth angle of a 3D object from a first layer (e.g., ‘n’) to a second layer (e.g., ‘n+1’), in a vicinity of the irradiation point. For example, larger values of an angle ε may correspond with a growth angle that is closer to vertical (e.g., anti-parallel) with respect to a global vector); smaller values of an angle ε may correspond to a growth angle that is closer to perpendicular with respect to a global vector. The angle(s) relative to the global vector may be during printing of the 3D object.

FIG. 6 depicts an example surface 630 of a 3D object between a point on a first layer and a point on a second (e.g., subsequently formed) layer (e.g., P1 and P2). The example surface 630 is non-planar (e.g., curvy) between the two layers (e.g., in a z-x and/or a z-y plane). An example (e.g., average) surface 635 is depicted between the layers 610 and 620 (e.g., between points P1 and P2). The surface (e.g., FIG. 6, 635) may be an average of points on a (e.g., non-planar) surface. A surface (e.g., FIGS. 6, 630 and/or 635) may be a surface of a model (e.g., a model of the 3D object). The average surface may be a (e.g., a mathematically) smoothed, or planarized surface of the object that is averaged in an area of a circle having a radius of at least about 0.25 a millimeter (mm), 0.5 mm, 1 mm, 1.5 mm, or 2 mm, centering at point P, which circle is disposed on the surface. Averaging of the surface may comprise selecting a line portion (AB) from the intersection of a layering plane of a layer n with the exposed surface that is to be averaged, and a point (C) from an intersection of a layering plane of a subsequent layer (‘n+1’) that intersects the surface to be averaged, to define a surface (ABC) to be averaged, and performing a (e.g., mathematical) averaging operation on that surface (ABC). Averaging operating may comprise a mean, or at least squares value operation.

In some embodiments, a control system (e.g., at least controller) configured to select a guidance system of a plurality of guidance systems is operatively coupled with one or more optical elements. The at least one controller may be configured to select an energy beam path (e.g., trajectory) for an energy beam for irradiating a (e.g., target) surface. The energy beam path may originate at an energy source and end at an irradiation position (e.g., on a target surface). An energy beam path may comprise a guidance selection beam path (e.g., a path from an energy source to a given guidance system at location Aⱼ). An energy beam path may comprise (a) an angle, (b) a direction, (c) a distance, or (d) any combination thereof, of an energy beam impingement onto a target surface (e.g., impingement with respect to an initiation point of the energy beam). The angle may be relative to the target surface or to the global vector. In some embodiments, the at least one controller is configured to select an energy beam path by movement of (i) at least one optical element (e.g., a mirror) in a guidance selection beam path, (ii) a position of a guidance system of at least two guidance systems (e.g., with respect to a target surface), or (iii) any combination thereof. In some embodiments, the at least one controller is (e.g., also) operatively coupled with at least one energy source. In some embodiments, control of an energy source, an optical element of a guidance selection beam path, or a guidance system is provided by the same controller. In some embodiments, control of an energy source, an optical element of a guidance selection beam path, or a guidance system is provided by at least two controllers.

In some embodiments, at least one guidance system (e.g., and at least one initiation point) has a position that is fixed with respect to the target surface, at least during the printing operation. Fixed may be stationary (e.g., with respect to the target surface) at least during printing. For example, the guidance system position may be fixed with respect to a perimeter of the target surface, at least during printing. The guidance system that is fixed during the printing may be (e.g., controllably) movable before and/or after the printing. In some embodiments, at least two guidance systems are arranged to have differing initiation positions (e.g., directions of incidence) with respect to a target surface (e.g., as in FIG. 4A, 410, 415, and/or 420). The at least two guidance systems may be operatively coupled with a same energy source, or with different energy sources. The position from which an energy beam impinges onto a surface (e.g., directionality of the energy beam) may be controlled. For example, the directionality of an energy beam from a given energy source may be controlled by selecting a guidance system of at least two guidance systems for directing the energy beam onto the target surface. Selecting a guidance system for directing an energy beam may comprise directing an energy beam along an energy beam path. An energy beam path may comprise a (e.g., optical) path from the energy source to the (e.g., selected) guidance system. An energy beam path from an energy source to a guidance system may be referred to herein as a “guidance selection beam path.” In some embodiments, a guidance selection beam path exists for at least two (e.g., all) guidance systems that are operatively coupled to at least one shared energy source. The control may comprise manual or automatic control (e.g., using at least one controller). The control may be before, during, and/or after printing. For example, control may comprise real-time control.

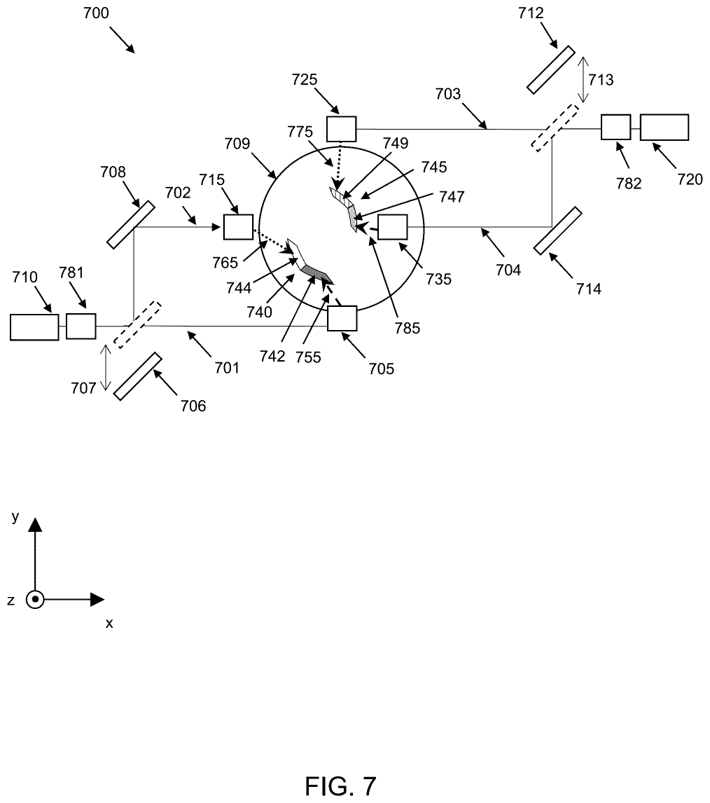

FIG. 7 depicts an example of an arrangement 700 of a plurality of guidance systems and a (e.g., target) surface 709. In the example of FIG. 7, a (e.g., first) energy source 710 is configured to irradiate energy (e.g., an energy beam) along a (e.g., first) energy beam path 701 to a guidance system 705; and along a (e.g., second) energy beam path 702 to a guidance system 715. The example in FIG. 7 shows a (e.g., second) energy source 720 that is configured to irradiate energy (e.g., an energy beam) along a (e.g., third) energy beam path 703 to a guidance system 725; and along a (e.g., fourth) energy beam path 704 to a guidance system 735. In the example of FIG. 7, the guidance systems 715 and 725 are arranged to have initiation points that are (e.g., laterally) outside of a target surface 709; the guidance system 705 is arranged to have an initiation point that is overlapping the target surface; and the guidance system 735 is arranged to have an initiation point that is (e.g., laterally) within the target surface.

In some embodiments, the energy beam (e.g., optical) path from an energy source to a target surface comprises a variable focus mechanism (e.g., FIG. 7, 781, 782). The variable focus mechanism may comprise aberration-correcting optics (e.g., achromatic optics, or apochromatic optics). The variable focus mechanism may be any, e.g., as disclosed in Patent Application serial number PCT/US17/64474, which is incorporated herein by reference in its entirety. The variable focus mechanism may adjust the focus of an energy beam, e.g., on a (e.g., target) surface. The variable focus mechanism may comprise one or more optical elements. At least one of the one or more optical elements may be stationary. At least one of the one or more optical elements may be movable (e.g., translatable, rotable, or any combination thereof). The energy beam path may be controlled manually and/or by a controller; before, after, and/or during the printing. The controller may control positions of the optical elements, e.g., to adjust the focus of the energy beam on the target surface and/or on a detector. The controller may consider (e.g., take into account) an energy beam selection path for adjusting the focus of the energy beam on the target surface. The optical element may be a negative optical element (e.g., a concave lens or a diverging lens). The optical element may be a positive optical element (e.g., a convex lens or a converging lens). The optical element may be planar. The optical element may comprise a (e.g., objective) lens, a mirror, a reflective objective, a prism, a beam splitter, an optical window, a filter, a polarizer, a grating, a retarder, a fiber (e.g., expander), a beam shaper, or a collimator (e.g., as in a Galilean and/or Newtonian telescope).

In some embodiments, an optical element comprises a material having a low (e.g., thermal) conductivity. For example, materials having a low conductivity may include those having a conductivity at 300K of no greater than about 2 Watts per meters times Celsius degrees ° C. (W/m° C.). For example, materials having a high (e.g., thermal) conductivity may include those having a conductivity at 300K that is greater than about 2 W/m° C. The optical element material may include SCHOTT N-BK 7®, SCHOTT N-SF2, UV fused silica (e.g., UV fused silica), Pyrex®, Zerodur®, fused silica, fused quartz, sodium carbonate (Na₂CO₃), lime (CaO), magnesium oxide (MgO), aluminum oxide (Al₂O₃), boron trioxide (B₂O₃), soda (Na₂O₃), barium oxide (BaO), lead oxide (PbO), potassium oxide (K₂O), zinc oxide (ZnO), and/or germanium oxide (GeO₂), calcium fluoride (CaF₂), magnesium fluoride (MgF₂), crystal quartz, sapphire, zinc selenide (ZnSe), zinc sulfide (ZnS), potassium fluoride (KF), barium fluoride (BaF₂), gallium arsenide (GaAs), germanium, lithium fluoride (LiF), magnesium fluoride (MgF₂), potassium bromide (KBr), potassium chloride (KCl), crystalline silicon, beryllium and/or silicon carbide (SiC).

At times, one or more optical elements in an optical system of the 3D printing system comprise (e.g., are formed of) a composition and/or material such that it may be characterized as having a (e.g., relatively) high thermal conductivity, a (e.g., relatively) low optical absorption coefficient, and/or a (e.g., relatively) low temperature coefficient of the refractive index (dn/dT). An optical element such as this may exhibit a reduced thermal distortion (e.g., over the time required for 3D printing). The thermal distortion may comprise thermal lensing. A thermal lensing effect may comprise a change in a refractive index of an optical element that is caused by a change in a temperature of the optical element. An optical element having high thermal conductivity may include a thermal conductivity of at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. An optical element having a low optical absorption coefficient can be at most about 10 ppm, 50 ppm, 100 ppm, or 250 ppm per centimeter at the wavelength of the irradiating energy beam. A low temperature coefficient of refractive index can refer to an optical element that has a refractive index deviation (e.g., at the wavelength of the irradiating energy beam) of at most about 2%, 5%, 8%, 10%, 12% or 15%, in a temperature range at least about 10° C. to at most about 140° C. A low temperature coefficient of refractive index can be a relative change in refractive index, for example at a temperature change from 20° C. to 40° C. at the irradiating wavelength (e.g., 1060 nm), from about 1.5*10⁻⁶/Kelvin (K) to about −2.2*10⁻⁶/K, from about 2*10⁻⁶/K to about −3*10⁻⁶/K, from about 3*10⁻⁶/K to about −4.5*10⁻⁶/K. The low temperature coefficient of refractive index may be measured at ambient pressure (e.g., of one (1) atmosphere). Materials that may exhibit a reduced thermal lensing effect include calcium fluoride (CaF₂), magnesium fluoride (MgF₂), crystal quartz, sapphire, zinc selenide (ZnSe), zinc sulfide (ZnS), potassium fluoride (KF), barium fluoride (BaF₂), gallium arsenide (GaAs), germanium, lithium fluoride (LiF), magnesium fluoride (MgF₂), potassium bromide (KBr), potassium chloride (KCl), and/or crystalline silicon. An optical element may comprise Beryllium and/or silicon carbide. The optical element having the reduced thermal lensing effect can be any optical element disclosed herein (e.g., an optical window, a mirror, a lens, a filter and/or a beam splitter). The optical element (having the reduced thermal effect) can comprise any of the materials exhibiting a reduced thermal lensing effect.

In some embodiments, an energy beam path is selected by a movement of an optical element. The energy beam path may comprise one or more optical elements (e.g., configured to enable directing an energy beam along an energy beam path). In some embodiments, an energy beam path comprises an optical element (e.g., a mirror, or beam splitter). In some embodiments, an energy beam path is devoid of a beam splitter. In the example of FIG. 7, a (e.g., second) energy beam path 702 comprises optical elements 706 and 708; and a (e.g., fourth) energy beam path comprises optical elements 712 and 714. In some embodiments, an energy beam path is devoid of an (e.g., energy beam path selection) optical element between a focus mechanism and a guidance system (e.g., FIG. 7, energy beam paths 701 and 703). The (e.g., selection of an) energy beam path may be controlled manually and/or by a controller. The control may be real-time control (e.g., before, during and/or following at least a portion of the 3D printing). The controller may control the positions of the optical elements, e.g., to adjust the energy beam path. For example, the controller may move at least one movable optical element into an optical path. Movement may comprise translation, rotation, or a combination thereof. An optical element may be configured for (e.g., translational and/or rotational) movement into and out of the optical path to (a) direct an energy beam to one or more guidance systems at a (e.g., first) position, or (b) direct the energy beam to the one or more guidance systems at a different (e.g., second) position. In the example of FIG. 7, the energy beam paths 702 is selected by a movement of a (e.g., movable) optical element 706 into an energy beam path (e.g., along arrow 707). Movement of an optical element into a (e.g., first) energy beam path may re-direct (e.g., reflect, refract, and/or deflect) an energy beam into a different (e.g., second) energy beam path. In the example of FIG. 7, the optical element 706, once moved along arrow 707, re-directs the energy beam onto a (e.g., stationary) optical element 708 and onto the guidance system 715. In the example of FIG. 7, the energy beam path 704 is enabled by a movement of the optical element 712 along arrow 713 into the optical path 703, deflecting the energy beam to the (e.g., stationary) optical element 714 and onto the guidance system 735. In some embodiments, re-direction of an energy beam path comprises at least one of (i) a stationary optical element, (ii) a movable optical element, or (iii) any combination thereof.

In some embodiments, a control system (e.g., at least one controller) selects a guidance system of a plurality of guidance systems for transforming a 3D object considering a position of the (e.g. given) guidance with respect to a position of the (e.g., portion of the) 3D object (e.g., on the target surface). In the example of FIG. 7, the target surface 709 comprises a (e.g., first) 3D object 740 comprising portions 742 and 744, and a (e.g., second) 3D object 745 comprising portions 747 and 749. In the example of FIG. 7, a control system selects the guidance system 705 to direct an energy beam 755 to irradiate the target surface for transforming the portion 742; the guidance system 715 to direct an energy beam 765 to irradiate the target surface for transforming the portion 744; the guidance system 725 to direct an energy beam 775 to irradiate the target surface for transforming the portion 749; and the guidance system 735 to direct an energy beam 785 to irradiate the target surface for transforming the portion 747.

In some embodiments, a (e.g., optical) path length is maintained between energy beam paths. A path length may comprise a path traveled by an energy beam from an energy source and a guidance system. In some embodiments, a path length may be configured to be substantially the same between energy beam paths for at least two guidance systems that are operatively coupled with a same energy source. A path length may be fixed (e.g., for an energy source and a guidance system having fixed positions). A path length may vary (e.g., for a guidance system having a variable position, with respect to a target surface). In some embodiments, compensation for a change in a path length (e.g., by movement of a guidance system) may be made. For example, compensation may be made by movement of at least one optical element (e.g., to maintain a path length to the guidance system from a first position to a second position). In some embodiments, a change in a path length may be compensated by a change in a focus of the energy beam (e.g., by a variable focus mechanism, such as FIG. 7, 782).

At times, an energy beam path that is changed (e.g., re-directed) from a first guidance system to a second guidance system has a transition time. A transition time may be a time from cessation of directing an energy beam along a first energy beam path (e.g., along FIG. 7, 701), to initiation of directing an energy beam along a second energy beam (e.g., along FIG. 7, 702). The transition time may comprise (1) a time for a command to be received and/or executed by a controller, (II) a time for a movement of one or more optical elements to re-direct the energy beam, or (Ill) a settling time of the one or more optical elements. A settling time may be a time required for an optical element to come to rest (e.g., become stationary), following a movement. In some embodiments, a transition time may be at most about 2 seconds (sec), 1 sec, 0.5 sec, 0.3 sec, or 0.1 sec. A transition time may be any time between the afore-mentioned values (e.g., from about 2 sec to about 0.1 sec, from about 2 sec to about 0.5 sec, or from about 0.5 sec to about 0.1 sec).

At times, a positional accuracy with which an optical element is positioned and/or maintained is a factor in the accuracy with which an energy beam is directed onto a (e.g., target surface). For example, the accuracy with which an optical element in a variable focus mechanism and/or an energy beam path is positioned and/or maintained may be controlled and/or measured. For example, a positioning of an optical element may comprise a kinematic mounting. In some embodiments, an optical element is coupled with a (e.g., linear, tilt and/or rotary) stage. The positional accuracy may be subject to a (e.g., threshold) requirement. A requirement may be such that (e.g., normal) operation of a 3D printer is maintained (e.g., with respect to an energy beam positioning on a target surface). For example, the requirement may be an accuracy of an energy beam (e.g., spot) position on a target surface that is at most 20 microns (μm), 15 μm, 10 μm, 5 μm, 3 μm, or 1 μm from a targeted position on the target surface. The accuracy of the position of the energy beam may be any value between the afore-mentioned values (e.g., from about 20 μm to about 1 μm, from about 20 μm to about 10 μm, or from about 10 μm to about 1 μm). For example, the requirement may be an accuracy of an optical element position with respect to a target angular position of the optical element. The angular requirement may be at most about 20 micro-radians (μRads), 15 μRads, 10 μRads, 5 μRads, 3 μRads, or 1 μRads, from a target angular position of the optical element. The accuracy of the angular position of the optical element may be any value between the afore-mentioned values (e.g., from about 20 μRads to about 1 μRads, from about 20 μRads to about 10 μRads, or from about 10 μRads to about 1 μRads).

The systems and/or apparatuses disclosed herein (e.g., an energy beam path selection element) may comprise one or more motors. The motors may comprise servomotors.

The servomotors may comprise actuated linear lead screw drive motors. The motors may comprise belt drive motors. The motors may comprise rotary encoders. The apparatuses and/or systems may comprise switches. The switches may be optical, capacitive, inductive and/or mechanical. The switches may comprise homing or limit switches. The motors may comprise actuators. The motors may comprise linear actuators. The motors may comprise belt driven actuators. The motors may comprise lead screw driven actuators. The motors may comprise a material such as copper, stainless steel, iron, rare-earth magnet (e.g., an element in the lanthanide series of the periodic chart). The motors may comprise any material disclosed herein. The actuators may comprise linear actuators. The systems and/or apparatuses disclosed herein may comprise one or more pistons. The systems and/or apparatuses disclosed herein may comprise one or more encoders (e.g., for positional feedback).

In some embodiments, a (e.g., residual) error remains in a position of at least one optical element in an energy beam selection path (e.g., following a movement of the at least one optical element). The residual error may comprise a variation in a (e.g., actual) position of an energy beam (e.g., as guided by a guidance system) from a requested position (e.g., at a target surface). The residual error may be a variation in a (e.g., actual) lateral and/or angular position of at least one optical element (e.g., in a guidance selection beam path and/or a guidance system) from a requested lateral and/or angular position. The residual error may comprise a vertical error (e.g., a difference between the actual vs. requested focal point of the energy beam with respect to the target surface). In some embodiments, a residual error in an energy beam position (e.g., at a target surface) and/or an optical element (e.g., angular) position may be compensated (e.g., corrected). Compensation may be effectuated by a (e.g., energy beam) calibration. At times, an energy beam calibration comprises formation of one or more (e.g., printed) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source. The calibration may be any calibration, e.g., as disclosed in PCT Patent Application serial number PCT/US19/14635, titled “CALIBRATION IN THREE-DIMENSIONAL PRINTING” that was filed on Jan. 22, 2019, which is incorporated herein by reference in its entirety.

In some embodiments, a calibration comprises a comparison of a commanded energy beam position (e.g., at the target surface) with an actual (e.g., measured) energy beam position at the target surface. A variation of the measured energy beam position from the commanded energy beam position (e.g., at the target surface) may be termed a “distortion.” A variation of the measured energy beam position of a first energy beam (e.g., as directed by a first guidance system) with respect to a measured energy beam position of a second energy beam (e.g., as directed by a first guidance system), compared to a commanded first energy beam position with respect to a commanded second energy beam position, may be termed an “overlay offset” or a “beam-to-beam overlay offset.” A calibrated energy beam position (e.g., regarding distortion and/or overlay offset, e.g., at a target surface) may comprise a measured position that may be at most about 350 microns (μm), 250 μm, 150 μm, 100 μm, 50 μm, 40 μm, 30 μm, 20 μm, 10 μm, 5 μm, or 2 μm from a commanded position of the energy beam. The measured position may be any value between the afore-mentioned values (e.g., from about 2 μm to about 350 μm, from about 150 μm to about 350 μm, or from about 2 μm to about 150 μm). A calibrated energy beam position may comprise a measured angular position of a guidance system and/or guidance beam selection path optical element (e.g., a mirror). The optical element may be an element of the optical system. The measured angular position may deviate from a requested angular position by (e.g., comprise an error of) at most about 40 micro-radians (μRads), 30 μRads, 20 μRads, 15 μRads, or 10 μRads from a commanded angular position of the guidance system element. A deviation of the measured angular position from a requested angular position may be any value between the afore-mentioned values (e.g., from about 10 μRads to about 50 μRads, from about 30 μRads to about 50 μRads, or from about 10 μRads to about 30 μRads). These angular position accuracies may correspond to position accuracies at the target surface (e.g., an X-Y position accuracy) from about 2 μm to about 350 μm, from about 150 μm to about 350 μm, or from about 2 μm to about 150 μm.

In some embodiments provided herein is a system-specific compensation of processing field distortion and beam-to-beam overlay offset. In some embodiments, a (e.g., energy beam position) calibration system is operatively coupled to (e.g., included in) the 3D printer, or is part of the 3D printer. The calibration system may comprise a guidance system (e.g., included in FIGS. 1, 120 and/or 114), sensor, detector, and/or one or more controllers. The sensor may be any sensor described herein. The detector may be any detector described herein. The calibration system may calibrate one or more components of the energy beam guidance system and/or the optical system (e.g., the irradiating energy). The calibration system may calibrate one or more characteristics of the irradiating energy (e.g., energy beam). For example, the calibration system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with a second energy beam position at the (e.g., target) surface, and/or (iv) the XY offset of the energy beam with respect to the (e.g., target) surface. The characteristics of the energy beam may be calibrated along a field of view of the optical system (e.g., and/or detector). The field of view (e.g., FIG. 1, 155) may be described as the maximum area of target surface that is covered (e.g., intersected, or accessed) by the optical system. A field of view may be (e.g., substantially) similar to a processing field of the energy beam. A field of view may be greater than a processing field of the energy beam. The field of view may be indirect (e.g., devoid of a direct view). The calibration may be utilized to calibrate one or more guidance systems of one or more energy beams, with respect to a target surface. The calibration may be any calibration, e.g., disclosed in PCT Patent Application serial number PCT/US19/14635 that is incorporated herein by reference in its entirety.

In some embodiments, an alignment marker arrangement is generated in a manner that allows detection of the positions and/or size of alignment markers of the arrangement by a detection system. The (e.g., alignment) marker may comprise a transformed material. The alignment markers may be disposed on the transformed material. The alignment marker may be 3D objects. The alignment marker arrangement may be located within the processing chamber (e.g., FIG. 1, 107, having the internal volume 126). The alignment marker arrangement may be generated within the enclosure of the 3D printer. For example, the alignment marker arrangement may be generated at or adjacent to the platform (e.g., FIG. 1, the base 123). The alignment marker arrangement may be generated at or adjacent to the target surface (e.g., FIG. 1, the exposed surface 140 of the material bed 104). The alignment marker arrangement may comprise transformed (and hard) material (e.g., FIG. 1, 106). The arrangement of the alignment marker may be located outside of, or at an edge of, the build module (e.g., in the processing chamber). The alignment marker arrangement may be located outside of the processing chamber (e.g., in the build module).

The alignment marker arrangement may comprise one or more alignment markers. The arrangement may be characterized by a coherence length in a direction of the arrangement. The marker may be characterized by an actual shape (e.g., as deviating from a requested shape). The alignment marker may comprise hardened (e.g., transformed) material, pre-transformed material, or a combination thereof. The alignment marker may be an area (e.g., at the target surface) comprising an embossing, depression, protrusion, line, and/or point. The alignment marker arrangement may comprise an alignment marker type having a (e.g., optically) detectable shape. The shape may be at least a two-dimensional shape. The shape may be a 3D shape. Detectable may include use of an illumination source (e.g., a light source, a projector, or an energy beam). The alignment marker arrangement may comprise two or more alignment marker portions. The alignment marker arrangement may include two different alignment marker portions. The alignment marker arrangement may include two different alignment marker types (e.g., each of which constituting an alignment marker portion). The two different marker types may differ in at least one detectable property. The detectable property may comprise a geometry, absorption spectrum, reflection spectrum (e.g., color), reflectivity, or diffusivity.

In some embodiments, an alignment marker is made up of a plurality of transformed material portions (e.g., plurality of 3D objects). In some embodiments, the alignment marker arrangement may include alignment markers located at different layers that form a material bed. At least one of the plurality of transformed material portions may be located at a different material layer than another of the plurality of transformed material portions. The layers may be layers of a material bed. For example, a first subset of alignment markers of the alignment marker arrangement may be located at a first layer and a second (e.g., remainder) subset of alignment markers of the alignment marker arrangement may be located at a second layer. The first layer may be (e.g., directly) below the second layer. The first layer may be (e.g., directly) above the second layer. The first and the second layer may be (e.g., directly) adjacent layers (e.g., sequential layers). At times, the first and the second layers may have one or more intervening layers. The one or more intervening layers may comprise pre-transformed material, transformed material, or a combination thereof. The alignment markers may be formed during the 3D printing, e.g., in locations of the target surface that are not occupied with the requested 3D object that is being built. The alignment markers may be formed in layers that are or that are not occupied by a requested 3D object.

At times, an alignment marker arrangement includes alignment markers that are formed from one or more partial alignment markers (e.g., “partial markers”). A partial marker may correspond to an alignment marker that is split to form scale-independent (e.g., partial) markers. For example, the partial markers may correlate to each other at least one point. A first set of partial alignment markers may be generated on a first layer, and a second (e.g., corresponding) set of partial alignment markers may be generated on a second layer. A combination of partial markers may be used to form a (e.g., complete) alignment marker in an alignment marker arrangement. A combination of the first set and the second set of partial alignment markers may form the (e.g., complete) alignment marker arrangement. A combination of partial markers may reduce a variability in the combined alignment marker. A reduction in variability can be with respect to a shape, position (e.g., on the target surface), and/or a dimension of the combined alignment marker, as compared to a (e.g., full) alignment marker generated in one processing step.

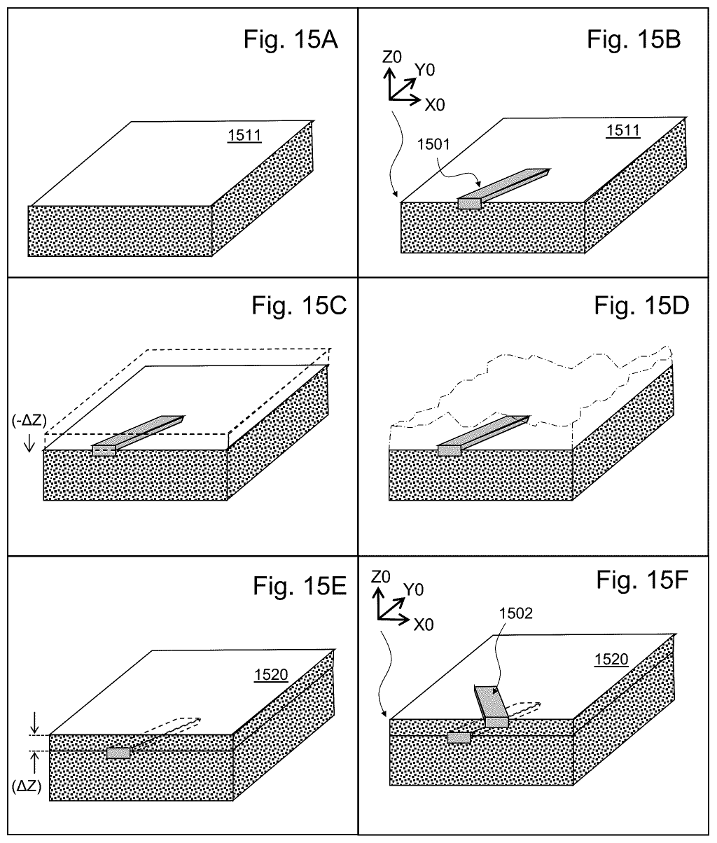

As an example, a (e.g., first) partial marker may comprise a forward-slash (“/”). For example, a (e.g., second) partial marker may form a back-slash (“ ”). The first and the second partial markers may be combined to form a (e.g., complete) alignment marker (e.g., an “X” marker). The partial markers may form an arrangement that is (e.g., substantially) similar in form to the alignment marker arrangement (e.g., placement on a grid, pitch, and/or coherence length). The combination of the first and the second (e.g., arrangements of the) partial markers may be performed via image processing. The combination of the first and the second (e.g., arrangements of the) partial markers may be performed via superposition of their two respective images. The (e.g., image processing) combination may be based on data captured by a detection system (e.g., a still image and/or a video). A (e.g., complete) alignment marker that is formed from a combination of partial markers may advantageously reduce variability in the alignment marker. A source of variability on a (e.g., completely) generated alignment marker may be one or more regions of the alignment marker that overlap. For example, a center portion of an alignment marker (e.g., an “X”) may be subject to two transformations (e.g., from overlapping build portions). For example: (a) a first layer of pre-transformed material (e.g., FIG. 15A, 1511) may be deposited above a platform; (b) a fist partial marker (e.g., or first set of partial markers) may be formed (e.g., FIG. 15B, 1501) using transformation of respective areas of the layer by a first energy beam; (c) a first image of the first marker is taken by the detector; (d) a second layer of pre-transformed material may be deposited above the first layer (e.g., FIG. 15D); (e) a second marker (e.g., or a second set of partial markers) may be formed using transformation of respective areas of the layer by a second energy beam (e.g., FIG. 15F); (f) a second image of the second marker is taken by the detector; (g) superposition of the first image and the second image is performed to form a third image; and (h) the image of the markers (formed using the superposition) is analyzed. At times, only one marker (e.g., set of markers) is generated; in that case, after operation (c) the image of the marker (or set thereof) is analyzed. The analysis may be with respect to a benchmark location (e.g., or grid of locations) and/or calibrated detector. In some embodiments, a guidance system causes an energy beam to generate corresponding partial alignment markers at the same XYZ position in the 3D printing system, but at different layers (e.g., FIG. 15, layer 1511 and layer 1520 shown as vertical cross sections) in the material bed (e.g., FIG. 15B, 1511 and FIG. 15F, 1520 shown as perspective views). The partial alignment markers may be generated at the same Z position as the platform on which the material bed is supported recedes between processing of subsequent layers (e.g., FIG. 15C, −ΔZ), and the prior layer of partial alignment markers may be (e.g., completely) covered (e.g., by using the layer dispensing system) (e.g., FIG. 15E). Therefore, separate layers (e.g., build layers) may be used for a (e.g., each) given set of partial alignment markers. In this manner the guidance system of the energy beam may be calibrated across its processing field using (e.g., combinations of) partial alignment markers formed at different material layers.

In some embodiments, the alignment marker arrangement forms a grid covering an area of interest (e.g., a processing field) of the energy beam. The area of interest may be the total available processing area (e.g., total surface of a material bed). The area of interest may be larger than the total available processing area. The area of interest may be smaller than the total available processing area. The area of intent may comprise an overlap between two or more energy beams.

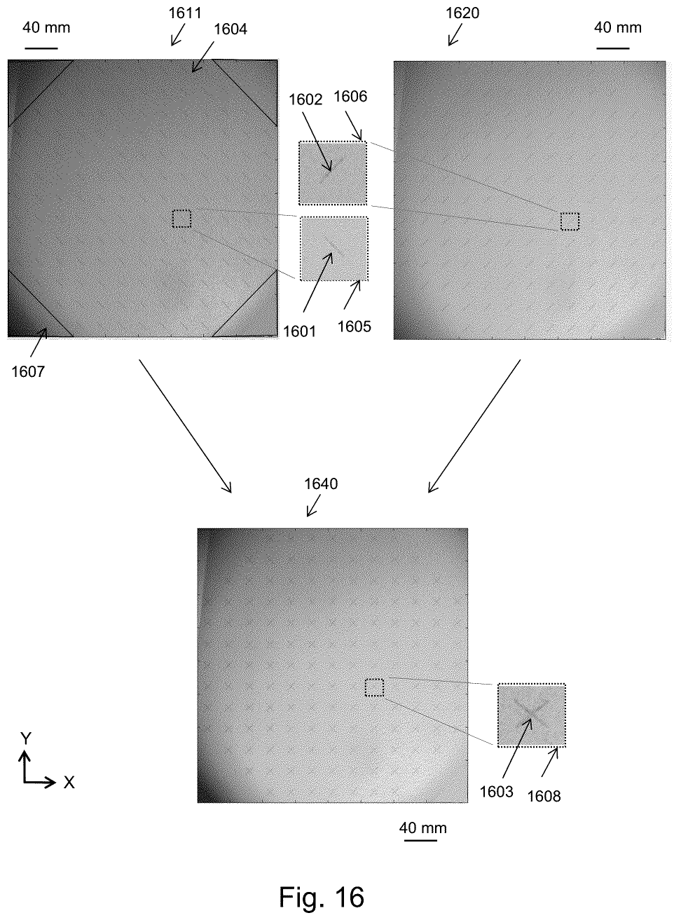

FIG. 16 shows an example of multiple partial alignment marker layers in an alignment marker arrangement. In the example of FIG. 16 a (e.g., first) layer 1611 includes an arrangement 1604 (e.g., grid) of partial alignment markers 1601. In the example of FIG. 16 a (e.g., second) layer 1620 includes an arrangement (e.g., grid) of partial alignment markers 1602. The example of FIG. 16 depicts the (e.g., complete) alignment marker arrangement 1640 formed by a (e.g., image processing, e.g., superposition) combination of the partial alignment marker arrangements. The example of FIG. 16 depicts the combined alignment marker 1603 as a combination of the partial markers 1601 and 1602. A combination of partial alignment markers to form a complete alignment marker may be based on corresponding regions of interest in the respective images. In the example of FIG. 16, a first region of interest 1605 and a second region of interest 1606 comprise their respective partial alignment markers (e.g., 1601 and 1602), which in region of interest 1608 in the combined image form the (e.g., complete) alignment marker 1603. A region of interest may be pre-determined (e.g., based on a coarse (rough) correction). The partial alignment marker images may be combined into one image using an image overlay. The image overlay may (i) assume that the detection system that captured the images did not move between image captures or (ii) take into account a movement of the detection system (e.g., by a known amount).

At times, the energy beam position calibration includes image processing. Image processing may include comparing an image of the alignment marker arrangement against a reference, to determine any distortion in the energy beam (e.g., guidance system) positioning (e.g., across its processing field). The alignment marker arrangement may comprise alignment markers formed completely (e.g., in one step by the energy beam). The alignment marker arrangement may comprise combined (e.g., partial) alignment markers (e.g., FIG. 16, 1640). The image processing may include recognition of alignment marker locations. Recognition of alignment marker locations may be performed on a one-by-one basis (e.g., per-alignment marker). Recognition of alignment marker positions may be performed image-wide (e.g., all alignment markers at once). Recognition of alignment marker positions may be performed on subsets of the image (e.g., for groups of alignment markers).

In some embodiments, a 3D printing system includes an image processor operatively coupled with the detection system. The image processor may be operatively coupled or included in a controller. The controller and/or processor may be in coupled with (e.g., in communication with) a guidance system for directing an energy beam. An image processor may perform image processing to determine a deviation between a given (e.g., measured) alignment marker position and its corresponding (e.g., commanded) reference position (e.g., from the reference image and/or image data). The deviation may be determined based on a correlation (e.g., a normalized cross correlation) between the measured and the reference positions. A cross correlation may be to a reference shape (e.g., a generated “X” to a reference “X”). The deviation may be determined (i) using a transformation of the image data translating lines of the image, into points, and (ii) recognizing peaks (e.g., portions of overlap) (e.g., a Hough transformation, and/or Radon transformation). The deviation may be determined by (a) a transformation of the image into its constituent frequency components (e.g., Fourier Transform, Fast Fourier Transform, and/or Discrete Fourier Transform) and (b) comparing the alignment marker arrangement image with the reference image. The deviation may include blob detection and a combination to determine the alignment marker shape. The image processing may comprise finding a center of gravity (CoG) of a given alignment marker (e.g., considering the alignment marker as a single blob), and determining the (e.g., measured) position of the given alignment marker while considering the CoG. A CoG may include identifying a center (e.g., peak) pixel and including a number (e.g., 4) of pixels located in the vicinity of the peak pixel.

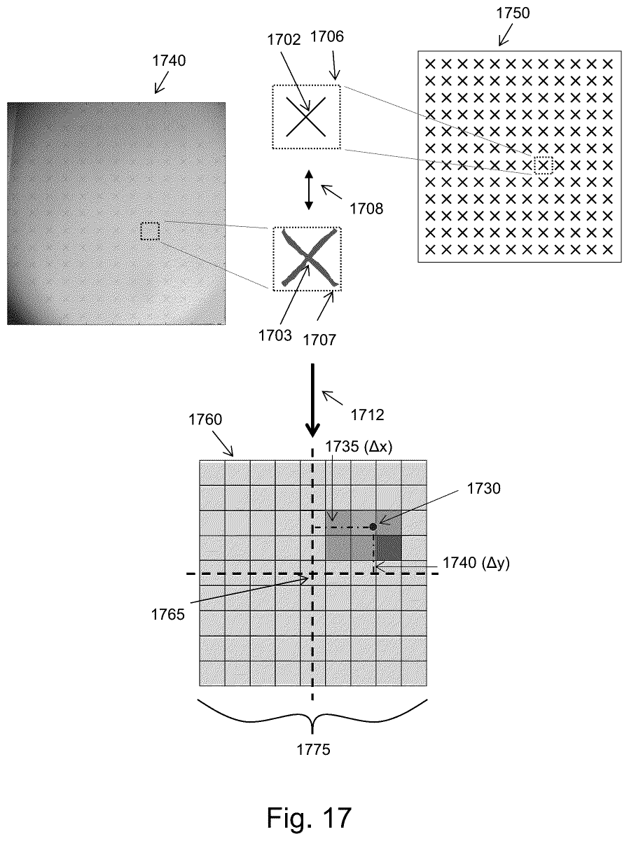

FIG. 17 depicts an example of the energy beam position calibration including image processing. In the example of FIG. 17 an (e.g., measured) alignment marker arrangement 1740 is compared with a reference image 1750. FIG. 17 depicts that a region of interest 1707 includes an alignment marker 1703, which is compared 1708 with a reference marker 1702 in a region of interest 1706 of the reference image. FIG. 17 depicts that a result 1712 of the region of interest comparison is given by array 1760. The comparison may result in locating a region (e.g., a pixel or a sub-pixel) of best correlation between the (e.g., generated) alignment marker and the reference marker. The region may correspond with a location on the target surface (e.g., a location in the processing field of the energy beam). In the example of FIG. 17, the array 1760 includes an array having a size 1775 (e.g., a 9-by-9 pixel array), which is centered around an expected (e.g., reference) position 1765. In the example of FIG. 17 the position of best correlation between the measured alignment marker position and the reference marker position is given by 1730 (including x-axis deviation 1735 and y-axis deviation 1740). As shown in the example of FIG. 17, the position 1730 (which is not centered on an integer pixel) is determined using sub-pixel registration (e.g., CoG) analysis, as depicted by shading of the pixels. In the example of FIG. 17, darker shading corresponds to a higher correlation of the alignment marker with the reference marker. In the example of FIG. 17, a peak correlation pixel is represented by the darkest pixel, with relatively lower correlation values represented by brighter (e.g., less dark) surrounding pixels. Correction (e.g. compensation) of the energy beam positioning at the given location of the alignment marker (e.g., in the processing field) may be determined, based on the measured position (e.g., FIG. 17, 1730). For example, the compensation may include correcting the positioning based on the values of the deviated location (e.g., the values of FIG. 17, 1735, 1740).

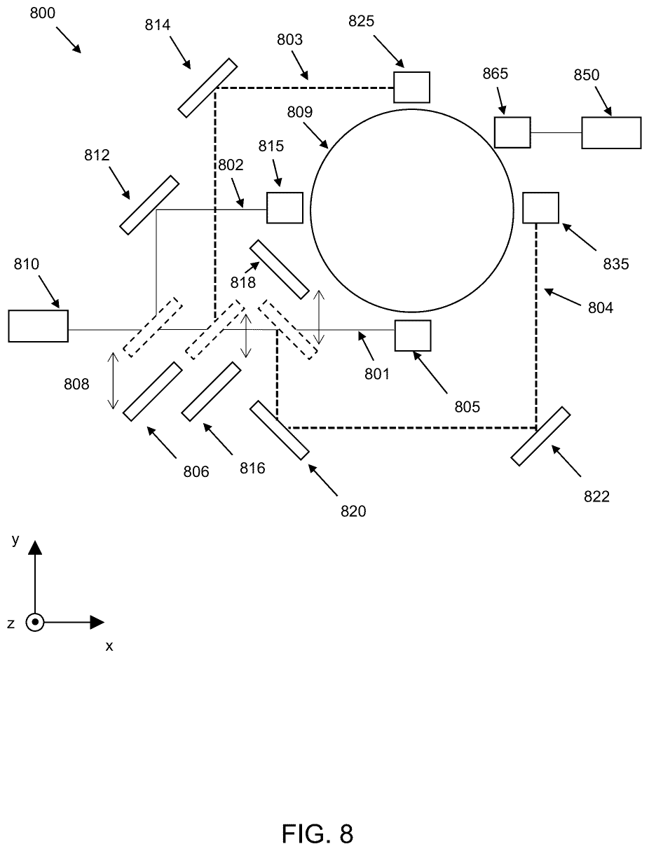

In some embodiments, a system comprising ‘H’ energy sources comprises a respective ‘n’ guidance systems, wherein H and n are positive integers. In some embodiments, for each energy source of a plurality of energy sources (e.g., H), a (e.g., respective, one) guidance system is operatively coupled therewith (e.g., H=n). In some embodiments, at least two guidance systems are operatively coupled to at least one energy source of a plurality of energy sources (e.g., n>H). In some embodiments, each energy source of a plurality of energy sources is operatively coupled with ‘i’ guidance systems (e.g., where i is a subset of n). In some embodiments, a first energy source is operatively coupled with a (e.g., first) number of guidance systems (e.g., FIG. 8, energy source 810 coupled with guidance systems 805, 815, 825 and 835; i₁=4), and a second energy source is operatively coupled with a (e.g., second) number of guidance systems (e.g., FIG. 8, energy source 850 coupled with guidance system 865; i₂=1, i₂≠i₁). The number of guidance systems i that are operatively coupled with a (e.g., given) energy source can be at least about 1, 2, 5, 8, 10, 15, 16, 20, 32, or 40. In some embodiments, the number of guidance systems i operatively coupled to an energy source is a power of 2 of the number of the energy sources (e.g., at least 1, 2, 4, 8, 16 or 32; (e.g., 2^{k}*H, where ‘*’ denotes the multiplication mathematical operation and ‘k’ is a positive integer). The number of guidance systems that are operatively coupled to a given energy source may be between any of the afore-mentioned values (e.g., from 1 to 40, from 1 to 20, or from 20 to 40).

FIG. 8 depicts an example of an arrangement 800 of a plurality of guidance systems and a (e.g., target) surface 809. In the example of FIG. 8, a (e.g., first) energy source 810 is configured to irradiate energy (e.g., an energy beam) along a (e.g., first) energy beam path 801 to a guidance system 805; along a (e.g., second) energy beam path 802 to a guidance system 815; along a (e.g., third) energy beam path 803 to a guidance system 825; and along an (e.g., fourth) energy beam path 804 to a guidance system 835. The example FIG. 8 shows an (e.g., second) energy source 850 that is configured to irradiate energy (e.g., an energy beam) along a (e.g., fifth) energy beam path 811 to a guidance system 865. In some embodiments, a plurality of energy beam paths may be selected (e.g., individually) from one energy beam path (e.g., beam paths 802, 803, and/or 804, from beam path 801). One or more (e.g., movable and/or fixed) optical elements may be configured to adjust the energy beam path. The controller may control the positions of the optical elements, e.g., to adjust the energy beam path. For example, the controller may move at least one movable optical element into an optical path. In the example of FIG. 8, the energy beam path 802 comprises a movement into the energy beam path 801 by an optical element 806 (e.g., along arrow 808), and a (e.g., fixed) optical element 812 that directs the energy beam onto the guidance system 815. In the example of FIG. 8, the energy beam path 803 comprises a movement into the energy beam path 801 by an optical element 816, and a (e.g., fixed) optical element 814 that directs the energy beam onto the guidance system 825. In the example of FIG. 8, the energy beam path 804 comprises a movement into the energy beam path 801 by an optical element 818, and (e.g., fixed) optical elements 820 and 822 that direct the energy beam onto the guidance system 835.

In some embodiments, at least two guidance systems of a 3D printing system are disposed at different heights (e.g., along a z-axis in a Cartesian coordinate space) with respect to one another. At least two lateral paths of the optical setup (e.g., from the energy source to the guidance system) may be disposed at different heights (e.g., different vertical positions). For example, a (e.g., first) guidance system may be positioned above a (e.g., second) guidance system. For example, a (e.g., first) energy source may be positioned above a (e.g., second) energy source. Above may be with respect to a global vector as disclosed herein. The at least two guidance systems may be operatively coupled with an energy source. In some embodiments, the at least two guidance systems are operatively coupled with a same energy source. In some embodiments, the at least two guidance systems are operatively coupled with different energy sources. In some embodiments, the at least two guidance systems are configured to direct at least two energy beams within a same processing field. In some embodiments, the at least two guidance systems are configured to direct at least two energy beams within different processing fields.

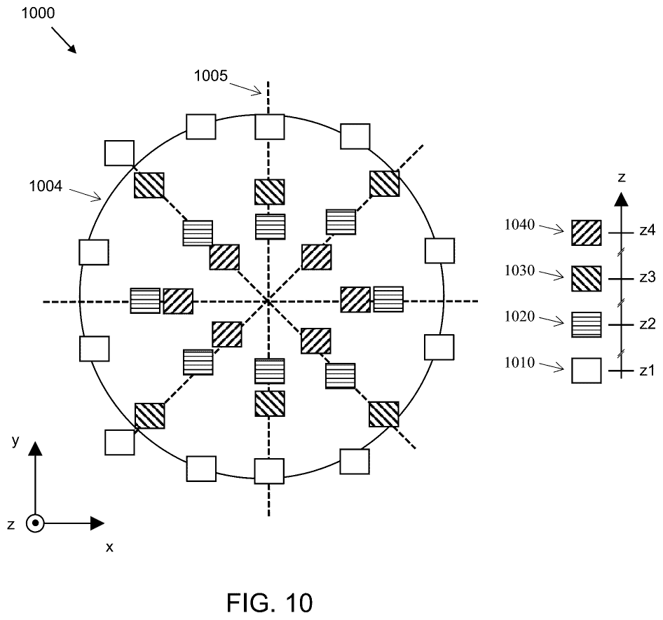

FIG. 10 depicts an example of an arrangement 1000 of a plurality of guidance systems with respect to a (e.g., target) surface 1004. In the example of FIG. 10, the target surface comprises a plurality of processing regions that are demarcated with respect to a plurality of lines (e.g., FIG. 10, 1005). In some embodiments, an arrangement of a plurality of guidance system comprises groups (e.g., at least two) of the guidance systems. The at least two guidance systems may be configured such that processing fields of the group are within a (e.g., one) processing region of the plurality of processing regions. In some embodiments, a group of guidance systems is arranged such that an (e.g., total) area of a processing region is at least partially (e.g., fully) covered by the processing fields of the group. In some embodiments, the at least two guidance systems of a group are at a same height (e.g., z-axis value of a Cartesian coordinate system). In some embodiments, the groups (e.g., each group) of guidance systems comprise a different height. In some embodiments, the at least two guidance systems of a group comprise a different height. In the example of FIG. 10, guidance systems are arranged about processing regions of the target surface in groups that comprise four heights z1, z2, z3, and z4 (e.g., FIG. 10, heights 1010, 1020, 1030, and 1040 according to fill pattern). In some embodiments, a height of a guidance system may be configured considering a position of the guidance system with respect to the target surface (e.g., perimeter). For example, a height may be based on a distance of a guidance system from a (e.g., radial) center of a target surface. For example, a height of a (e.g., first) guidance system that is near a center of a target surface may be higher than a height of a (e.g., second) guidance system that is distal from the center of the target surface (e.g., with respect to the position of the first guidance system). The energy source that is operatively coupled to the guidance system may be in the same height as the guidance system, or at a different (e.g., higher or lower) height. In some embodiments, the position of at least one of the energy source and/or guidance system is fixed at least during the printing. In some embodiments, the position of at least one of the energy source and/or guidance system translates at least during the printing (e.g., during a time at which the energy beam is not transforming, e.g., during dispensing of the pre-transformed material).

In some embodiments, at least one guidance system (e.g., at least one initiation point) has a position that is movable with respect to (e.g., a perimeter of) the target surface (e.g., during printing). During printing may comprise a time at which the energy beam that is guided by this guidance system, is not transforming and/or otherwise operational. For example, the direction from which an energy beam impinges onto a surface may be controlled by moving a position of at least one guidance system with respect to the target surface. The location, area, and/or shape of the processing field may change considering the movement of the guidance system. One or more characteristics of the energy beam may be adjusted considering the movement of the guidance system. For example, a focus (e.g., footprint of the energy beam on the target surface), an energy beam cross-section (e.g., FLS), and/or an energy density of the energy beam may be adjusted considering the movement of the guidance system. The movement may be a translation that is vertical (e.g., along a z-axis in a Cartesian coordinate space), horizontal (e.g., along an x-y plane in a Cartesian coordinate space), or any combination thereof. The movement may be a rotation (e.g., of an orientation of the guidance system). The movement of the guidance system may be along a trajectory. The trajectory may comprise a line, a curve, an ellipse, a circle, a parabola, or any combination thereof. An energy beam path from an energy source to a (e.g., movable) guidance system that is operatively coupled therewith, may be (e.g., controllably) adjustable (e.g., during the printing), considering the movement of the guidance system along its trajectory.

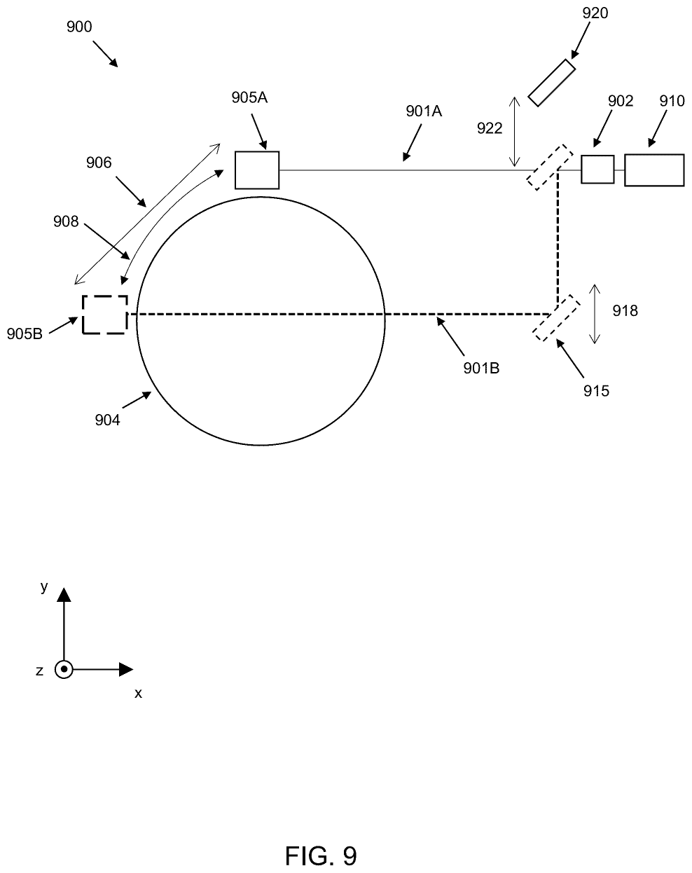

FIG. 9 depicts an example of an arrangement 900 of a (e.g., movable) guidance system about a (e.g., target) surface 904. In the example of FIG. 9, an energy source 910 is configured to irradiate an energy beam to an optional (e.g., variable) focus mechanism 902, and onto a guidance system 905A, along a first energy beam path 901A. In some embodiments, an energy beam path that is devoid of an optical element between a (e.g., variable) focus mechanism and a guidance system may be a “default” energy beam path (e.g., FIG. 9, 901A). The position of a guidance system of the default energy beam path may be a “default position” (e.g., 905A). In some embodiments, the energy beam path may vary considering the position of a guidance system. The variation in the energy beam path may be a variation in an energy beam path length, direction, or any combination thereof. In the example shown in FIG. 9, a (e.g., second) energy beam path 901B comprises a variation in a length and direction, with respect to the energy beam path 901A. The variation in the energy beam path may be controlled (e.g., by at least one controller). The control may be manual, automatic, or any combination thereof. The control may be by movement of at least one optical element. The variation in the energy beam path (e.g., by controlled optical element movement) may be continuous, discrete (e.g., in steps), or any combination thereof. In some embodiments, the (e.g., re-direction) optical element may re-direct the incident energy beam (e.g., directly) onto a guidance system (e.g., at a location different than the default location). For example, at least one optical element may rotate in coordination with (e.g., to track) a position of a guidance system. In some embodiments, the (e.g., re-direction) optical element may re-direct the incident energy beam onto at least one (e.g., additional) optical element, and then onto a guidance system (e.g., at a location different than the default location). The position of the guidance system may be adjusted with respect to a (e.g., target) surface according to a trajectory (e.g., FIG. 9, 906 or 908). In the example of FIG. 9, an energy beam path 901B comprise a re-direction of the energy beam out of the (e.g., default) energy beam path 901A by a movement of the optical element 920 (e.g., along arrow 922); an (e.g., movable) optical element 915 is configured to direct the (e.g., redirected) energy beam onto the guidance system 905B (e.g., at a second position). In some embodiments, at least one optical element is configured to move by considering a position of the guidance system (e.g., with respect to the target surface). The movement of the at least one optical element and a guidance system may be disconnected. The movement of the at least one optical element and a guidance system may be coordinated (e.g., synchronously and/or asynchronously). For example, a movement of the at least one optical element (e.g., FIG. 9, 915) may be coupled with a movement of a guidance system (e.g., FIG. 9, 905B). The movement of the at least one optical element may be controlled to maintain impingement of an energy beam onto a guidance system. In the example shown in FIG. 9, the optical element 915 moves along the y-axis (e.g., along arrow 918), in concert with the (e.g., y-axis) position of the guidance system 905B. Maintaining an energy beam impingement on a (e.g., movable) guidance system may comprise a movement of at least one optical element.

Maintaining an energy beam impingement on a (e.g., movable) guidance system may comprise a coordinated movement of at least two optical elements, or coordination of at least one optical element and of the energy source. In the example shown in FIG. 9, a movement of the optical element 920 into the energy beam path 901A is coordinated with a (e.g., y-axis) movement of the optical element 915 (e.g., to maintain energy beam impingement on the guidance system 905B).

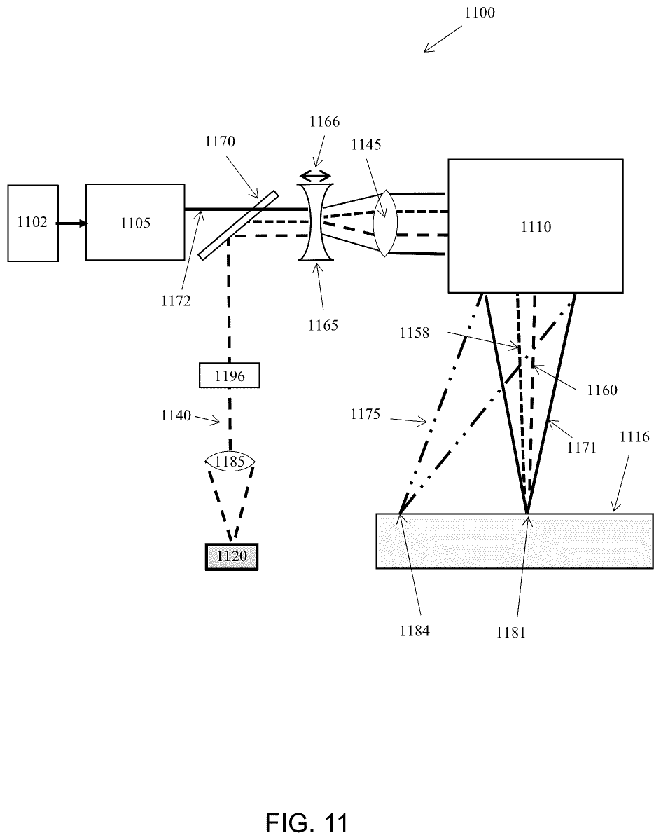

In some embodiments, the 3D printer comprises a detection system. The detection system may detect one or more characteristics and/or features of the energy beam (e.g., detecting an energy beam footprint at the target surface). In some embodiments, the detection system detects one or more characteristics and/or features caused by the energy beam (e.g., on the target surface). For example, a detection system may detect (i) a position at which the energy beam contacts a surface (e.g., the target surface), (ii) a shape of the footprint of the energy beam at the (e.g., target) surface, (iii) an XY offset of a (e.g., first) energy beam footprint position at the (e.g., target) surface with a (e.g., second) energy beam footprint position at the (e.g., target) surface, and/or (iv) an XY offset of an energy beam footprint with respect to an intended position of the footprint at the (e.g., target) surface. In some embodiments, the detection system detects one or more characteristics and/or features of an electromagnetic radiation. In some embodiments, the detection system detects one or more characteristics and/or features of a thermal radiation. FIG. 11 shows an example of a (e.g., optical) detection system (e.g., FIG. 11, 1100) as part of a 3D printer. The detection system may be operatively coupled to at least one component of the processing chamber. The at least one component of the processing chamber may comprise the energy beam, the controller, the target surface, or the platform. The detection system may be operatively coupled to the build module. The detection system may be a part of or separate from the optical system. The detection system may be operatively coupled to an energy source (e.g., FIG. 11, 1102). The energy source may be any energy source disclosed herein. The energy source may irradiate with a transforming energy (e.g., beam). The transforming energy may heat (e.g., and transform) a material at the target surface, and subsequently emit an electromagnetic radiation of a different wavelength (e.g., a thermal radiation, e.g., a black body radiation) and/or be reflected (e.g., away from the material) (e.g., FIGS. 11, 1158 and/or 1160). The different wavelength may be a larger wavelength as compared to the wavelength of the irradiating energy by the energy source. For example, a laser may emit laser energy towards the target surface at a position, which irradiation will cause the irradiated position to heat (e.g., and melt). The laser irradiation may be reflected from the target surface (e.g., exposed surface of a material bed). The heating of the position at the target surface may cause emittance of heat radiation. The heat radiation may have a larger wavelength as compared to the laser irradiation wavelength. At times, the irradiating energy may illuminate the enclosure environment. At times, the target surface may be illuminated by the energy beam (e.g., direct or reflected) or the produced thermal radiation. At times, the enclosure environment may include a separate illumination source (e.g., a light-emitting diode (LED)). The back reflected irradiating energy, and/or the electromagnetic radiation of a different wavelength may be referred to herein as “the returned energy beams.” The returned energy beams may be detected via one or more detectors. The detection may be performed in real-time (e.g., during at least a portion of the 3D printing). For example, the real-time detection may be during the transformation of the pre-transformed material (e.g., using the energy beam). The irradiating energy may be focused on a position at the target surface. The returned energy beams may be focused on their respective detectors. In some embodiments, the irradiating energy is focused on a position at the target surface as at least a portion of the returned energy beams are focused on at least one of their respective detectors. The returned energy beam can provide energy at a peak wavelength of at least about 100 nanometer (nm), 400 nm, 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm 3000 nm, or 3500 nm. The returned energy beam can provide energy at a peak wavelength between any of the afore-mentioned peak wavelength values (e.g., from about 100 nm to about 3500 nm, from about 1000 nm to about 1500 nm, from about 1700 nm to about 2600 nm, or from about 1000 nm to about 1100 nm). In some embodiments, the detection system may comprise aberration—correcting optics (e.g., spherical aberration correcting optics, chromatic aberration correcting optics, achromatic optics, apochromatic optics, superachromatic optics, f-theta achromatic optics, or any combinations thereof). In some embodiments, the aberration-correcting optics is devoid of an f-theta lens. In some embodiments, the aberration corrective optics is devoid of f-theta achromatic optics. The detector of the returned energy beam may detect the energy at the above mentioned peak wavelengths. The peak wavelength may be a wavelength at full width at half maximal of the energy profile of the returned energy beam.

In some embodiments, a detector is arranged to follow the processing location of the directed energy beam to the target material. For example, the detector (e.g., a field of view thereof) may move along with a point at which the energy beam is incident upon the target material. The processing location may comprise (i) a footprint of the energy beam on a target surface, (ii) a transformed portion that comprises the target surface, or (iii) a heated portion that comprises the target surface. In an embodiment, an optical system includes a detector (e.g., FIG. 11, 1120) operable to detect one or more characteristics of the target surface (e.g., comprising a material). For example, the detector may be operable to detect one or more characteristics of the target surface (or a portion thereof). The detector can be operated continuously or controlled to operate at a selected time (e.g., selected time intervals). The detector may operate before, during, and/or after processing of the target material (at the target surface). The detector can be formed with at least one radiation-sensitive detector. The detector can be adapted to detect a selected wavelength (e.g., wavelength span) of radiation. The radiation may be an electromagnetic radiation. The wavelength of the electromagnetic radiation may comprise a wavelength in the ultraviolet band, visible band, or infrared (IR) band. According to some embodiments, different radiation detectors detect different wavelengths, respectively. For example, a near-IR wavelength for a first radiation detector, and an IR wavelength for a second radiation detector.

FIG. 11 shows an example of a (e.g., optical) detection system 1100 that may be operatively coupled to a platform. The platform may be a part of a (e.g., 3D) printing system. In the example of FIG. 11 an energy source 1102 provides an energy beam to a collimator 1105, and the collimated energy beam 1172 is incident on a beam splitter 1170. In the example of FIG. 11, the energy beam passes through optical elements 1165 (e.g., a diverging lens, capable of translating 1166) and 1145 (e.g., a converging lens) to a scanner 1110 (e.g., any scanner described herein). In some embodiments, one or more optical elements (e.g., lenses, FIG. 11, 1185) may be placed preceding the one or more detectors, and along the path of the returning energy beam. Optionally, there may be one or more filter elements (e.g., 1196) placed before each of the optical element. The optical element may maintain the focus of the detector energy beam on each detector (e.g., simultaneously with maintaining the focus of the transforming energy beam on the target surface). An arrangement of the one or more lenses may comprise a variable optical axis focusing arrangement (e.g., variable focus mechanism). While not depicted in the example of FIG. 11, it should be appreciated that more than one or more optical elements can be present between the optical element (e.g., 1165) and the scanner (e.g., 1110) (e.g., a second converging lens). The scanner (e.g., 1110) can be operable to direct an energy beam onto a material, for example, via optical paths (e.g., 1171 and 1175) toward target positions (e.g., 1181 and 1184, respectively) of a target surface (e.g., 1116). Irradiation of the target surface can generate characteristic radiation (e.g., electromagnetic radiation) at or near the targeted position of the target material. Near the targeted position may be at most 2, 3, 4, 5, 6, 7, or 10 FLS of the energy beam (e.g., cross sectional diameter of the energy beam, or diameters of the footprint of the energy beam on the target surface).

At times, the energy beam is directed onto a specified area of at least a portion of the target surface for a specified time period. The material in or on the target surface (e.g., powder material such as in a top surface of a powder bed) can absorb the energy from the energy beam and, and as a result, a localized region of the material can increase in temperature. In some instances, one, two, or more 3D objects are generated in a material bed (e.g., a single material bed; the same material bed). The plurality of 3D objects may be generated in the material bed simultaneously or sequentially. At least two 3D objects may be generated side by side. At least two 3D objects may be generated one on top of the other. At least two 3D objects generated in the material bed may have a gap between them (e.g., gap filled with pre-transformed material). At least two 3D objects generated in the material bed may contact (e.g., not connect to) each other. In some embodiments, the 3D objects may be independently built one above the other. The generation of a multiplicity of 3D objects in the material bed may allow continuous creation of 3D objects.

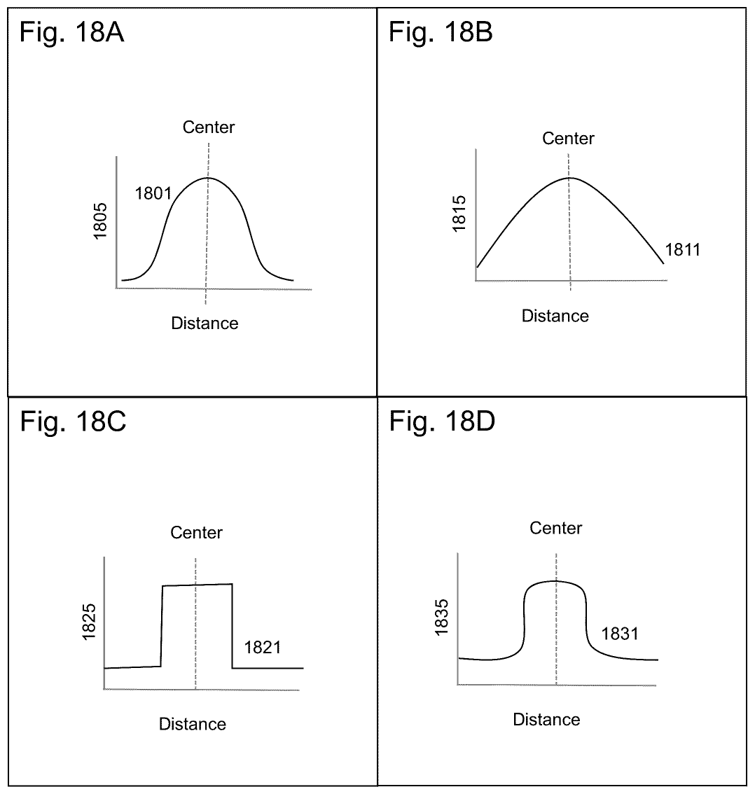

The energy profile of the energy beam may represent the spatial intensity profile of the energy beam at a particular plane transverse to the beam propagation path. FIGS. 18A-18D show examples of energy beam profiles as a function of distance (e.g., energy as a function of distance from the center of the energy beam). The energy beam profile may be represented as the energy at a target surface (e.g., power density at the exposed surface) of the energy beam plotted as a function of a distance, e.g., along its cross section. The energy beam profile may be represented as the energy at a target surface (e.g., temperature at the exposed surface) excreted by the energy beam plotted as a function of a distance, e.g., along its cross section. The energy beam profile may be substantially uniform (e.g., homogenous), or non-uniform.

The energy beam has an energy profile. The energy beam may have any of the energy beam profiles in FIGS. 18A-18D. The energy beam profile may be (e.g., substantially) uniform. The energy beam profile may comprise a (e.g., substantially) uniform section. The energy beam profile may deviate from uniformity. The energy beam profile may be non-uniform. The energy beam profile may have a shape that facilitates (e.g., substantially) uniform heating of the tile (e.g., substantially all points within the melt pool (e.g., including its rim)). The energy beam profile may have a shape that facilitates (e.g., substantially) uniform temperature variation within a melt pool (e.g., at substantially all points within a melt pool (e.g., including its rim)). The energy beam profile may have a shape that facilitates substantially uniform phase of the melt pool (e.g., substantially all points in the melt pool (e.g., including its rim)). The phase can be liquid or solid. Substantially uniform may be substantially similar, even, homogenous, invariable, consistent, and/or equal. At times, the energy beam profile may have a shape that facilitates non-uniform temperature variation within a melt pool. For example, the rims of the melt pool may be of a lower temperature than its interior. The energy beam profile may heat (e.g., and not transform) the vicinity of a melt pool (e.g., outside the rim of the melt pool). At times, the energy beam may comprise a heat profile that may transform portions of an irradiated spot (e.g., towards the center of the irradiated spot, e.g., to form a melt pool), and may not be sufficient to transform other portions of the irradiated spot (e.g., towards the edges of the spot)

In an example, the energy flux profile of the energy beam comprises a square shaped beam. In some instances, the energy beam may deviate from a square shaped beam. In some examples, the energy beam includes a Gaussian shaped beam (e.g., FIG. 18A, 1801). In some examples, the energy beam excludes a Gaussian shaped beam. The shape of the energy beam profile may be the energy profile of the energy beam with respect to a distance, e.g., from its center. The “center” in FIGS. 18A-18D can be a center of the energy beam irradiation spot at the target surface (e.g., energy footprint on the target surface, or cross section of the energy beam on the target surface) and/or center of a melt pool (e.g., of a horizontal cross section of a melt pool residing on the target surface) formed by irradiation of the energy beam. The energy beam profile in FIG. 18A-18C can be depicted as a distance as a function of energy (e.g., 1805, 1815, 1825, or 1835). The energy may be a power density of the energy beam at the target surface, or a temperature at the target surface. The energy beam profile may comprise one or more planar sections. FIG. 18C, 1821 shows an example of a top hat energy profile having planar sections. The energy beam profile may comprise of a gradually increasing and/or decreasing section. FIG. 18B, 1811 shows an example of an energy profile comprising a gradually increasing section, and a gradually decreasing section. The energy beam profile may comprise an (e.g., abruptly) increasing and/or decreasing sections. FIG. 18D, 1831 shows an example of an energy profile comprising an abruptly increasing section and an abruptly decreasing section. The energy beam profile may comprise a section wherein the energy beam profile deviates from planarity. The energy profile of the energy beam may comprise a section of fluctuating energy (e.g., power) profile. The fluctuation may deviate from an average planar energy (e.g., power) profile of the energy beam profile. The fluctuating section deviates from the average flat (e.g., planar) power profile. The average planar power profile may be referred to using the average energy (e.g., power density at the target surface) from an average baseline, by a +/− distance of “h” of energy beam profile.

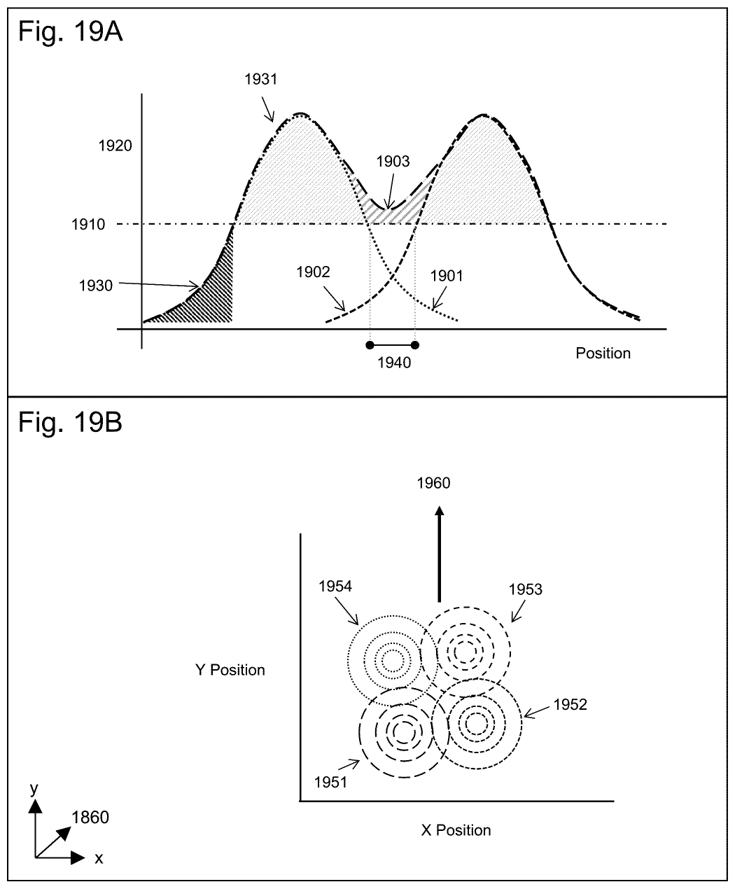

In some embodiments, the energy beam irradiates a target surface to form an irradiation spot. The irradiation spot may have an energy profile. The energy profile may be non-homogenous. FIG. 19A shown an example of an energy beam profile 1901 that is non-homogenous (e.g. a gaussian beam), and another example of an energy beam profile 1902 that is non-homogenous (e.g., another gaussian beam). The energy beam distance may be measured relative to a position on a target surface. Numeral 1920 of FIG. 19A shows an example of energy axis (that is related to the beam spot at the target surface). The energy in the energy axis may be represented as power density, temperature, and/or emitted energy (e.g., from the target surface). The energy profile of the energy beam may comprise (i) portions that have sufficient energy to transform a pre-transformed material to a transformed material, (e.g., at the target surface), and (ii) portions that have insufficient energy to transform a pre-transformed material to a transformed material (e.g., at the target surface). FIG. 19A shows an example of an energy threshold 1910 for the transformation (e.g., temperature threshold, power density threshold, emitted energy threshold). Below the threshold, the energy beam does not have sufficient energy to transform, does not exert sufficient energy to transform, does not elevate the target surface to sufficient temperature to transform, and/or does not otherwise cause transformation, of the pre-transformed material to the transformed material (e.g., does not have sufficient energy to sinter, or melt powder). The non-transforming portion of the energy beam profiles may be referred to herein as “residual energy beam profile”. At or above the threshold, the energy beam has sufficient energy to transform, exerts sufficient energy to transform, elevate the target surface to sufficient temperature to transform, and/or otherwise causes transformation, of the pre-transformed material to the transformed material. FIG. 19A shows an example of an energy beam profile 1930 where the energy beam does not have sufficient energy to transform the pre-transformed material to a transformed material (e.g., includes energy values below the energy threshold 1910). For example, portion numerated 1930 shows an example of a portion of the energy beam profile that is a residual energy beam profile portion. FIG. 19A shows an example of an energy beam profile 1931 where the energy beam does have sufficient energy to transform the pre-transformed material to a transformed material (e.g., includes energy values at or above the energy threshold 1910).

In some embodiments, a plurality of energy beams are align to superimpose such that they take advantage of one or more portions of the energy profile that by themselves are insufficient to transform the pre-transformed material to a transformed material, but together (e.g., as superimposed energy beam profiles) have sufficient energy to transform the pre-transformed material to a transformed material. The superimposed energy beam profile portion has an energy at or above the energy threshold (e.g., 1910). FIG. 19A shows an example of an energy beam 1901 and another energy beam 1902 that are align such that a portion of their residual energy beam profiles overlap (e.g., are superimposed) in a manner such that their cumulative energy is sufficient to transform the pre-transformed material to a transformed material. Section 1903 in FIG. 19A shows an example in which the cumulative energy of the two beams is elevated to a value at or above the threshold 1910 for transformation of the pre-transformed material to a transformed material. Such alignment may allow (1) using greater spacing between energy beam trajectories (e.g., hatch lines), (2) lower an amount of energy required for building a 3D object, and/or (3) saving time (e.g., printing quicker) the 3D object, as compared to using the plurality of energy beam without taking advantage of the residual energy beam profiles (e.g., when each energy beam generates a different portion of the 3D object, regardless of their simultaneous operation). Alignment of the plurality of energy beams to take advantage of the residual energy beam profile during printing, may use energy (e.g., heat) that dissipates and is insufficient to transform the pre-transformed material to a transformed material. Alignment of the plurality of energy beam to use the residual energy beam profile portion(s) during printing may increase a printing throughput of the 3D object. The plurality of energy beam may be at least 2, 3, 4, 5, 6, 10, 20, 50, or 100 energy beams (or any other number of energy beams, e.g., as disclosed herein). Any number of energy beams may be superimposed in a manner that allows usage of the residual energy beam profile portion(s). FIG. 19B shows an example of contour plots of four energy beam provides 1951, 1952, 1953, and 1954 depicted on an exposed surface. The distance (e.g., X or Y distance) is relative to a position on the target surface; and arrow 1960 designates a direction of propagation along a translation path (e.g., to form a layer of the 3D object). Alignment of plurality of energy beams may utilize the (high) accuracy of calibrated energy beam impingement on target surface (e.g., that is distortion-compensated). Such spatial alignment and time synchronization of the energy beams may increase the transformation area at a given time, as the energy beam may be disposed further apart from each other (e.g., by a distance 1940). A plurality of energy beams may form a portion of a 3D object (e.g., a portion of a layer thereof). One combination of energy beams be consistent through formation of at least a portion of a layer (e.g., the entire layer or the entire 3D object). At times, the combination (e.g., selection) of the energy beams may change during formation of at least a portion of the 3D object (e.g., a layer or the entire 3D object). The selection of the energy beam combination may be made manual and/or in an automated fashion (e.g., using a controller). The selection of the energy beam for the combination may consider (i) an angle between the energy beam and the target surface, (ii) a distance of the position to be irradiated, (iii) a path length of the energy beam in the processing chamber, (iv) an energy density profile of the energy beam, (v) a power of the energy source generating the energy beam, and/or (vi) one or more characteristics of an optical system (e.g., scanner) that directs the energy beam across the target surface. The one or more characteristics of the optical system may comprise: response time, optical components, or optical setup.

A pre-transformed material may be a powder material. A pre-transformed material layer (or a portion thereof) can have a thickness (e.g., layer height) of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A pre-transformed material layer (or a portion thereof) may have any value of the afore-mentioned layer thickness values (e.g., from about 0.1 am to about 1000 μm, from about 1 μm to about 800 μm, from about 20 μm to about 600 μm, from about 30 μm to about 300 μm, or from about 10 μm to about 1000 μm).

At times, the pre-transformed material comprises a powder material. The pre-transformed material may comprise a solid material. The pre-transformed material may comprise one or more particles or clusters. The term “powder,” as used herein, generally refers to a solid having fine particles. The powder may also be referred to as “particulate material.” Powders may be granular materials. The powder particles may comprise micro particles. The powder particles may comprise nanoparticles. In some examples, a powder comprises particles having an average FLS of at least about 5 nanometers (nm), 10 nm, 20 nm, 30 nm, 40 nm, 50 nm, 100 nm, 200 nm, 300 nm, 400 nm, 500 nm, 11 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. In some embodiments, the powder may have an average fundamental length scale of any of the values of the average particle fundamental length scale listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The powder in a material bed may be flowable (e.g., retain its flowability) during the printing.

At times, the powder is composed of individual particles. The individual particles can be spherical, oval, prismatic, cubic, or irregularly shaped. The particles can have a FLS. The powder can be composed of a homogenously shaped particle mixture such that all of the particles have substantially the same shape and fundamental length scale magnitude within at most about 1%, 5%, 8%, 10%, 15%, 20%, 25%, 30%, 35%, 40%, 50%, 60%, or 70%, distribution of FLS. In some embodiments, the powder may have a distribution of FLS of any of the values of the average particle FLS listed above (e.g., from at most about 1% to about 70%, about 1% to about 35%, or about 35% to about 70%). In some embodiments, the powder can be a heterogeneous mixture such that the particles have variable shape and/or fundamental length scale magnitude.

At times, at least parts of the layer are transformed to a transformed material that subsequently forms at least a fraction (also used herein “a portion,” or “a part”) of a hardened (e.g., solidified) 3D object. At times a layer of transformed or hardened material may comprise a cross section of a 3D object (e.g., a horizontal cross section). At times a layer of transformed or hardened material may comprise a deviation from a cross section of a 3D object. The deviation may comprise vertical or horizontal deviation.

At times, the pre-transformed material is requested and/or pre-determined for the 3D object. The pre-transformed material can be chosen such that the material is the requested and/or otherwise predetermined material for the 3D object. A layer of the 3D object may comprise a single type of material. For example, a layer of the 3D object may comprise a single metal alloy type. In some examples, a layer within the 3D object may comprise several types of material (e.g., an elemental metal and an alloy, several ally types, several alloy phases, or any combination thereof). In certain embodiments, each type of material comprises only a single member of that type. For example: a single member of metal alloy (e.g., Aluminum Copper alloy). In some cases, a layer of the 3D object comprises more than one type of material. In some cases, a layer of the 3D object comprises more than one member of a material type.

In some instances, the elemental metal comprises an alkali metal, an alkaline earth metal, a transition metal, a rare-earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare-earth metal can be a lanthanide, or an actinide. The lanthanide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

In some instances, the metal alloy comprises an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750. The metal (e.g., alloy or elemental) may comprise an alloy used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The metal (e.g., alloy or elemental) may comprise an alloy used for products comprising a device, medical device (human & veterinary), machinery, cell phone, semiconductor equipment, generators, turbine, stator, motor, rotor, impeller, engine, piston, electronics (e.g., circuits), electronic equipment, agriculture equipment, gear, transmission, communication equipment, computing equipment (e.g., laptop, cell phone, i-pad), air conditioning, generators, furniture, musical equipment, art, jewelry, cooking equipment, or sport gear. The impeller may be a shrouded (e.g., covered) impeller that is produced as one piece (e.g., comprising blades and cover) during one 3D printing process. The 3D object may comprise a blade. The impeller may be used for pumps (e.g., turbo pumps). The impeller and/or blade may be any, e.g., as described in U.S. patent application Ser. No. 15/435,128, filed on Feb. 16, 2017; PCT patent application number PCT/US17/18191; or European patent application number EP17156707.6, each of which is incorporated herein by reference in its entirety where non-contradictory. The metal (e.g., alloy or elemental) may comprise an alloy used for products for human and/or veterinary applications comprising implants, or prosthetics. The metal alloy may comprise an alloy used for applications in the fields comprising human and/or veterinary surgery, implants (e.g., dental), or prosthetics.

In some instances, the alloy includes a superalloy. The alloy may include a high-performance alloy. The alloy may include an alloy exhibiting at least one of: excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances, the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may comprise cast iron, or pig iron. The steel may comprise Bulat steel, Chromoly, Crucible steel, Damascus steel, Hadfield steel, High speed steel, HSLA steel, Maraging steel, Maraging steel (M300), Reynolds 531, Silicon steel, Spring steel, Stainless steel, Tool steel, Weathering steel, or Wootz steel. The high-speed steel may comprise Mushet steel. The stainless steel may comprise AL-6XN, Alloy 20, celestrium, marine grade stainless, Martensitic stainless steel, surgical stainless steel, or Zeron 100. The tool steel may comprise Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade steel such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may comprise 316L, or 316LVM. The steel may comprise 17-4 Precipitation Hardening steel (e.g., type 630, a chromium-copper precipitation hardening stainless steel, 17-4PH steel).

In some instances, the titanium-based alloy comprises alpha alloy, near alpha alloy, alpha and beta alloy, or beta alloy. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances, the titanium base alloy comprises Ti-6Al-4V or Ti-6Al-7Nb.

In some instances, the Nickel alloy comprises Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may comprise Nickel hydride, Stainless or Coin silver. The cobalt alloy may comprise Megallium, Stellite (e. g. Talonite), Ultimet, or Vitallium. The chromium alloy may comprise chromium hydroxide, or Nichrome.

In some instances, the aluminum alloy comprises AA-8000, Al—Li (aluminum-lithium), Alnico, Duralumin, Hiduminium, Kryron Magnalium, Nambe, Scandium-aluminum, or Y alloy. The magnesium alloy may comprise Elektron, Magnox, or T-Mg—Al—Zn (Bergman phase) alloy.

In some instances, the copper alloy comprises Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may comprise Calamine brass, Chinese silver, Dutch metal, Gilding metal, Muntz metal, Pinchbeck, Prince's metal, or Tombac. The Bronze may comprise Aluminum bronze, Arsenical bronze, Bell metal, Florentine bronze, Guanin, Gunmetal, Glucydur, Phosphor bronze, Ormolu, or Speculum metal. The copper alloy may be a high-temperature copper alloy (e.g., GRCop-84).

In some instances, the metal alloys are Refractory Alloys. The refractory metals and alloys may be used for heat coils, heat exchangers, furnace components, or welding electrodes. The Refractory Alloys may comprise a high melting points, low coefficient of expansion, mechanically strong, low vapor pressure at elevated temperatures, high thermal conductivity, or high electrical conductivity.

In some examples, the material (e.g., pre-transformed material) comprises a material wherein its constituents (e.g., atoms or molecules) readily lose their outer shell electrons, resulting in a free-flowing cloud of electrons within their otherwise solid arrangement. In some examples the material is characterized in having high electrical conductivity, low electrical resistivity, high thermal conductivity, or high density (e.g., as measured at ambient temperature (e.g., R.T., or 20° C.)). The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the afore-mentioned electrical conductivity values (e.g., from about 1*10⁵ S/m to about 1*10⁸ S/m). The low electrical resistivity may be at most about 1*10⁻⁵ ohm times meter (Q*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the afore-mentioned electrical resistivity values (e.g., from about 1*10⁻⁵ Ω*m to about 1*10⁻⁸ Ω*m). The high thermal conductivity may be at least about 20 Watts per meters times Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the afore-mentioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the afore-mentioned density values (e.g., from about 1 g/cm³ to about 25 g/cm³).

At times, a metallic material (e.g., elemental metal or metal alloy) comprises small amounts of non-metallic materials, such as, for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (based on weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (based on weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

In some embodiments, a pre-transformed material within the enclosure is in the form of a powder, wires, sheets, or droplets. The material (e.g., pre-transformed, transformed, and/or hardened) may comprise elemental metal, metal alloy, ceramics, an allotrope of elemental carbon, polymer, and/or resin. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may comprise high performance material (HPM). The ceramic material may comprise a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding. The pre-transformed material may be pulverous. The printed 3D object can be made of a single material (e.g., single material type) or multiple materials (e.g., multiple material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or comprising (e.g., with) metal alloy. The material may comprise a stainless steel. The material may comprise a titanium alloy, aluminum alloy, and/or nickel alloy.

In some embodiments, a 3D object includes one or more auxiliary features. The auxiliary feature(s) can be supported by the material (e.g., powder) bed. The term “auxiliary feature” or “support structure” as used herein, generally refers to a feature that is part of a printed 3D object, but is not part of the desired, intended, designed, ordered, modeled, or final 3D object. Auxiliary feature(s) (e.g., auxiliary support(s)) may provide structural support during and/or subsequent to the formation of the 3D object. The 3D object can have auxiliary feature(s) that can be supported by the material bed (e.g., powder bed) and not touch and/or anchor to the base, substrate, container accommodating the material bed, or the bottom of the enclosure. The 3D part (3D object) in a complete or partially formed state can be completely supported by the material bed (e.g., without touching the substrate, base, container accommodating the powder bed, or enclosure). The 3D object in a complete or partially formed state can be completely supported by the powder bed (e.g., without touching anything except the powder bed). The 3D object in a complete or partially formed state can be suspended anchorlessly in the powder bed, without resting on and/or being anchored to any additional support structures. In some cases, the 3D object in a complete or partially formed (e.g., nascent) state can freely float (e.g., anchorlessly) in the material bed. Auxiliary feature(s) may enable the removal of energy from the 3D object that is being formed. In some instances, the auxiliary support is a scaffold that encloses the 3D object or part thereof. The scaffold may comprise lightly sintered or lightly fused powder material. In some examples, the 3D object may not be anchored (e.g., connected) to the platform and/or walls that define the material bed (e.g., during formation). At times, the 3D object may not touch (e.g., contact) to the platform and/or walls that define the material bed (e.g., during formation). The 3D object be suspended (e.g., float) in the material bed. The scaffold may comprise a continuously sintered (e.g., lightly sintered) structure that is at most 1 millimeter (mm), 2 mm, 5 mm or 10 mm. The scaffold may comprise a continuously sintered structure having dimensions between any of the aforementioned dimensions (e.g., from about 1 mm to about 10 mm, from about 5 mm to about 10 mm, or from about 1 mm to about 5 mm). In some examples, the 3D object may be printed without a supporting scaffold. The supporting scaffold may engulf the 3D object. The supporting scaffold may float in the material bed. The printed 3D object may be printed without the use of auxiliary features, may be printed using a reduced number of auxiliary features, or printed using spaced apart auxiliary features. The auxiliary support structure can be any auxiliary support structure, e.g., disclosed in Patent Application Serial No. PCT/US15/36802 that is entirely incorporated herein by reference in its entirety. The printed 3D object may comprise a single auxiliary support mark. The single auxiliary feature (e.g., auxiliary support or auxiliary structure) may be a platform (e.g., a building platform such as a base or substrate), or a mold. The auxiliary support may be adhered to the platform or mold. In some embodiments, the 3D object comprises a layered structure indicative of 3D printing process that is devoid of one or more auxiliary support features or one or more auxiliary support feature marks that are indicative of a presence or removal of the one or more auxiliary support features. Examples of auxiliary features comprise heat fins, wires, anchors, handles, supports, pillars, columns, frame, footing, scaffold, flange, projection, protrusion, mold (a.k.a. mould), or other stabilization features.

In some embodiments, an energy beam position calibration process comprises generation of alignment markers (or partial markers) in an arrangement (e.g., on an evenly-spaced grid) on a material bed using at least one energy beam (e.g., a first energy beam). The energy beam calibration may correct for any residual error in a positioning of an optical element (e.g., of a guidance selection beam path and/or a guidance system). In some embodiments, the alignment markers are disposed without auxiliary supports in the material bed. The alignment markers may be suspended anchorlessly in the material bed (e.g., during their formation). In some embodiments the alignment markers are disposed with auxiliary supports in the material bed. The auxiliary support(s) may or may not be anchored to the platform. In some embodiments, the alignment markers float (e.g., anchorlessly) above the platform. The calibration and alignment markers may be any calibration markers, e.g., ones disclosed in PCT Patent Application serial number PCT/US19/14635 that is incorporated herein by reference in its entirety.

In some embodiments, an at least one controller is a part of a (e.g., high-speed) computing environment. The computing environment may be any computing environment described herein. The computing environment may be any computer and/or processor described herein. The at least one controller may control (e.g., alter, adjust) the parameters of the components of the 3D printer in real-time (e.g., before, after, and/or during at least a portion of the 3D printing). The control (e.g., open loop control) may comprise a calculation. The control may comprise a feedback loop or a feed-forward, control scheme. In some examples, the control scheme may comprise at least two of (i) open loop (e.g., empirical calculations), and (ii) closed loop (e.g., feed forward and/or feedback loop) control scheme. In some examples, the feedback loop(s) control scheme comprises one or more comparisons with an input parameter and/or threshold. The threshold may be a value, or a relationship (e.g., curve, e.g., function). The threshold may comprise a calculated (e.g., predicted) threshold (e.g., setpoint) value. The threshold may comprise adjustment according to the closed loop and/or feedback control. The at least one controller may use a material level and/or a material flow rate measurement of at least one portion of the sieve assembly. The at least one controller may direct adjustment of one or more systems and/or apparatuses in the 3D printing system. For example, the at least one controller may direct adjustment of a position and/or an angle of an optical element for selection and/or maintenance of an energy beam path (e.g., a guidance selection beam path). For example, the at least one controller may direct adjustment of a position of a (e.g., at least one) guidance system (e.g., with respect to a target surface).

The at least one controller comprises using data obtain from one or more sensors operatively coupled to the controller. The sensor can detect the physical and/or chemical state of material deposited on the target surface (e.g., liquid, or solid (e.g., powder or bulk)). The sensor can detect the crystallinity of material deposited on the target surface. The sensor may spectroscopically detect the material. The sensor can detect the temperature of the material. For example, the sensor may detect the temperature of the material before, during and/or after its transformation. One or more sensors (at least one sensor) can detect the topology of the exposed surface of the material bed and/or the exposed surface of the 3D object or any part thereof. The sensor can detect the amount of material deposited in the material bed. The sensor can be a proximity sensor. The sensor may detect the temperature and/or pressure of the atmosphere within an enclosure (e.g., chamber). The sensor may detect the temperature of the material (e.g., powder) bed at one or more locations. The controller may be configured to operatively couple (e.g., and may be operatively coupled) to any apparatus or component thereof, e.g., as disclosed herein.

In some embodiments, the at least one controller receives a target parameter (e.g. temperature) to maintain at least one characteristics of a forming 3D object. Examples of characteristics of forming 3D objects include temperature and/or metrological information of a melt pool. The metrological information of the melt pool may comprise its FLS. Examples of characteristics of forming 3D objects include metrological information of the forming 3D object. For example, geometry information (e.g. height) of the forming 3D object. Examples of characteristics of forming 3D objects include material characteristic such as hard, soft and/or fluid (e.g., liquidus) state of the forming 3D object. The target parameter may be time-varying, location-varying, or a series of values per location or time. The controller may (e.g., further) receive a pre-determined control variable (e.g. power per unit area) target value from a control loop such as, for example, a feed forward control. In some embodiments, the control variable controls the value of a target parameter of the forming 3D object. For example, a predetermined (e.g., threshold) value of power per unit area of an energy beam may control the temperature of the melt pool of the forming 3D object.

At times, a computer model (e.g. comprising a prediction model, statistical model, or a thermal model) predicts and/or estimates one or more physical and/or chemical parameters of the forming 3D object. There may be more than one computer models (e.g. at least 1, 2, 3, 4, 5, 6, 7, 8, 9 or 10 different models). The controller may (e.g., dynamically) switch between the computer models to predict and/or estimate the one or more physical and/or chemical parameters of the forming 3D object. Dynamic includes changing computer models (e.g., in real time) based on a user input, and/or a controller decision that may be based on monitored target variables of the forming 3D object. The dynamic switch may be performed in real-time (e.g., during the forming of the 3D object). Real time may be, for example, during the formation of a layer of transformed material, during the formation of a layer of hardened material, during formation of a portion of a 3D object, during formation of a melt pool, during formation of a single digit number of melt pools, or during formation of an entire 3D object. The at least one computer model may receive sensed parameter(s) value(s) from one or more sensors. The sensed parameter(s) value(s) may comprise temperature sensed within and/or near one or more melt pools. Vicinity may be within a radius of at least about 1, 2, 3, 4, or 5 average melt pool FLS from a forming melt pool. The computer model may use (e.g., in real-time) the sensed parameter(s) value(s) for a prediction and/or adjustment of the target parameter. The computer model may use (e.g., in real-time) geometric information associated with the requested and/or forming 3D object (e.g. melt pool geometry). The use may be in real-time, or off-line. Real time may comprise during the operation of the energy beam and/or energy source. Off-line may be during the time a 3D object is not printed and/or during “off” time of the energy beam and/or source. The computer model may compare a sensed value (e.g., by the one or more sensors) to an estimated value of the target parameter. The computer model may (e.g., further) calculate an error term and readjust the at least one computer model to achieve convergence (e.g., of a desired or requested 3D model with the printed 3D object).

In some embodiments, the computer model estimates a target variable. The target variable may be of a physical or chemical occurrence (e.g., phenomenon) that may or may not be (e.g., directly) detectable. For example, the target variable may be of a temperature that may or may not be (e.g., directly) measurable. For example, the target variable may be of a physical location that may or may not be (e.g., directly) measurable. For example, the target variable may be an oxidative state of the material that may or may not be (e.g., directly) measurable. For example, a physical location may be inside the 3D object at a depth, that may be not directly measured by the one or more sensors. An estimated value of the target variable may be (e.g., further) compared to a critical value of the target variable. At times, the target value exceeds a critical value (e.g., threshold value), and the computer model may provide feedback to the controller to attenuate (e.g., turn off, or reduce the intensity of) the energy beam (e.g., for a specific amount of time). The computer model may set up a feedback control loop with the controller. The feedback control loop may be for the purpose of adjusting one or more target parameters to achieve convergence (e.g., of a desired or requested 3D model with the printed 3D object). In one embodiment, the computer model may predict (i) an estimated temperature of the melt pool, (ii) local deformation within the forming 3D object, (iii) global deformation and/or (iv) imaging temperature fields. The computer model may (e.g. further) predict corrective energy beam adjustments (e.g. in relation to a temperature target threshold).

The adjustment predictions may be based on the (i) measured and/or monitored temperature information at a first location on the forming 3D object (e.g. a forming melt pool), (ii) a second location (e.g. in the vicinity of the forming melt pool), and/or (iii) geometric information (e.g. height) of the forming 3D object. The energy beam adjustment may comprise adjusting at least one control variable (e.g. power per unit area, dwell time, cross-sectional diameter, and/or speed) of the energy beam. In some embodiments, the control system may comprise a closed loop feed forward control scheme. The control scheme may override one or more (e.g., any) corrections and/or predictions by the computer model. The override may be by requesting a predefined amount of energy (e.g. power per unit area) to supply to the portion (e.g., of the material bed and/or of the 3D object). Real time may be before, during, or following formation of at least a portion of the 3D object. The control may comprise controlling a cooling rate (e.g., of a material bed or a portion thereof), control the microstructure of a transformed material portion, or control the microstructure of at least a portion of the 3D object. Controlling the microstructure may comprise controlling the phase, morphology, FLS, volume, or overall shape of the transformed (e.g., and subsequently solidified) material portion. The material portion may be a melt pool.

The detector may be any detector, e.g., disclosed in patent application number PCT/US15/65297, titled “FEEDBACK CONTROL SYSTEMS FOR THREE-DIMENSIONAL PRINTING” that was filed on Dec. 11, 2015 that is incorporated herein by reference in its entirety. The detectors can comprise the sensors. The detectors (e.g., sensors) can be configured to measure one or more properties of the 3D object and/or the pre-transformed material (e.g., powder). The detectors can collect one or more signals from the 3D object and/or the target surface (e.g., by using the returning energy beams). In some cases, the detectors can collect signals from one or more optical sensors (e.g., as disclosed herein). The detectors can collect signals from one or more vision sensors (e.g. camera), thermal sensors, acoustic sensors, vibration sensors, spectroscopic sensor, radar sensors, and/or motion sensors. The optical sensor may include an analogue device (e.g., CCD). The optical sensor may include a p-doped metal-oxide-semiconductor (MOS) capacitor, charge-coupled device (CCD), active-pixel sensor (APS), micro/nano-electro-mechanical-system (MEMS/NEMS) based sensor, or any combination thereof. The APS may be a complementary MOS (CMOS) sensor. The MEMS/NEMS sensor may include a MEMS/NEMS inertial sensor. The MEMS/NEMS sensor may be based on silicon, polymer, metal, ceramics, or any combination thereof. The detector (e.g., optical detector) may be coupled to an optical fiber.

In some embodiments, the detector includes a sensor, e.g., a temperature sensor. The temperature sensor (e.g., thermal sensor) may sense an IR radiation (e.g., photons). The thermal sensor may sense a temperature of at least one melt pool. The sensor may be a metrology sensor. The metrology sensor may comprise a sensor that measures the FLS (e.g., depth) of at least one melt pool. The transforming energy beam and the detector energy beam (e.g., thermal sensor beam and/or metrology sensor energy beam) may be focused on substantially the same position. The transforming energy beam and the detector energy beam (e.g., thermal sensor beam and/or metrology sensor energy beam) may be confocal.

The detector may include an imaging sensor. The imaging sensor can image a surface of the target surface comprising untransformed material (e.g., pre-transformed material) and at least a portion of the 3D object. The imaging sensor may be coupled to an optical fiber. The imaging sensor can image (e.g. using the returning energy beam) a portion of the target surface comprising transforming material (e.g., one or more melt pools and/or its vicinity). The optical filter or CCD can allow transmission of background lighting at a predetermined wavelength or within a range of wavelengths.

The detector may include a reflectivity sensor. The reflectivity sensor may include an imaging component. The reflectivity sensor can image the material surface at variable heights and/or angles relative to the surface (e.g., the material surface). In some cases, reflectivity measurements can be processed to distinguish between the exposed surface of the material bed and a surface of the 3D object. For example, the untransformed material (e.g., pre-transformed material) in the target surface can be a diffuse reflector and the 3D object (or a melt pool, a melt pool keyhole) can be a specular reflector. Images from the detectors can be processed to determine topography, roughness, and/or reflectivity of the surface comprising the untransformed material (e.g., pre-transformed material) and the 3D object. The detector may be used to perform thermal analysis of a melt pool and/or its vicinity (e.g., detecting keyhole, balling and/or spatter formation). The surface can be sensed (e.g., measured) with dark-field and/or bright field illumination and a map and/or image of the illumination can be generated from signals detected during the dark-field and/or bright field illumination. The maps from the dark-field and/or bright field illumination can be compared to characterize the target surface (e.g., of the material bed and/or of the 3D object). For example, surface roughness can be determined from a comparison of dark-field and/or bright field detection measurements. In some cases, analyzing the signals can include polarization analysis of reflected or scattered light signals.

The at least one sensor can be operatively coupled to a control system (e.g., computer control system). The sensor may comprise a light sensor, acoustic sensor, vibration sensor, chemical sensor, electrical sensor, magnetic sensor, fluidity sensor, movement sensor, speed sensor, position sensor, pressure sensor, force sensor, density sensor, distance sensor, or proximity sensor. The sensor may include a temperature sensor, weight sensor, material (e.g., powder) level sensor, metrology sensor, gas sensor, or humidity sensor. The metrology sensor may comprise a measurement sensor (e.g., height, length, width, angle, and/or volume). The metrology sensor may comprise a magnetic, acceleration, orientation, or optical sensor. The sensor may transmit and/or receive a sound (e.g., echo), magnetic, electronic, or electromagnetic signal. The electromagnetic signal may comprise a visible, infrared, ultraviolet, ultrasound, radio wave, or microwave signal. The metrology sensor may measure at least a portion of the layer of material. The layer of material may be a pre-transformed material (e.g., powder), transformed material, or hardened material. The metrology sensor may measure at least a portion of the 3D object. The gas sensor may sense any of the gas delineated herein. The distance sensor can be a type of metrology sensor. The distance sensor may comprise an optical sensor, or capacitance sensor. The temperature sensor can comprise Bolometer, Bimetallic strip, Calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer (e.g., resistance thermometer), or Pyrometer. The temperature sensor may comprise an optical sensor. The temperature sensor may comprise image processing. The temperature sensor may comprise a camera (e.g., IR camera, CCD camera). The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. In another example, one or more sensors (e.g., optical sensors or optical level sensors) can be provided adjacent to the material bed such as above, below, or to the side of the material bed. In some examples, the one or more sensors can sense the powder level. The material (e.g., powder) level sensor can be in communication with a material dispensing mechanism (e.g., powder dispenser). Alternatively, or additionally a sensor can be configured to monitor the weight of the material bed by monitoring a weight of a structure that contains the material bed. One or more position sensors (e.g., height sensors) can measure the height of the material bed relative to the substrate. The position sensors can be optical sensors. The position sensors can determine a distance between one or more energy beams (e.g., a laser or an electron beam.) and a surface of the material (e.g., powder). The one or more sensors may be connected to a control system (e.g., to a processor, to a computer).

In some embodiments, the methods, systems, and/or the apparatus described herein comprise an actuator. In some embodiments, the methods, systems, and/or the apparatus described herein comprise a motor. The motor may comprise a servomotor. The servomotors may comprise actuated linear lead screw drive motors. The motor may comprise a stepper motor. The motors may comprise belt drive motors. The motors may comprise rotary encoders.

The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators. The systems and/or apparatuses disclosed herein may comprise one or more pistons. The piston may be a trunk, crosshead, slipper, or deflector piston. The motor may be controlled by the control system and/or manually. The apparatuses and/or systems described herein may include a system that adjusts a position of an (e.g., at least one) optical element (e.g., to direct an energy beam to impinge onto a guidance system). The system for adjusting the optical element may be controlled by the control system, or manually. The motor may connect to a system for adjusting the optical element. The motor may alter (e.g., the position of) the optical element with respect to an energy source, a guidance system, and/or an energy beam (e.g., guidance selection) path.

At times, one or more controllers are configured to control (e.g., direct) one or more apparatuses and/or operations. Control may comprise regulate, modulate, adjust, maintain, alter, change, govern, manage, restrain, restrict, direct, guide, oversee, manage, preserve, sustain, restrain, temper, or vary. The control configuration (e.g., “configured to”) may comprise programming. The controller may comprise an electronic circuitry, and electrical inlet, or an electrical outlet. The configuration may comprise facilitating (e.g., and directing) an action or a force. The force may be magnetic, electric, pneumatic, hydraulic, and/or mechanic. Facilitating may comprise allowing use of ambient (e.g., external) forces (e.g., gravity). Facilitating may comprise alerting to and/or allowing: usage of a manual force and/or action. Alerting may comprise signaling (e.g., directing a signal) that comprises a visual, auditory, olfactory, or a tactile signal.

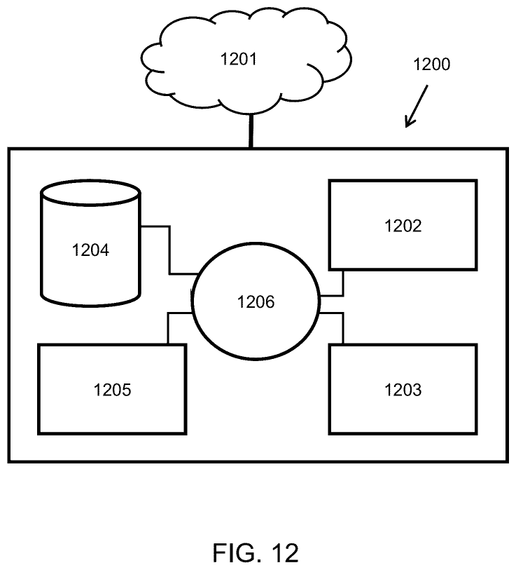

The controller may comprise a processing unit. The processing unit may be central. The processing unit may comprise a central processing unit (herein “CPU”). The controllers or control mechanisms (e.g., comprising a computer system) may be configured to, e.g., programmed to implement methods of the disclosure. The controller may control at least one component of the systems and/or apparatuses disclosed herein. FIG. 12 is a schematic example of a computer system 1200 that is programmed or otherwise configured to facilitate the formation of a 3D object according to the methods provided herein. The computer system 1200 can control (e.g., direct and/or regulate) various features of printing methods, apparatuses and systems of the present disclosure, such as, for example, guidance of a path of the energy source, trajectory of the guidance system, application of an amount of energy emitted to a selected location, detection system activation and deactivation, sensor data and/or signal, detector field of view coordinated movement, image processing, process parameters (e.g., dispenser layer height, planarization, chamber pressure), or any combination thereof. The computer system 1200 can be part of, or be in communication with, a printing system or apparatus, such as a 3D printing system or apparatus of the present disclosure. The processor may be coupled to one or more mechanisms disclosed herein, and/or any parts thereof. For example, the computer may be coupled to one or more energy sources, optical elements, processing chamber, build module, platform, sensors, valves, switches, motors, pumps, or any combination thereof.

The computer system 1200 can include a processing unit 1206 (also “processor,” “computer” and “computer processor” used herein). The computer system may include memory or memory location 1202 (e.g., random-access memory, read-only memory, flash memory), electronic storage unit 1204 (e.g., hard disk), communication interface 1203 (e.g., network adapter) for communicating with one or more other systems, and peripheral devices 1205, such as cache, other memory, data storage and/or electronic display adapters. The memory 1202, storage unit 1204, interface 1203, and peripheral devices 1205 are in communication with the processing unit 1206 through a communication bus (solid lines), such as a motherboard. The storage unit can be a data storage unit (or data repository) for storing data. The computer system can be operatively coupled to a computer network (“network”) 1201 with the aid of the communication interface. The network can be the Internet, an Internet and/or extranet, or an intranet and/or extranet that is in communication with the Internet. The network in some cases is a telecommunication and/or data network. The network can include one or more computer servers, which can enable distributed computing, such as cloud computing. The network, in some cases with the aid of the computer system, can implement a peer-to-peer network, which may enable devices coupled to the computer system to behave as a client or a server.

The processing unit can execute a sequence of machine-readable instructions, which can be embodied in a program or software. The instructions may be stored in a memory location, such as the memory 1202. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLD), a chipset, a field programmable gate array (FPGA), or any combination thereof. The processing unit can be part of a circuit, such as an integrated circuit. One or more other components of the system 1200 can be included in the circuit.

The storage unit 1204 can store files, such as drivers, libraries, and saved programs. The storage unit can store user data, e.g., user preferences and user programs. The computer system in some cases can include one or more additional data storage units that are external to the computer system, such as located on a remote server that is in communication with the computer system through an intranet or the Internet.

The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system via the network.

Methods as described herein can be implemented by way of machine (e.g., computer processor) executable code stored on an electronic storage location of the computer system, such as, for example, on the memory 1202 or electronic storage unit 1204. The machine executable or machine-readable code can be provided in the form of software. During use, the processor 1206 can execute the code. In some cases, the code can be retrieved from the storage unit and stored on the memory for ready access by the processor. In some situations, the electronic storage unit can be precluded, and machine-executable instructions are stored on memory.

The code can be pre-compiled and configured for use with a machine have a processer adapted to execute the code or can be compiled during runtime. The code can be supplied in a programming language that can be selected to enable the code to execute in a pre-compiled or as-compiled fashion.

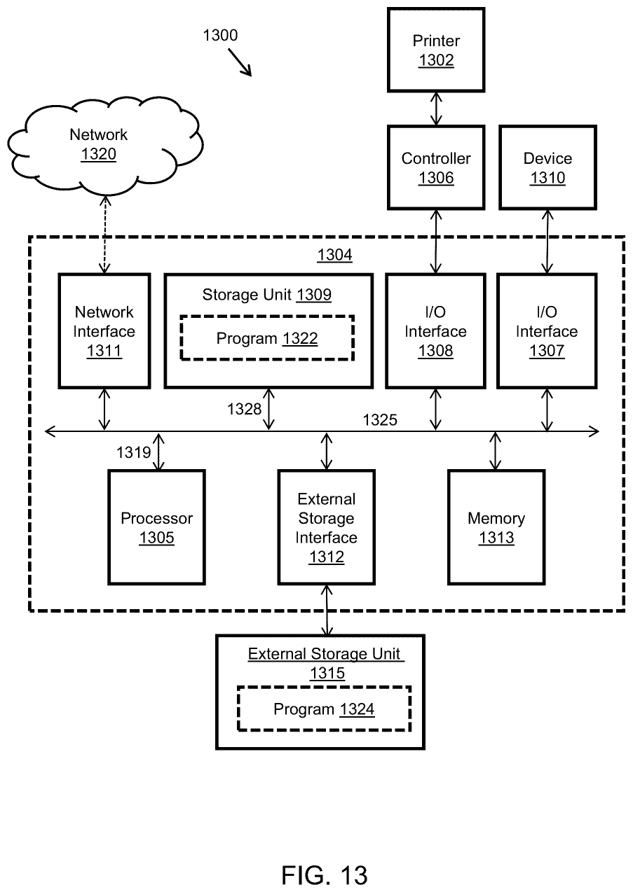

FIG. 13 shows an example computer system 1300, upon which the various arrangements described, can be practiced. The computer system (e.g., FIG. 13, 1300) can control and/or implement (e.g., direct and/or regulate) various features of printing methods, apparatus and/or system operations of the present disclosure. For example, the computer system can be used to control energy beam directionality parameters, processing chamber parameters (e.g., chamber pressure, gas flow and/or temperature), energy beam parameters (e.g., scanning rate, path and/or power), platform parameters (e.g., location and/or speed), layer forming apparatus parameters (e.g., speed, location and/or vacuum), or any combination thereof. The energy beam directionality parameters may comprise a position of at least one guidance system with respect to a target surface, or a position of an optical element (e.g., with regard to a guidance selection beam path). The computer system can be part of, or be in communication with, one or more 3D printers (e.g., FIG. 13, 1302) or any of their (e.g., sub-) components. The computer system can include one or more computers (e.g., FIG. 13, 1304). The computer(s) may be operationally coupled to one or more mechanisms of the printer(s). For example, the computer(s) may be operationally coupled to one or more sensors, valves, switches, actuators (e.g., motors), pumps, optical components, and/or energy sources of the printer(s). In some cases, the computer(s) controls aspects of the printer(s) via one or more controllers (e.g., 106). The controller(s) may be configured to direct one or more operations of the one or more printer(s). For example, the controller(s) may be configured to direct one or more actuators of printer(s). In some cases, the controller(s) is part of the computer(s) (e.g., within the same unit(s)). In some cases, the controller(s) is separate (e.g., a separate unit) from the computer(s). In some instances, the computer(s) communicates with the controller(s) via one or more input/output (I/O) interfaces (e.g., FIG. 13, 1308). The input/output (I/O) interface(s) may comprise one or more wired or wireless connections to communicate with the printer(s). In some embodiments, the I/O interface comprises Bluetooth technology to communicate with the controller(s).

The computer(s) (e.g., FIG. 13, 1304) may have any number of components. For example, the computer(s) may comprise one or more storage units (e.g., FIG. 13, 1309), one or more processors (e.g., FIG. 13, 1305), one or more memory units (e.g., FIG. 13, 1313), and/or one or more external storage interfaces (e.g., FIG. 13, 1312). In some embodiments, the storage unit(s) includes a hard disk drive (HDD), a magnetic tape drive and/or a floppy disk drive. In some embodiments, the memory unit(s) includes a random access memory (RAM) and/or read only memory (ROM), and/or flash memory. In some embodiments, the external storage interface(s) comprises a disk drive (e.g., optical or floppy drive) and/or a universal serial bus (USB) port. The external storage interface(s) may be configured to provide communication with one or more external storage units (e.g., FIG. 13, 1315). The external storage unit(s) may comprise a portable memory medium. The external storage unit(s) may be a non-volatile source of data. In some cases, the external storage unit(s) is an optical disk (e.g., CD-ROM, DVD, Blu-ray Disc™), a USB-RAM, a hard drive, a magnetic tape drive, and/or a floppy disk. In some cases, the external storage unit(s) may comprise a disk drive (e.g., optical or floppy drive). Various components of the computer(s) may be operationally coupled via a communication bus (e.g., FIG. 13, 1325). For example, one or more processor(s) (e.g., FIG. 13, 1305) may be operationally coupled to the communication bus by one or more connections (e.g., FIG. 13, 1319). The storage unit(s) (e.g., FIG. 13, 1309) may be operationally coupled to the communication bus one or more connections (e.g., FIG. 13, 1328). The communication bus (e.g., FIG. 13, 1325) may comprise a motherboard.

In some embodiments, methods described herein are implemented as one or more software programs (e.g., FIGS. 13, 1322 and/or 1324). The software program(s) may be executable within the one or more computers (e.g., FIG. 13, 1304). The software may be implemented on a non-transitory computer readable media. The software program(s) may comprise machine-executable code. The machine-executable code may comprise program instructions. The program instructions may be carried out by the computer(s) (e.g., FIG. 13, 1304). The machine-executable code may be stored in the storage device(s) (e.g., FIG. 13, 1309). The machine-executable code may be stored in the external storage device(s) (e.g., FIG. 13, 1315). The machine-executable code may be stored in the memory unit(s) (e.g., FIG. 13, 1313). The storage device(s) (e.g., FIG. 13, 1309) and/or external storage device(s) (e.g., FIG. 13, 1315) may comprise a non-transitory computer-readable medium. The processor(s) may be configured to read the software program(s) (e.g., FIGS. 13, 1322 and/or 1324). In some cases, the machine-executable code can be retrieved from the storage device(s) and/or external storage device(s), and stored on the memory unit(s) (e.g., FIG. 13, 1306) for access by the processor (e.g., FIG. 13, 1305). In some cases, the access is in real-time (e.g., during printing). In some situations, the storage device(s) and/or external storage device(s) can be precluded, and the machine-executable code is stored on the memory unit(s). The machine-executable code may be pre-compiled and configured for use with a machine have a processer adapted to execute the machine-executable code, or can be compiled during runtime (e.g., in real-time). The machine-executable code can be supplied in a programming language that can be selected to enable the machine-executable code to execute in a pre-compiled or as-compiled fashion.

In some embodiments, the computer(s) is operationally coupled with, or comprises, one or more devices (e.g., FIG. 13, 1310). In some embodiments, the device(s) (e.g., FIG. 13, 1310) is configured to provide one or more (e.g., electronic) inputs to the computer(s). In some embodiments, the device(s) (e.g., FIG. 13, 1310) is configured to receive one or more (e.g., electronic) outputs from the computer(s). The computer(s) may communicate with the device(s) via one or more input/output (I/O) interfaces (e.g., FIG. 13, 1307). The input/output (I/O) interface(s) may comprise one or more wired or wireless connections. The device(s) can include one or more user interfaces (UI). The UI may include one or more keyboards, one or more pointer devices (e.g., mouse, trackpad, touchpad, or joystick), one or more displays (e.g., computer monitor or touch screen), one or more sensors, and/or one or more switches (e.g., electronic switch). In some cases, the UI may be a web-based user interface. At times, the UI provides a model design or graphical representation of a 3D object to be printed. The sensor(s) may comprise a light sensor, a thermal sensor, an audio sensor (e.g., microphone), and/or a tactile sensor. In some cases, the sensor(s) are part of the printer(s) (e.g., FIG. 13, 1302). For example, the sensor(s) may be located within a processing chamber of a printer (e.g., to monitor an atmosphere therein). The sensor(s) may be configured to monitor one or more signals (e.g., thermal and/or light signal) that is generated during a printing operation. In some cases, the sensor(s) are part of a component or apparatus that is separate from the printer(s). In some cases, the device(s) is a pre-printing processing apparatus. For example, in some cases, the device(s) can be one or more scanners (e.g., 2D or 3D scanner) for scanning (e.g., dimensions of) a 3D object. In some cases, the device(s) is a post-printing processing apparatus (e.g., a docking station, unpacking station, and/or a hot isostatic pressing apparatus). In some embodiments, the I/O interface comprises Bluetooth technology to communicate with the device(s).

In some embodiments, the computer(s) (e.g., FIG. 13, 1304), controller(s) (e.g., FIG. 13, 1306), printer(s) (e.g., FIG. 13, 1302) and/or device(s) (e.g., FIG. 13, 1310) comprises one or more communication ports. For example, one or more I/O interfaces (e.g., FIG. 13, 1307 or 1308) can comprise communication ports. The communication port(s) may be a serial port or a parallel port. The communication port(s) may be a Universal Serial Bus port (i.e., USB). The USB port can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. The communication port(s) may comprise a plug and/or a socket (e.g., electrical, AC power, DC power). The communication port(s) may comprise an adapter (e.g., AC and/or DC power adapter). The communication port(s) may comprise a power connector.

The power connector can be an electrical power connector. The power connector may comprise a magnetically coupled (e.g., attached) power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In some embodiments, the computer(s) is configured to communicate with one or more networks (e.g., FIG. 13, 1320). The network(s) may comprise a wide-area network (WAN) or a local area network (LAN). In some cases, the computer(s) includes one or more network interfaces (e.g., FIG. 13, 1311) that is configured to facilitate communication with the network(s).

The network interface(s) may include wired and/or wireless connections. In some embodiments, the network interface(s) comprises a modulator demodulator (modem). The modem may be a wireless modem. The modem may be a broadband modem. The modem may be a “dial up” modem. The modem may be a high-speed modem. The WAN can comprise the Internet, a cellular telecommunications network, and/or a private WAN. The LAN can comprise an intranet. In some embodiments, the LAN is operationally coupled with the WAN via a connection, which may include a firewall security device. The WAN may be operationally coupled the LAN by a high capacity connection. In some cases, the computer(s) can communicate with one or more remote computers via the LAN and/or the WAN. In some instances, the computer(s) may communicate with a remote computer(s) of a user (e.g., operator). The user may access the computer(s) via the LAN and/or the WAN. In some cases, the computer(s) (e.g., FIG. 13, 1304) store and/or access data to and/or from data storage unit(s) that are located on one or more remote computers in communication via the LAN and/or the WAN. The remote computer(s) may be a client computer. The remote computer(s) may be a server computer (e.g., web server or server farm). The remote computer(s) can include desktop computers, personal computers (e.g., portable PC), slate or tablet PC's (e.g., Apple® iPad, Samsung® Galaxy Tab), telephones, smart phones (e.g., Apple® iPhone, Android-enabled device, Blackberry®), or personal digital assistants.

At times, the processor (e.g., FIG. 13, 1305) includes one or more cores. The computer system may comprise a single core processor, multiple core processor, or a plurality of processors for parallel processing. The processor may comprise one or more central processing units (CPU) and/or graphic processing units (GPU). The multiple cores may be disposed in a physical unit (e.g., Central Processing Unit, or Graphic Processing Unit). The processor may be a single physical unit. The physical unit may be a die. The physical unit may comprise cache coherency circuitry. The processor may include multiple physical units. The physical unit may comprise an integrated circuit chip. The integrated circuit chip may comprise one or more transistors. The integrated circuit chip may comprise at least about 0.2 billion transistors (BT), 0.5 BT, 1BT, 2 BT, 3 BT, 5 BT, 6 BT, 7 BT, 8 BT, 9 BT, 10 BT, 15 BT, 20 BT, 25 BT, 30 BT, 40 BT, or 50 BT. The integrated circuit chip may comprise at most about 7 BT, 8 BT, 9 BT, 10 BT, 15 BT, 20 BT, 25 BT, 30 BT, 40 BT, 50 BT, 70 BT, or 100 BT. The integrated circuit chip may comprise any number of transistors between the afore-mentioned numbers (e.g., from about 0.2 BT to about 100 BT, from about 1 BT to about 8 BT, from about 8 BT to about 40 BT, or from about 40 BT to about 100 BT). The integrated circuit chip may have an area of at least about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of at most about 50 mm², 60 mm², 70 mm², 80 mm², 90 mm², 100 mm², 200 mm², 300 mm², 400 mm², 500 mm², 600 mm², 700 mm², or 800 mm². The integrated circuit chip may have an area of any value between the afore-mentioned values (e.g., from about 50 mm² to about 800 mm², from about 50 mm² to about 500 mm², or from about 500 mm² to about 800 mm²). The multiple cores may be disposed in close proximity. The close proximity may allow substantial preservation of communication signals that travel between the cores. The close proximity may diminish communication signal degradation. A core as understood herein is a computing component having independent central processing capabilities. The computing system may comprise a multiplicity of cores, which are disposed on a single computing component. The multiplicity of cores may include two or more independent central processing units. The independent central processing units may constitute a unit that read and execute program instructions. The independent central processors may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. The multiplicity of cores may include at least about 2, 10, 40, 100, 400, 1000, 2000, 3000, 4000, 5000, 6000, 7000, 8000, 9000, 10000, 11000, 12000, 13000, 14000 or 15000 cores. The multiplicity of cores may include at most about 1000, 2000, 3000, 4000, 5000, 6000, 7000, 8000, 9000, 10000, 11000, 12000, 13000, 14000, 15000, 20000, 30000, or 40000 cores. The multiplicity of cores may include cores of any number between the afore-mentioned numbers (e.g., from about 2 to about 40000, from about 2 to about 400, from about 400 to about 4000, from about 2000 to about 4000, from about 4000 to about 10000, from about 4000 to about 15000, or from about 15000 to about 40000 cores). In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS). The number of FLOPS may be at least about 1 Tera Flops (T-FLOPS), 2 T-FLOPS, 3 T-FLOPS, 5 T-FLOPS, 6 T-FLOPS, 7 T-FLOPS, 8 T-FLOPS, 9 T-FLOPS, or 10 T-FLOPS. The number of flops may be at most about 5 T-FLOPS, 6 T-FLOPS, 7 T-FLOPS, 8 T-FLOPS, 9 T-FLOPS, 10 T-FLOPS, 20 T-FLOPS, 30 T-FLOPS, 50 T-FLOPS, 100 T-FLOPS, 1 P-FLOPS, 2 P-FLOPS, 3 P-FLOPS, 4 P-FLOPS, 5 P-FLOPS, 10 P-FLOPS, 50 P-FLOPS, 100 P-FLOPS, 1 EXA-FLOP, 2 EXA-FLOPS, or 10 EXA-FLOPS. The number of FLOPS may be any value between the afore-mentioned values (e.g., from about 0.1 T-FLOP to about 10 EXA-FLOPS, from about 0.1 T-FLOPS to about 1 T-FLOPS, from about 1 T-FLOPS to about 4 T-FLOPS, from about 4 T-FLOPS to about 10 T-FLOPS, from about 1 T-FLOPS to about 10 T-FLOPS, or from about 10 T-FLOPS to about 30 T-FLOPS, from about 50 T-FLOPS to about 1 EXA-FLOP, or from about 0.1 T-FLOP to about 10 EXA-FLOPS). In some processors (e.g., FPGA), the operations per second may be measured as (e.g., Giga) multiply-accumulate operations per second (e.g., MACs or GMACs). The MACs value can be equal to any of the T-FLOPS values mentioned herein measured as Tera-MACs (T-MACs) instead of T-FLOPS respectively. The FLOPS can be measured according to a benchmark. The benchmark may be an HPC Challenge Benchmark. The benchmark may comprise mathematical operations (e.g., equation calculation such as linear equations), graphical operations (e.g., rendering), or encryption/decryption benchmark. The benchmark may comprise a High Performance LINPACK, matrix multiplication (e.g., DGEMM), sustained memory bandwidth to/from memory (e.g., STREAM), array transposing rate measurement (e.g., PTRANS), Random-access, rate of Fast Fourier Transform (e.g., on a large one-dimensional vector using the generalized Cooley-Tukey algorithm), or Communication Bandwidth and Latency (e.g., MPI-centric performance measurements based on the effective bandwidth/latency benchmark). LINPACK may refer to a software library for performing numerical linear algebra on a digital computer. DGEMM may refer to double precision general matrix multiplication. STREAM benchmark may refer to a synthetic benchmark designed to measure sustainable memory bandwidth (in MB/s) and a corresponding computation rate for four simple vector kernels (Copy, Scale, Add and Triad). PTRANS benchmark may refer to a rate measurement at which the system can transpose a large array (global). MPI refers to Message Passing Interface.

At times, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by NVidia, ATI Technologies, S3 Graphics, Advanced Micro Devices (AMD), or Matrox. The processor(s) may be able to process algorithms comprising a matrix or a vector. The core may comprise a complex instruction set computing core (CISC), or reduced instruction set computing (RISC).

At times, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise an algorithm.

At times, the computer system includes configurable computing, partially reconfigurable computing, reconfigurable computing, or any combination thereof. The computer system may include a FPGA. The computer system may include an integrated circuit that performs the algorithm. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration.

At times, the computing system includes an integrated circuit that performs the algorithm (e.g., control algorithm). The physical unit (e.g., the cache coherency circuitry within) may have a clock time of at least about 0.1 Gigabits per second (Gbit/s), 0.5 Gbit/s, 1 Gbit/s, 2 Gbit/s, 5 Gbit/s, 6 Gbit/s, 7 Gbit/s, 8 Gbit/s, 9 Gbit/s, 10 Gbit/s, or 50 Gbit/s. The physical unit may have a clock time of any value between the afore-mentioned values (e.g., from about 0.1 Gbit/s to about 50 Gbit/s, or from about 5 Gbit/s to about 10 Gbit/s). The physical unit may produce the algorithm output in at most about 0.1 microsecond (μs), 1 μs, 10 μs, 100 μs, or 1 millisecond (ms). The physical unit may produce the algorithm output in any time between the afore-mentioned times (e.g., from about 0.1 μs, to about 1 ms, from about 0.1 μs, to about 100 μs, or from about 0.1 μs to about 10 μs).

In some instances, the controller(s) (e.g., FIG. 13, 1306) uses real time measurements and/or calculations to regulate one or more components of the printer(s). In some cases, the controller(s) regulate characteristics of the energy beam(s). The sensor(s) (e.g., on the printer) may provide a signal (e.g., input for the controller and/or processor) at a rate of at least about 0.1 KHz, 1 KHz, 10 KHz, 100 KHz, 1000 KHz, or 10000 KHz). The sensor(s) may be a temperature and/or positional sensor(s). The sensor(s) may provide a signal at a rate between any of the above-mentioned rates (e.g., from about 0.1 KHz to about 10000 KHz, from about 0.1 KHz to about 1000 KHz, or from about 1000 KHz to about 10000 KHz). The memory bandwidth of the processor(s) may be at least about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may be at most about 1 gigabytes per second (Gbytes/s), 10 Gbytes/s, 100 Gbytes/s, 200 Gbytes/s, 300 Gbytes/s, 400 Gbytes/s, 500 Gbytes/s, 600 Gbytes/s, 700 Gbytes/s, 800 Gbytes/s, 900 Gbytes/s, or 1000 Gbytes/s. The memory bandwidth of the processor(s) may have any value between the afore-mentioned values (e.g., from about 1 Gbytes/s to about 1000 Gbytes/s, from about 100 Gbytes/s to about 500 Gbytes/s, from about 500 Gbytes/s to about 1000 Gbytes/s, or from about 200 Gbytes/s to about 400 Gbytes/s). The sensor measurements may be real-time measurements. The real-time measurements may be conducted during at least a portion of the 3D printing process. The real-time measurements may be in-situ measurements in the 3D printing system and/or apparatus. the real-time measurements may be during at least a portion of the formation of the 3D object. In some instances, the processor(s) may use the signal obtained from the at least one sensor to provide a processor(s) output, which output is provided by the processing system at a speed of at most about 100 minute (min), 50 min, 25 min, 15 min, 10 min, 5 min, 1 min, 0.5 min (i.e., 30 seconds (sec)), 15 sec, 10 sec, 5 sec, 1 sec, 0.5 sec, 0.25 sec, 0.2 sec, 0.1 sec, 80 milliseconds (msec), 50 msec, 10 msec, 5 msec, or 1 msec. In some instances, the processor(s) may use the signal obtained from the at least one sensor to provide a processor(s) output, which output is provided at a speed of any value between the aforementioned values (e.g., from about 100 min to about 1 msec, from about 100 min to about 10 min, from about 10 min to about 1 min, from about 5 min to about 0.5 min, from about 30 sec to about 0.1 sec, or from about 0.1 sec to about 1 msec). The processor(s) output may comprise an evaluation of the temperature at a location, position at a location (e.g., vertical and/or horizontal), or a map of locations. The location may be on the target surface. The map may comprise a topological or temperature map.

At times, the processor(s) (e.g., FIG. 13, 1305) uses the signal obtained from one or more sensors (e.g., on the printer) in an algorithm that is used in controlling the energy beam. The algorithm may comprise the path of the energy beam. In some instances, the algorithm may be used to alter the path of the energy beam on the target surface. The path may deviate from a cross section of a model corresponding to the requested 3D object. The processor may use the output in an algorithm that is used in determining the manner in which a model of the requested 3D object may be sliced. The processor may use the signal obtained from the at least one sensor in an algorithm that is used to configure one or more parameters and/or apparatuses relating to the 3D printing process. The parameters may comprise a characteristic of the energy beam. The parameters may comprise movement of the platform and/or material bed. The parameters may include characteristics of the gas flow system. The parameters may include characteristics of the layer forming apparatus. The parameters may comprise relative movement of the energy beam and the material bed. In some instances, the energy beam, the platform (e.g., material bed disposed on the platform), or both may translate. Alternatively, or additionally, the controller(s) (e.g., FIG. 13, 1310) may use historical data for the control. Alternatively, or additionally, the processor may use historical data in its one or more algorithms. The parameters may comprise the height of the layer of pre-transformed material disposed in the enclosure and/or the gap by which the cooling element (e.g., heat sink) is separated from the target surface. The target surface may be the exposed layer of the material bed.

At times, the memory (e.g., FIG. 13, 1306) comprises a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NAND) or NOR logic gates. A NAND gate (negative-AND) may be a logic gate which produces an output which is false only if all its inputs are true. The output of the NAND gate may be complemented to that of the AND gate. The storage may include a hard disk (e.g., a magnetic disk, an optical disk, a magneto-optic disk, a solid-state disk, etc.), a compact disc (CD), a digital versatile disc (DVD), a floppy disk, a cartridge, a magnetic tape, and/or another type of computer-readable medium, along with a corresponding drive.

At times, all or portions of the software program(s) (e.g., FIG. 13, 1327) are communicated through the WAN or LAN networks. Such communications, for example, may enable loading of the software program(s) from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software program(s). As used herein, unless restricted to non-transitory, tangible “storage” media, terms such as computer or machine “readable medium” refer to any medium that participates in providing instructions to a processor for execution. Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases. Volatile storage media can include dynamic memory, such as main memory of such a computer platform. Tangible transmission media can include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and/or infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, any other medium from which a computer may read programming code and/or data, or any combination thereof. The memory and/or storage may comprise a storing device external to and/or removable from device, such as a Universal Serial Bus (USB) memory stick, or/and a hard disk. Many of these forms of computer readable media may be involved in carrying one or more sequences of one or more instructions to a processor for execution.

At times, the computer system monitors and/or controls various aspects of the 3D a printer(s). In some cases, the control is via controller(s) (e.g., FIG. 13, 1310). The control may be manual and/or programmed. The control may comprise an open loop control or a closed loop control (e.g., including feed forward and/or feedback) control scheme. The closed loop control may utilize signal from the one or more sensors. The control may utilize historical data. The control scheme may be pre-programmed. The control scheme may consider an input from one or more sensors (described herein) that are connected to the control unit (i.e., control system or control mechanism) and/or processor(s). The computer system (including the processor(s)) may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output various parameters of the 3D printing system (as described herein) in real time or in a delayed time. The output unit may output the current 3D printed object, the ordered 3D printed object, or both. The output unit may output the printing progress of the 3D printed object. The output unit may output at least one of the total times, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may output which guidance system of a plurality of guidance systems is (e.g., configured for) directing an energy beam. The output unit may output a guidance selection beam path. The output unit may output a position of at least one optical element (e.g., configured for) selecting a guidance selection beam path. The computer may generate a report comprising various parameters of the 3D printing system, method, and or objects at predetermined time(s), on a request (e.g., from an operator), and/or at a whim. The output unit may comprise a screen, printer, a light source (e.g., lamp), or speaker. The control system may provide a report. The report may comprise any items recited as optionally output by the output unit.

At times, the systems, methods, and/or apparatuses disclosed herein comprises receiving a request for a 3D object (e.g., from a customer). The request can include a model (e.g., a CAD file) of the requested 3D object. Alternatively, or additionally, a model of the requested 3D object may be generated. The model may be used to generate 3D printing instructions. The software program(s) (e.g., FIGS. 13, 1322 and/or 1324) may comprise the 3D printing instructions. The 3D printing instructions may exclude the 3D model. The 3D printing instructions may be based on the 3D model. The 3D printing instructions may take the 3D model into account. The 3D printing instructions may be alternatively or additionally based on simulations. The 3D printing instructions may use the 3D model. The 3D printing instructions may comprise using a calculation (e.g., embedded in a software program(s)) that considers the 3D model, simulations, historical data, sensor input, or any combination thereof. The processor may compute the calculation during the 3D printing process (e.g., in real-time), during the formation of the 3D object, prior to the 3D printing process, after the 3D printing process, or any combination thereof. The processor may compute the calculation in the interval between pulses of the energy beam, during the dwell time of the energy beam, before the energy beam translates to a new position, while the energy beam is not translating, while the energy beam does not irradiate the target surface, while the (e.g., at least one) energy beam irradiates the target surface, or any combination thereof. The processor may compute the calculation in the interval between a movement of at least one optical element (e.g., for selecting a guidance selection beam path) from a first position to a second position, while the at least one optical element moves (e.g., translates) to a new (e.g., second) position, in the interval between a movement of a guidance system (e.g., for selecting a guidance selection beam path) from a first position to a second position, while the guidance system moves (e.g., translates) to a new (e.g., second) position, or any combination thereof. For example, the processor(s) may compute the calculation while the energy beam translates and does substantially not irradiate the exposed surface. For example, the processor(s) may compute the calculation while the energy beam does not translate and irradiates the exposed surface. For example, the processor(s) may compute the calculation while the energy beam does not substantially translate and does substantially not irradiate the exposed surface. For example, the processor(s) may compute the calculation while the energy beam does translate and irradiates the exposed surface. The translation of the energy beam may be translation along an entire energy beam path or a portion thereof. The energy beam path may correspond to a cross section of the model of the 3D object. The translation of the energy beam may be translation along at least one energy beam path.

### EXAMPLES

The following are illustrative and non-limiting examples of methods of the present disclosure.

### Example 1

In a 320 mm diameter and 400 mm maximal height container at ambient temperature, Inconel 718 powder of average particle size 35 μm is deposited in a container to form a powder bed. The container is disposed in an enclosure to separate the powder bed from the ambient environment. The enclosure is purged with Argon gas. A first 1000 W fiber laser beam was used to melt a portion of the powder bed in a first material layer to form a first arrangement of 3D objects (e.g., markers) on a platform base (as in FIG. 16, 1611). A second 1000 W fiber laser beam was used to melt a portion of the powder bed in a second material layer to form a second arrangement of 3D objects (e.g., markers) on a platform base (as in FIG. 16, 1620). The 3D objects were formed by transforming layers of powder material having an average thickness of about 50 μm using a layerwise manufacturing process as described herein. Optical images of the markers in FIG. 16 were obtained using a Grasshopper3 (GS3-U3-51S5MC, manufactured by Point Grey) imaging camera, at 2048×2048 pixel resolution.

While preferred embodiments of the present invention have been shown, and described herein, it will be obvious to those skilled in the art that such embodiments are provided by way of example only. It is not intended that the invention be limited by the specific examples provided within the specification. While the invention has been described with reference to the afore-mentioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

1. An apparatus for printing a three-dimensional object comprising: one or more controllers configured to
(i) operatively couple (a) to an electrical power source, (b) to an energy beam source, and (c) to one or more guidance systems;
(ii) select, or direct selection of, a location Aⱼ of the one or more guidance systems from a location set A₁, A₂, . . . Aₙ, wherein n and j are integers; and
(iii) direct the one or more guidance systems to guide an energy beam from the location Aⱼ to a point P on a surface of the three-dimensional object, wherein Vⱼ is a unit vector of a vector from the location Aⱼ to the point P, wherein Uⱼ is a unit vector of a projection of Vⱼ on a plane normal to a global vector, the energy beam being generated by the energy beam source,
wherein the global vector is (a) directed to a gravitational center of an ambient environment, (b) directed opposite to a direction of layer-wise deposition to print the three-dimensional object, and/or (c) normal to a platform configured to support the three-dimensional object during its printing and directed opposite to a surface of the platform that supports the three-dimensional object,
wherein a unit vector N normal to an average of the surface of the three-dimensional object at the point P forms an angle alpha with the global vector, wherein the angle alpha is at most about 45 degrees, wherein the unit vector N is directed away from the three-dimensional object, and
wherein M is a unit vector of a projection of N on a plane normal to the global vector, wherein Sⱼ is a scalar product of Uⱼ·M, and wherein the point P satisfies having a Sⱼ value of from about minus one (−1) to about half (0.5).

2. The apparatus of claim 1, wherein the point P satisfies having a Sⱼ value of from about minus one (−1) to about zero (0).

3. (canceled)

4. (canceled)

5. The apparatus of claim 1, wherein the one or more controllers are configured to direct translation of the one or more guidance systems to the location Aⱼ.

6. The apparatus of claim 1, wherein the average of the surface of the three-dimensional object is a planarized surface of the three-dimensional object that is averaged in an area of a circle having a radius of at least half (0.5) a millimeter centered at the point P, which circle is disposed on the surface.

7. The apparatus of claim 1, wherein the average of the surface of the three-dimensional object is a surface defined by a selected line portion and a point, wherein the selected line portion is a first cross section of a first layering plane with the surface, and the point is in a second cross section of a second layering plane with the surface.

8. The apparatus of claim 1, wherein the one or more controllers are further configured to operatively couple to a sensor, the sensor being configured to detect (a) a position of the one or more guidance systems with respect to the location set A₁, A₂, . . . Aₙ, (b) at least one energy beam characteristic and/or (c) a signal emitted from an energy beam footprint on the surface.

9. The apparatus of claim 8, wherein the at least one energy beam characteristic comprises (I) a position of the energy beam footprint with respect to the point P, (II) a fundamental length scale of the energy beam footprint, or (III) a focal position of the energy beam footprint.

10. The apparatus of claim 1, wherein the one or more guidance systems are disposed within an optical enclosure separating a traversal path of the energy beam in the optical enclosure from an ambient environment external to the optical enclosure.

11. The apparatus of claim 10, wherein the optical enclosure comprises, or is operatively coupled with, one or more optical elements, the one or more optical elements arranged to direct and/or to transmit the energy beam, the one or more optical elements comprising a lens, a mirror, a beam splitter, or an optical window.

12. The apparatus of claim 11, wherein the one or more optical elements comprise sapphire, beryllium, zinc selenide, calcium fluoride (CaF₂), or fused silica.

13. The apparatus of claim 1, wherein the one or more guidance systems are mounted or disposed on a railing, the railing comprising locations of the location set A₁, A₂, . . . Aₙ, the railing comprising at least one actuator configured to move the one or more guidance systems from a first location to a second location of the location set A₁, A₂, . . . Aₙ.

14. (canceled)

15. The apparatus of claim 1, wherein
the one or more controllers are configured to direct the energy beam source to generate the energy beam directed to the one or more guidance systems disposed at the location Aⱼ.

16. (canceled)

17. (canceled)

18. The apparatus of claim 1, wherein at least a first one of the one or more guidance systems are configured for movement from a first location to a second location with of the location set A₁, A₂, . . . Aₙ.

19. The apparatus claim 1, wherein (A) the one or more guidance systems comprise a plurality of guidance systems disposed at locations within the location set A₁, A₂, . . . Aₙ, and/or (B) the energy beam source is a first energy source of a plurality of energy sources.

20. The apparatus of claim 19, wherein at least one controller is configured to optimize election of a guidance system from the plurality of guidance systems to guide the energy beam at least in part by being configured to consider, or direction consideration of, (A) the point P and/or (B) a location of the energy source, wherein to optimize is with respect to minimizing the Sⱼ value.

21. The apparatus of claim 19, wherein the at least one controller is configured to optimize selection of an energy source from the plurality of energy sources to generate the energy beam at least in part by being configured to consider, or direct consideration of, (A) the point P and/or (B) a location of a guidance system of the plurality of guidance systems, wherein to optimize is with respect to minimizing the Sⱼ value.

22.-43. (canceled)

44. The apparatus of claim 1, wherein during printing, the one or more guidance systems are disposed horizontally externally to an exposed surface of a material bed from which the three-dimensional object is printed during the printing.

45. The apparatus of claim 1, wherein the one or more controllers are configured to direct control of an atmosphere of an enclosure to be different by at least one characteristic from an ambient atmosphere of the ambient environment external to the enclosure, the three-dimensional object being printed in the enclosure; and optionally wherein the at least one characteristic comprises (a) a pressure or (b) at least one reactive species configured to react during the printing with a transformed and/or a pre-transformed material, the pre-transformed material being transformed to the transformed material to print the three-dimensional object.

46. Non-transitory computer readable program instructions, the program instructions, when read by one or more processors operatively coupled with the apparatus of claim 1, instruct the one or more processors to perform, or direct performance of, one or more operations associated with the apparatus for printing the three-dimensional object, the program instructions being inscribed on at least one non-transitory computer readable medium.

47. A method of printing a three-dimensional object, the method comprising: (a) providing the apparatus of claim 1; and (b) performing one or more operations associated with the apparatus for printing the three-dimensional object.
